(19) United States
(12) Patent Application Publication
(10) Pub. No.: US 2023/0377195 A1
(43) Pub. Date: Nov. 23, 2023

(54) REINFORCEMENT LEARNING TO PERFORM LOCALIZATION, SEGMENTATION, AND CLASSIFICATION ON BIOMEDICAL IMAGES

(71) Applicant: MEMORIAL SLOAN KETTERING CANCER CENTER, New York, NY (US)

(72) Inventors: Joseph N. Stember, New York, NY (US); Hrithwik Shalu, New York, NY (US)

(21) Appl. No.: 18/030,256

(22) PCT Filed: Oct. 5, 2021
(86) PCT No.: PCT/US2021/053508

§ 371 Date: Apr. 4, 2023

Related U.S. Application Data
(60) Provisional application No. 63/087,475, filed on Oct. 5, 2020.
(60) Provisional application No. 63/129,999, filed on Dec. 23, 2020.
(60) Provisional application No. 63/145,678, filed on Feb. 4, 2021.
(60) Provisional application No. 63/237,804, filed on Aug. 27, 2021.

(51) Int. Cl. G06T 7/73; G06T 7/00

(52) U.S. Cl. CPC G06T 7/75; G06T 7/0012; G06T 2207/30004; G06T 2207/10072; G06T 2207/20084; G06T 2207/30016

(57) ABSTRACT

Presented herein are systems and methods using reinforcement learning to perform localization, segmentation, and classification on biomedical images. A computing system may identify a biomedical image. The biomedical image may have a structure of interest (SOI) corresponding to a condition. The computing system may apply one or more models to perform (i) localization to determine a location of the SOI in the biomedical image; (ii) segmentation to identify a segment corresponding to the SOI on the biomedical image; and (iii) classification to determine a class identifying the condition of the biomedical image. The models may be established using reinforcement learning, such as deep Q-learning.

### CROSS-REFERENCE TO RELATED PATENT APPLICATIONS

The present application claims priority to U.S. Provisional Application No. 63/087,475, titled “Gridworld Deep Q Networks, Q-Learning, Policy Gradient and Hierarchical Deep Reinforcement Learning Applied to Medical Image Classification, Lesion Localization and Segmentation,” filed Oct. 5, 2020, U.S. Provisional Application No. 63/129,999, titled “Unsupervised Deep Learning Clustering and Reinforcement Learning to Accurately Segment Images,” filed Dec. 23, 2020, U.S. Provisional Application No. 63/145,678, titled “Deep Reinforcement Learning-Based Image Classification,” filed Feb. 4, 2021, U.S. Provisional Application No. 63/237,804, titled “Image Noise with Multistep Reinforcement Learning for Medical Image Analysis,” filed Aug. 27, 2021, each of which is incorporated herein by reference in their entireties.

### BACKGROUND

Computer vision algorithms may be used by a computing device to recognize and detect various objects and features on digital images.

### SUMMARY

Various aspects of the present disclosure are directed to systems and methods of localizing on biomedical images. A computing system may identify a biomedical image having at least one structure of interest (SOI). The computing system may apply the biomedical image to a localization model for handling an agent. The localization model may include a set of transform layers to generate an output identifying (i) a state indicating a position of the agent within the biomedical image; and (ii) an action to be performed by the agent with respect to the position. The computing system may determine at least one location in the biomedical image corresponding to the at least one SOI based on the state and the action performed by the agent in accordance with the output. The computing system may provide information based on the at least one location in the biomedical image corresponding to the at least one SOI.

In some embodiments, the computing system may generate a plurality of tiles from the biomedical image to define an action space for the position of the agent. At least one tile of the plurality of tiles may have the at least one SOI. In some embodiments, the output generated by the localization model may identify (i) the state indicating the position corresponding to a first tile of the plurality of tiles; and (ii) the action to maintain the position of the agent or the move the agent from the first tile to a second tile of the plurality of tiles.

In some embodiments, the computing system may receive, from a tomograph, a tomogram of at least one of a two-dimensional section of a subject or a three-dimensional volume of the subject. In some embodiments, the computing system may apply the biomedical image to the localization model for a number of iterations. The number of iterations may be identified based on a set number of tiles in a plurality of tiles defining an action space for the position of the agent. In some embodiments, the set of transform layers may be arranged across a plurality of convolutional neural networks (CNNs) and a plurality of fully-connected layers (FLCs) connected in series.

In some embodiments, the computing system may determine the at least one location corresponding to at least one tile of a plurality of tiles defining an action space for the position of the agent on the biomedical image, based on the state and the action performed by the agent in accordance with the output. In some embodiments, the computing system may present, on an interface, the information based on the at least one location corresponding to the at least one SOI in the biomedical image

Various aspects of the present disclosure are directed to systems and methods of training models to localize biomedical images. A computing system may identify a biomedical image having at least one structure of interest (SOI) and an annotation identifying at least one location of the at least one SOI in the biomedical image. The computing system may apply the biomedical image to a localization model. The localization model may include a set of transform layers to generate an output identifying (i) a state indicating a position of the agent within the biomedical image; and (ii) a plurality of actions to be performed by the agent with respect to the position. The state and the plurality of actions may be used to determine the at least one location corresponding to the at least one SOI in the biomedical image. The computing system may determine a loss metric based on the state and the plurality of actions identified in the output in accordance with a value function. The value function may define (i) a first value for when the position of the agent corresponds to the at least one location identified in the at least one SOI; and (ii) a second value for when the position of the agent does not correspond to the at least one location. The computing system may update at least one of the set of transform layers of the localization model using the loss metric.

In some embodiments, the computing system may generate a plurality of tiles from the biomedical image to define an action space for the position of the agent. At least one tile of the plurality of tiles may have the at least one SOI. In some embodiments, the output generated by the localization model may identify (i) the state indicating the position corresponding to a first tile of the plurality of tiles; and (ii) the plurality of actions to maintain the position of the agent or the move the agent from the first tile to a second tile of the plurality of tiles.

In some embodiments, the computing system may assign an initial state for the agent indicating an initial position corresponding to one of a plurality of tiles defining an action space for the position of the agent. In some embodiments, the computing system may select, from the plurality of actions, an action for the agent to perform with respect to the position based on a value associated with the action. In some embodiments, the computing system may apply the biomedical image to the localization model for a number of iterations. The number of iterations may be identified based on a set number of tiles in a plurality of tiles defining an action space for the position of the agent.

In some embodiments, the computing system may store, on a buffer, an entry identifying the state of the agent, an action of the plurality of actions performed by the agent, and a value determined based on the value function. The entry may be used in at least one subsequent iteration of application of the biomedical image. In some embodiments, the computing system may add random noise to the biomedical image, prior to at least one iteration of applying the biomedical image to the segmentation model.

Various aspects of the present disclosure are directed to systems and methods of segmenting biomedical images. A computing system may identify a biomedical image having at least one structure of interest (SOI). The computing system may generate a plurality of clusters from the biomedical image. Each of the plurality of clusters may correspond to a region in the biomedical image having a respective characteristic. The computing system may apply the biomedical image to a segmentation model for handling an agent. The segmentation model may include a set of transform layers to generate an output identifying (i) a state indicating a selection of a cluster by the agent from the plurality of clusters of the biomedical image; and (ii) an action to be performed with respect to the selection of the cluster. The computing system may identify at least one segment within the biomedical image corresponding to the at least one SOI based on the state and the action performed by the agent in accordance with the output. The computing system may provide information based on the at least one segment corresponding to the at least one SOI in the biomedical image.

In some embodiments, the computing system may receive, from a tomograph, a tomogram of at least one of a two-dimensional section of a subject or a three-dimensional volume of the subject. In some embodiments, the computing system may apply the biomedical image to a clustering model. The clustering model may include a second set of transform layers to generate the plurality of clusters having a set number of clusters.

In some embodiments, the computing system may apply the biomedical image to the segmentation model for a number of iterations. The number of iterations may be identified based on a set number of clusters. In some embodiments, the computing system may select, from the plurality of clusters, the at least one cluster as the at least one segment based on the state and the action performed by the agent in accordance with the output.

In some embodiments, the set of transform layers may be arranged across a plurality of convolutional neural networks (CNNs) and a plurality of fully-connected layers (FLCs) connected in series. In some embodiments, the computing system may present, on an interface, the information based on the at least one segment corresponding to the at least one SOI in the biomedical image.

Various aspects of the present disclosure are directed to systems and methods of training models to segment biomedical images. A computing system may identify a biomedical image, a plurality of clusters generated from the biomedical image, and an annotation identifying at least one cluster corresponding to at least one structure of interest (SOI) in the biomedical image. The computing system may apply the biomedical image to a segmentation model for handling an agent. The segmentation model may include a set of transform layers to generate an output identifying (i) a state indicating a selection of a cluster by the agent from the plurality of clusters of the biomedical image; and (ii) a plurality of actions to be performed with respect to the selection of the cluster. The state and the plurality of actions may be used to identify at least one segment within the biomedical image corresponding to the at least one SOI. The computing system may determine a loss metric based on the state and the plurality of actions identified in the output in accordance with a value function. The value function may define (i) a first value for when the selection by the agent corresponds to the at least one cluster of the annotation; and (ii) a second value for when the selection by the agent does not correspond to the at least one cluster of the annotation. The computing system may update at least one of the set of transform layers of the segmentation model using the loss metric.

In some embodiments, the computing system may provide information based on the plurality of clusters generated from the biomedical image. In some embodiments, the computing system may receive the annotation identifying a selection of the at least one cluster, from the plurality of clusters, corresponding to the at least one structure of interest (SOI) in the biomedical image.

In some embodiments, the computing system may assign an initial state for the agent indicating an initial selection of one from the plurality of clusters of the biomedical image. In some embodiments, the computing system may select, from the plurality of actions, an action for the agent to perform with respect to the selection of the cluster based on a value associated with the action.

In some embodiments, the computing system may apply the biomedical image to the segmentation model for a number of iterations. The number of iterations may be identified based on a set number of clusters. In some embodiments, the computing system may establish a clustering model comprising a second set of transform layers to generate the plurality of clusters having a set number of clusters using a training dataset.

In some embodiments, the computing system may store, on a buffer, an entry identifying the state of the agent, an action of the plurality of actions performed by the agent, and a value determined based on the value function. The entry may be used in at least one subsequent iteration of application of the biomedical image. In some embodiments, the computing system may add random noise to the biomedical image, prior to at least one iteration of applying the biomedical image to the segmentation model.

Various aspects of the present disclosure are directed to systems and methods of classifying biomedical images. A computing system may identify a biomedical image having one of a presence or an absence of a condition. The computing system may apply the biomedical image to a classification model for handling an agent. The classification model may include a set of transform layers to generate an output identifying (i) a state identifying a class associated with a factor for the biomedical image as one of the presence or the absence of the condition; and (ii) an action with respect to the class for the biomedical image. The computing system may identify the class for the biomedical image as having one of the presence or the absence of the condition based on the state and the action identified in the output generated by the classification model. The computing system may provide information based on the class identified for the biomedical image.

In some embodiments, the computing system may receive, from a tomograph, a tomogram of at least one of a two-dimensional section of a subject or a three-dimensional volume of the subject. In some embodiments, the computing system may add a graphical indicator corresponding to the factor to the biomedical image based on the state of the factor, prior to at least one iteration of an application of the biomedical image to the classification model.

In some embodiments, the computing system may assign an initial state for the agent indicating an initial factor corresponding to an initial class for the biomedical image as having one of the presence or the absence. In some embodiments, the computing system may present, on an interface, the information based on the class identified for the biomedical image.

In some embodiments, the sets of transform layers may be arranged across (i) a plurality of convolutional neural networks (CNNs); (ii) a plurality of fully-connected layers (FLCs) connected in series with the plurality of CNNs; (iii) at least one first FLC parallel to the plurality of CNNs and the plurality of FLCs; and (iv) at least one second FLC in series with the plurality of CNNs, the plurality of FLCs, and the at least one first FLC.

Various aspects of the present disclosure are directed to systems and methods of training models to classifying biomedical images. A computing system may identify a biomedical image and an annotation identifying the biomedical image as having one of a presence or an absence of a condition. The computing system may apply the biomedical image to a classification model for handling an agent. The classification model may have a set of transform layers to generate an output identifying (i) a state identifying a class associated with a factor for the biomedical image as one of the presence or the absence of the condition; and (ii) a plurality of actions with respect to the class for the biomedical image. The state and the plurality of actions may be used to identify the class for the biomedical image as having one of the presence or the absence of the condition. The computing system may determine a loss metric based on the state and the plurality of actions identified in the output in accordance with a value function. The value may define (i) a first value when the state of the agent corresponds to the condition identified in the annotation; and (ii) a second value when the state of the agent does not correspond to the condition identified in the annotation. The computing system may update at least one of the set of transform layers of the classification model using the loss metric.

In some embodiments, the computing system may provide information based on the class identified from the output as having one or the presence or the absence of the condition, subsequent to a first iteration of an application of the classification model. In some embodiments, the computing system may receive a feedback identifying the class for the biomedical image as one of correct or incorrect. The feedback may be acquired via at least one of an audio input, a visual input, or a tactile input in response to presentation of the information. In some embodiments, the computing system may determine the loss metric based on an identification of one of the first value or the second value from the value function using the feedback.

In some embodiments, the computing system may add a graphical indicator corresponding to the factor to the biomedical image based on the state of the agent, prior to at least one iteration of an application of the biomedical image to the classification model. In some embodiments, the computing system may assign an initial state for the agent indicating an initial factor corresponding to an initial class for the biomedical image as having one of the presence or the absence. In some embodiments, the computing system may parse a report associated with the biomedical image to identify the biomedical image as having one of the presence or the absence of the condition.

In some embodiments, the computing system may store, by the computing system, on a buffer, an entry identifying the state of the agent, an action of the plurality of actions performed by the agent, and a value determined based on the value function. The entry may be used in at least one subsequent iteration of application of the biomedical image. In some embodiments, the computing system may add random noise to the biomedical image, prior to at least one iteration of applying the biomedical image to the segmentation model.

### BRIEF DESCRIPTION OF THE DRAWINGS

FIG. 1: Illustration of the agent, environment, action space and reward system. Each figure displays the 2D image slice of brain+tumor, sectioned into grids of 60×60 pixels. The agent occupies one grid point at a time and can move by one at a time between adjacent grid points. Here the 3-action space is shown. The agent may take 3 possible actions: stay, move to the right and move down. The corresponding rewards are shown. In the left and middle figures, it is seen that a maximum penalty of R=−2 is applied when the agent stays still outside the lesion, with a lesser penalty of R=−0.5 when moving. The maximum reward of +1 is obtained when the action brings the agent to a state overlapping the lesion. Hence in the middle figure, it wants to move to the right, and in the right figure, it “wants” to stay in place.

FIG. 2: Testing accuracy of the Deep Q network with Q-learning approach to the state-action space illustration in FIG. 1. The testing set consists of 30 two-dimensional images, each with one brain tumor. The x axis represents training time; training was performed on 30 training set images, different from the testing set images. By the standards of artificial intelligence, this is an extremely small training set, yet it is able to obtain testing set accuracies of around 70%, with best fit line showing improved, more generalizable learning over time.

FIG. 3: A block diagram of an overview of a training scheme of unsupervised cluster reinforcement learning for lesion segmentation.

FIG. 4: Schematic of the unsupervised clustering convolutional neural network. The raw image is fed as input into the network with convolutional layers via 3×3 kernels and zero padding to keep the subsequent layers the same H×W size. The three convolutional layers have 100 channels; each pixel has 100 features. Then argmax is obtained over the 100 features for each pixel, selecting the most important feature over the image.

FIG. 5: Illustration of target versus output prediction from the network illustrated in FIG. 4. On the right is a tiling of the input image. The individual cells are the so-called superpixels, generated by the SLIC method. For the purposes of illustration, a small subset of the image is analyzed on the left panel. The CNN from FIG. 4 predicts most important features of the 100-feature embeddings in the penultimate layer in said figure. The goal is for each pixel in a given superpixel to be the one type of feature. Here, three features are illustrated as three shapes. The algorithm to generate the target is to make all pixels in a given superpixel equal to the most numerous/common feature type predicted in the CNN output.

FIG. 6: Set of clusters produced by the unsupervised deep clustering CNN. These serve as lesion mask candidates. The user can select the best image/mask number, here the best mask is clearly the first one, on the top left image. That cluster [symbol] and its complement [symbol] ^{C} are then used for training of the reinforcement learning network. The reinforcement learning network learns to select which is the best cluster (mask or its complement) to serve as lesion mask.

FIG. 7: Architecture of Deep Q-learning CNN to select which region should be the lesion mask.

FIG. 8: Sample mask predictions. (A) shows one of the testing set images, (B) displays the hand annotated mask overlaid in red, (C) shows the predicted mask from the Unsupervised Deep Clustering Reinforcement Learning approach, overlaid in green and (D) shows both masks overlaid, noting that their region of overlap becomes yellow.

FIG. 9: Training set accuracy as a function of training time. A steady and monotonic increase is manifest.

FIG. 10: Test set accuracy of reinforcement learning map selection as a function of training time. All 10 test set images have the correct mask selected already by the fourth episode and there is no subsequent dip in accuracy to suggest over-fitting. Best fit sigmoid function curve is shown in red.

FIG. 11: Bar plot comparison between testing set accuracy (measured as Dice score) for unsupervised deep clustering and reinforcement learning map selection (U DC+RL) and supervised deep learning/U-net (SDL). The average value is given by the height of the bars, and the standard deviation is represented by the error bars.

FIG. 12: Markov decision process for a normal image.

FIG. 13: Markov decision process for a tumor-containing image.

FIG. 14: Deep Q network (DQN) architecture for two-dimensional binary classification.

FIG. 15: Testing set accuracy during the course of reinforcement learning training.

FIG. 16: Unsupervised learning training set loss. The method overfits the small training set as it successively decreases loss.

FIG. 17: Bar plot showing the testing set accuracy (bar height) for reinforcement learning vs. supervised deep learning. The dashed horizontal line corresponds to 50% accuracy, equivalent to random guess.

FIG. 18: Deep Q Network (DQN) architecture for three-dimensional binary classification, with a separate input for prediction correctness of the prior image (pred_corr).

FIG. 19: Example of a grayscale image with random noise. Note the random black and white pixels interspersed throughout the image.

FIG. 20: Illustration of the Markov Decision Process for a normal (i.e., tumor-free) image.

FIG. 21: Illustration of the Markov Decision Process for a metastasis-containing image.

FIG. 22: Comparison of the testing set accuracy during training. MDP-RL with image noise added produces many more high accuracy candidate policies than MDP-RL without noise-altered images. The former achieves a higher maximum accuracy of 100% for these candidates.

FIG. 23 is a block diagram of a system for localizing images in accordance with an illustrative embodiment.

FIGS. 24A and 24B are block diagrams of a process for training models in the system for localizing images in accordance with an illustrative embodiment.

FIG. 25A is a block diagram of an architecture of a localization model of the system for localizing images in accordance with an illustrative embodiment.

FIG. 25B is a block diagram of an architecture of a transform block in a localization model of the system for localizing images in accordance with an illustrative embodiment.

FIG. 25C is a block diagram of an architecture of a set of transform layers in a transform block in a localization model of the system for localizing images in accordance with an illustrative embodiment.

FIGS. 26A and 26B are block diagrams of a process for using models in the system for localizing images in accordance with an illustrative embodiment.

FIG. 27A is a flow diagram of a method of training models to localize images in accordance with an illustrative embodiment.

FIG. 27B is a flow diagram of a method of localizing images in accordance with an illustrative embodiment.

FIG. 28 is a block diagram of a system for segmenting images in accordance with an illustrative embodiment.

FIGS. 29A-C are block diagrams of a process for training models in the system for segmenting images in accordance with an illustrative embodiment.

FIG. 30A is a block diagram of an architecture of a segmentation model of the system for segmenting images in accordance with an illustrative embodiment.

FIG. 30B is a block diagram of an architecture of a transform block in a segmentation model of the system for segmenting images in accordance with an illustrative embodiment.

FIG. 30C is a block diagram of an architecture of a set of transform layers in a transform block in a segmentation model of the system for segmenting images in accordance with an illustrative embodiment.

FIGS. 31A and 31B are block diagrams of a process for using models in the system for segmenting images in accordance with an illustrative embodiment.

FIG. 32A is a flow diagram of a method of training models to segment images in accordance with an illustrative embodiment.

FIG. 32B is a flow diagram of a method of segmenting images in accordance with an illustrative embodiment.

FIG. 33 is a block diagram of a system for classifying images in accordance with an illustrative embodiment.

FIGS. 34A and 34B are block diagrams of a process for training models in the system for classifying images in accordance with an illustrative embodiment.

FIG. 35A is a block diagram of an architecture of a classification model of the system for classifying images in accordance with an illustrative embodiment.

FIG. 35B is a block diagram of an architecture of a transform block in a classification model of the system for classifying images in accordance with an illustrative embodiment.

FIG. 35C is a block diagram of an architecture of a set of transform layers in a transform block in a classification model of the system for classifying images in accordance with an illustrative embodiment.

FIGS. 36A and 36B are block diagrams of a process for using models in the system for classifying images in accordance with an illustrative embodiment.

FIG. 37A is a flow diagram of a method of training models to classifying images in accordance with an illustrative embodiment.

FIG. 37B is a flow diagram of a method of classifying images in accordance with an illustrative embodiment.

FIG. 38 is a block diagram of a server system and a client computer system in accordance with an illustrative embodiment.

### DETAILED DESCRIPTION

Following below are more detailed descriptions of various concepts related to, and embodiments of, systems and methods for multi-step reinforcement of biomedical images. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Section A describes gridworld deep Q networks for deep reinforcement learning applied to image classification, localization, and segmentation;

Section B describes unsupervised deep learning clustering and reinforcement learning for segmentation of images;

Section C describes deep reinforcement learning based image classification;

Section D describes image noise with multi-step reinforcement learning for medical image analysis;

Section E describes systems and methods for models established using reinforcement learning to perform localization of biomedical images;

Section F describes systems and methods for models established using reinforcement learning to perform segmentation of biomedical images;

Section G describes systems and methods for models established using reinforcement learning to perform classification of biomedical images; and

Section H describes a network environment and computing environment which may be useful for practicing various embodiments described herein.

### A. Grid-World Deep Q Networks for Deep Reinforcement Learning Applied to Image Classification, Localization, and Segmentation

AI in radiology is hindered chiefly by 1) requiring large annotated data sets; 2) non-generalizability that limits deployment to new scanners; and 3) inadequate explainability and interpretability. It is believed that policy-based and hierarchical deep reinforcement learning can address all three shortcomings, with robust and intuitive algorithms trainable on small datasets. Regarding the latter, it is noted that reward structures guide the algorithms. This provides both intuition in interpreting results and formulating the algorithms. As such, experts from various fields employing medical imaging can employ their domain knowledge to produce better, more targeted algorithms.

Feasibility is shown for deep reinforcement learning in general to localize lesions using a Deep Q Network. High accuracy (85%) may be achieved for a very small training data set size, whereas the supervised approach produced nowhere close to the same accuracy (<10%).

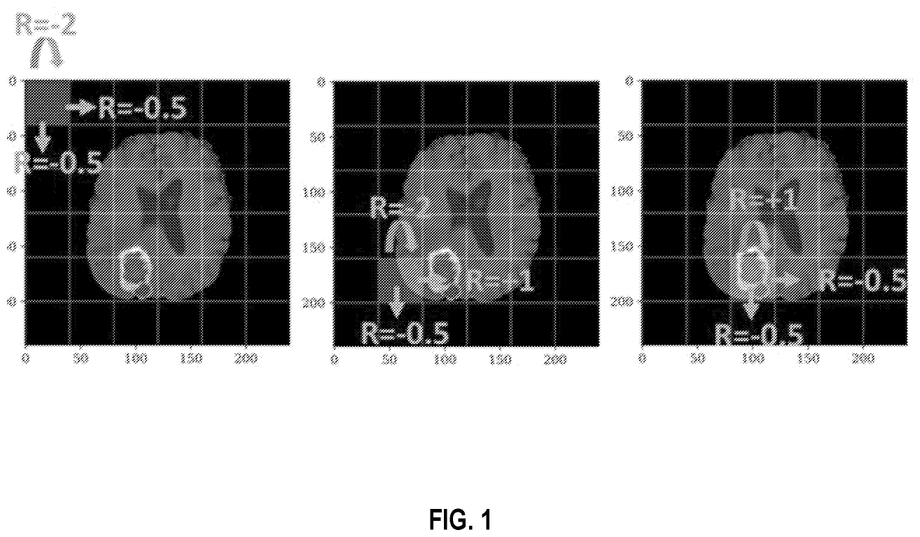

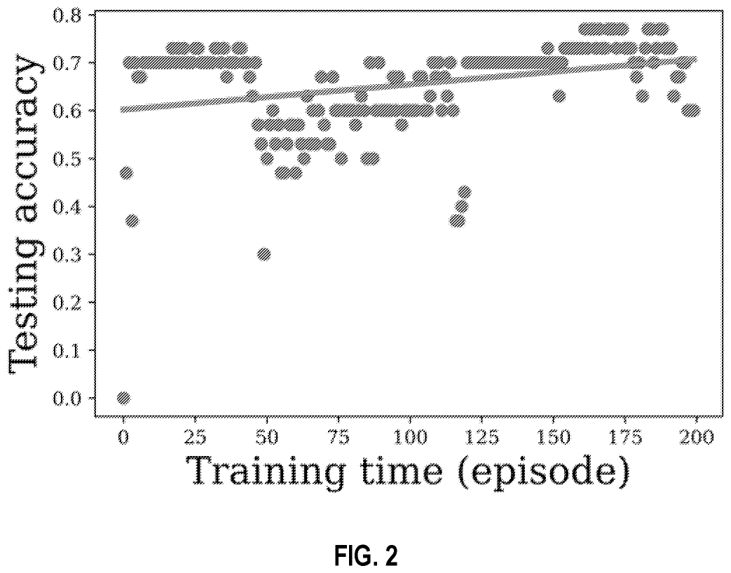

In order to generalize this to cases in which eye tracking data is not available, the gridworld environment with 3 possible actions (right, down and stay) with the agent able to move pixels one at a time starting from the top-left pixel may be used as a proof of concept. It is noted that “pixel” really refers in gridworld to a collection (defined by the grid) of pixels (or voxels)—in the result shown here, 240×240 pixel 2D images from a database was used and split into 4×4 grids, each 60×60 pixels. The agent was able to move between successive grid points. A rewards scheme of reward=+1 for agent in the lesion, otherwise for action=0 (staying still), it was penalized with reward=−2, and if moving while outside the lesion less of a penalty at reward=−0.5. The gridworld environment and reward scheme illustrated in FIG. 1. Using this reward scheme, replay memory buffer and deep Q network and Q-learning to predict possible actions based on state, a set of only 30 post-contrast T1 weighted images with brain tumors may be able to be trained. The model was tested on 30 separate images, as shown in FIG. 2, the testing set accuracy converged to around 70%.

The present patent aims to use the gridworld framework along with combinations of Deep Q-learning, policy-based and hierarchical deep reinforcement learning to automate and assist medical image interpretation and analysis. Deep reinforcement learning may be applied to train and analyze medical images.

The three main tasks of AI in radiology which this can address are (1) image classification, (2) lesion (or structure-of-interest) localization, and (3) lesion (or structure-of-interest) segmentation. The approach is as follows for the 3 above tasks.

### 1. Image Classification

Put images into encodings (AKA embedding) via a convolutional neural network (CNN). Then group the vectors into different categories (classifications) via convolutional layers followed by fully connected layers. The last hidden fully connected layer provides the embedding. For example, two images may be compared by running them forward in this network (same architecture and weights, so-called “Siamese neural networks”) to a pair of embeddings that will be compared.

The embedding can determine image similarity. As such, by any standard vector similarity measure (e.g., dot product) two embeddings from the same class should be similar up to some threshold, and pair might be assigned a value of, for example, 1. If they are sufficiently different, then they would receive the value 0. The embedding similarity should be enforced to correspond to class similarity of the input images.

This condition can be enforced via reinforcement learning, by penalizing mis-adherence to the condition and incentivizing with a positive reward that any pair of embeddings be similar if and only in the input images are within the same class. This could be added to standard log similarity measures on the network outputs, so should improve any standard classification convolutional neural network approach.

### 2. Lesion or Structure of Interesting Localization

Start by using the “gridworld” (two-or-three dimensional) framework for the environment (e.g., medical images). The agent is a pixel/position (actually a grid within the image consisting of a square arrangement of adjacent pixels, as described above) that can move, driven by a reward system favoring movement toward, and stasis in the lesion/structure-of-interest. It is penalized for being outside the lesion, especially remaining in one position in this state. This drives the system to the target state, which is within the lesion.

Various combinations of deep Q-learning and policy-driven approaches may be used. Using images with lesion annotations (hand drawn “masks”), a CNN may be trained that optimizes policy by maximizing the likelihood for choosing actions that maximize cumulative reward.

### 3. Lesion or Structure of Interest Segmentation

Extending localization to visit states that are optimal but not visited before. Use an agent with an action (called “mark”). If the agent chooses mark, then a non-opaque grid is “painted” on the image in a pixel-by-pixel manner, outlining and thus segmenting the lesion or structure-of-interest. Using a similar approach to lesion localization, by keeping track of all the points that the agent stops in, this will paint the map of the lesion or structure-of-interest. The first part would be a segmentation grid based on the gridworld pixel blocks, then hierarchical reinforcement learning would refine down to more fine-grained segmentation. The hierarchical reinforcement learning approach may be also applied to (2) above. Generalization to segmenting lesions for volumes would necessitate three-dimensional gridworld-based environments and semi-continuous action spaces, such that the agent can move by values differing from one grid at a time (e.g., multiple grids or fractions of grids in one step).

### B. Unsupervised Deep Learning Clustering and Reinforcement Learning for Segmentation of Images

Proposed is to use unsupervised deep clustering following by reinforcement learning to segment lesions or other structures-of-interest on medical images, including radiological and histopathological. The unsupervised deep networks generate candidate lesion masks without user input. The user then selects the best lesion mask from those proposed by the network. The user also selects a point, called a fiduciary point, within the lesion. In so doing, a training set of image+mask is created. Using reinforcement learning, for each training set image, the correct mask is selected from among the candidate masks generated by the deep clustering network. The reinforcement learning algorithm is driven by a reward system that incentivizes choosing the correct lesion mask (correct identified via the fiduciary point.) In the proof-of-principle implementation and manuscript, Deep Q-learning and TD(0) Q-learning were used for the reinforcement learning portion.

Purpose. Lesion segmentation in medical imaging is key for evaluating response to treatment. Other approaches to reinforcement learning can not only be applied to radiological images. In fact, in so doing, it addresses important limitations of erstwhile prevailing supervised deep learning. This can address some of the latter's major limitations, including the requirement of large training data set. Here, an approach combining unsupervised deep learning clustering with reinforcement learning to segment brain lesions on MRI is introduced.

Materials and Methods. Images were initially clustered using unsupervised deep learning clustering to generate candidate lesion masks for each MRI image. The user then selected the best mask for each of 10 training images. Using these masks, a reinforcement learning algorithm is trained to select the masks. The corresponding trained deep Q network was tested on a separate testing set of 10 images. For comparison, a U-net supervised deep learning network was trained and tested on the same set of training/testing images.

Results. Whereas the supervised approach quickly overfit the training data and predictably performed poorly on the testing set (16% average Dice score), the unsupervised deep clustering and reinforcement learning achieved an average Dice score of 83%.

Conclusion. A proof-of-principle application of unsupervised deep clustering and reinforcement learning to segmentation of brain tumors is shown. The approach represents human-allied AI that requiring minimal input from the radiologist without the need for hand-drawn annotation.

### 1. Introduction

Segmentation of lesions, organs or other structures-of-interest is an integral component of artificial intelligence (AI) in radiology. All of AI segmentation, just like the tasks of localization and classification, may fall within the category of supervised deep learning.

A supervised deep learning research project focusing on segmentation typically begins with accruing and pre-processing a large number of appropriate images. As a general rule, this needs to be at least on the order of hundreds of images for successful training. Then the process of annotation begins, which entails radiologists or other imaging researchers tracing outer contours around each structure-of-interest, thereby creating a mask. Once enough masks have been acquired, the data is typically “augmented” via a series of rotations, scaling, translations and/or addition of random pixel noise to artificially produce a larger training set. At this point, the data set is divided between a training and validation set, which comprises the vast majority of the image data set, and a smaller separate testing set. A convolutional neural network (CNN) is trained through repeated forward and backpropagation through the CNN with the training set images as input and output compared to masks for the loss. Two other CNN architectures for segmentation are mask-regional-CNN (mask-RCNN) and U-net.

As is the case in general, supervised deep learning suffers from three major limitations. Three key shortcomings are addressed in current supervised deep learning approaches:
1. Requirement of large amounts of expert-annotated data. This can be expensive, tedious and time-consuming. For example, it has been estimated that segmenting 1,000 images may require two experts to work full-time for a month
2. Lack of generalizability, making it “brittle” and subject to grossly incorrect predictions when even a small amount of variation is introduced. This can occur when applying a trained network to images from a new scanner, institution, and/or patient population.
3. Lack of insight or intuition into the algorithm, thus limiting confidence needed for clinical implementation and restricting potential contributions from non-AI experts with advanced domain knowledge (e.g., radiologists or pathologists).

The concept of radiological reinforcement learning (RL) is introduced: the application of reinforcement learning to analyze medical images. It is shown that RL can address these challenges. RL may be applied to lesion localization.

But segmentation can provide more information, such as lesion volume, which is particularly useful for follow-up determining radiological response to treatment. Here, RL is applied to the task of segmentation. In order to do so, another important, though less prevalent, branch of AI may be leveraged in radiology: unsupervised deep learning. Unsupervised deep learning performs data clustering, grouping the data sets into different classes. The identity of classes is left to human users to determine, thereby providing post-training “supervision.”

Hence, two major phases are used:
Use unsupervised clustering CNN, or unsupervised deep clustering (UDC) to generate clusters that are candidate lesion masks. The user then selects the cluster that serves as the best mask. Then for this proof-of-principle application, by reducing the tiling of each image to two clusters, the user-selected mask and its complement may be simplified, for the next step in the training set.
Using a training set comprised of lesions and masks obtained from UDC, train a deep reinforcement learning (RL) deep Q network (DQN) along in tandem with Q-learning to predict the best cluster to serve as lesion mask.

In so doing, lesion segmentations may be able to be produced with minimal input from the users. The user is spared from having to manually trace out a single lesion border. Additionally, given the data efficiency of RL, even the user effort to select masks from the UDC step can be minimized. This is due to the ability of RL to train effectively on very small data sets. Accurate lesion segmentations were produced with only 10 user-directed mask selections.

### 2. Methods

### I. Overview

The approach may be divided into a few key steps:
Collect 20 glioma MRI 2D images, the first 10 will be used for the training set, and the remaining 10 will comprise the testing set.
Use an unsupervised deep clustering (UDC) network to generate a set of possible lesion masks.
User selects appropriate mask.
Doing as above, 10 training set images+masks are obtained.
Train a reinforcement learning (RL) algorithm using Q-learning and a deep Q network to select the correct lesion masks automatically.

### II. Data Collection

Twenty available T2 FLAIR images of gliomas as screen captures were collected, using web sites accessed via from a database as well as from other sources.

### III. Clustering

a. Superpixel Generation

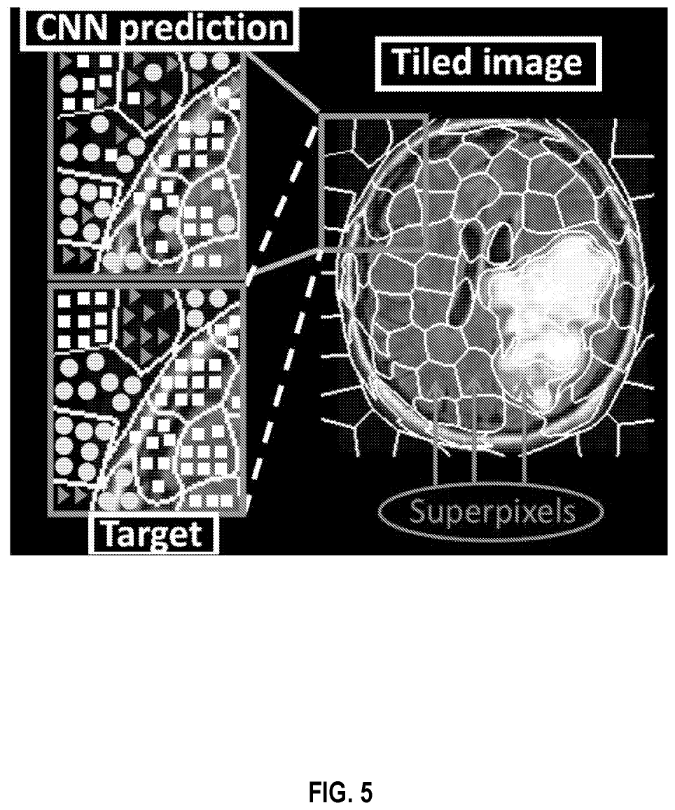

Consider for exemplification one of the training images. A tiling of the image may be generated using the SLIC method. This approach separates the image into Nₛₚ superpixels using nearest-neighbors with the features of red-green-blue color channel pixel intensity each in the range from 0 to 255 and x, y position. This tends to cluster together regions of the image that are of similar color and spatially close, with an example superpixel tiling displayed on the right image in FIG. 5. In order to ensure small enough superpixels so as not to artifactually group together disparate regions, a high number of superpixels Nₛₚ=1×10⁴ may be used. The python function skimage.segmentation.slic produces the tiling ultimately with a number of superpixels close to Nₛₚ. A parameter called compactness may be set equal to 100 in order to balance the influence of color proximity and space proximity. The SLIC tiling forms a scaffolding for the subsequent steps.

b. Clustering CNN

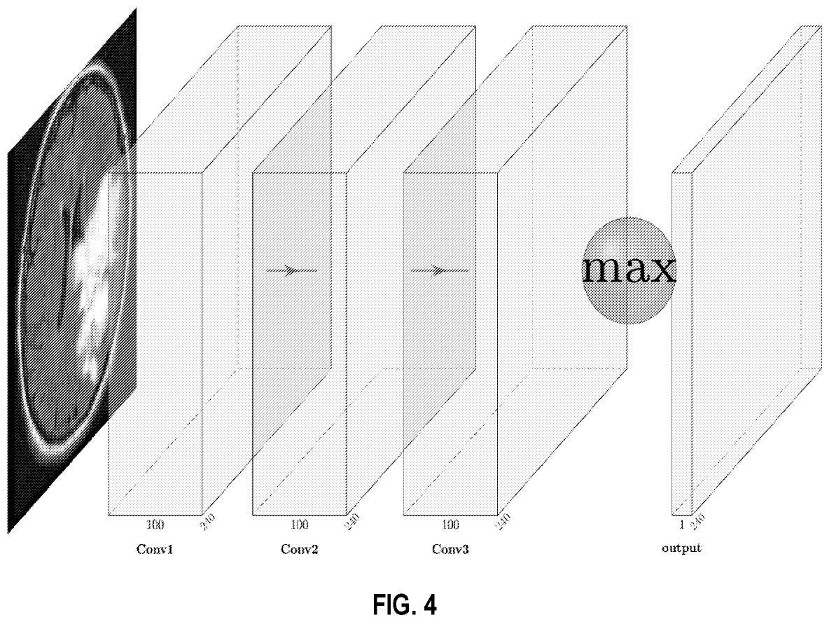

A forward pass of the convolutional neural network (CNN) shown in FIG. 4 may be run. Part of a sample output of the forward pass is displayed as the upper left panel in FIG. 5. The target is produced from this output by making the most numerous features selected for each superpixel to be the only feature present, for each pixel, within that superpixel. The target obtained from the sample output of FIG. 5 is shown as the lower left image of FIG. 5.

Then cross entropy between target and output provides pixel-wise classification CNN loss, which is minimized via backpropagation. The CNN thus learns during training to predict features for which all or as many as possible pixels in each superpixel have the same value. In other words, as the network trains, it becomes more confident about the categories to which small regions (superpixels) in the image belong. Then, grouping the superpixels together provides us with larger image clusters. This approach is thus an agglomerative (“bottom up”) type of hierarchical image clustering.

Because the network in 2 is unsupervised, it does not actually know the category or label of the clusters. However, it does learn that certain tiny regions belong together in the same cluster and class. Then it is up to the user to assign actual identities to these regions. A key step forward in the approach is to minimize the burden of user/expert oversight needed to inform the unsupervised network, thereby guiding it toward more meaningful predictions.

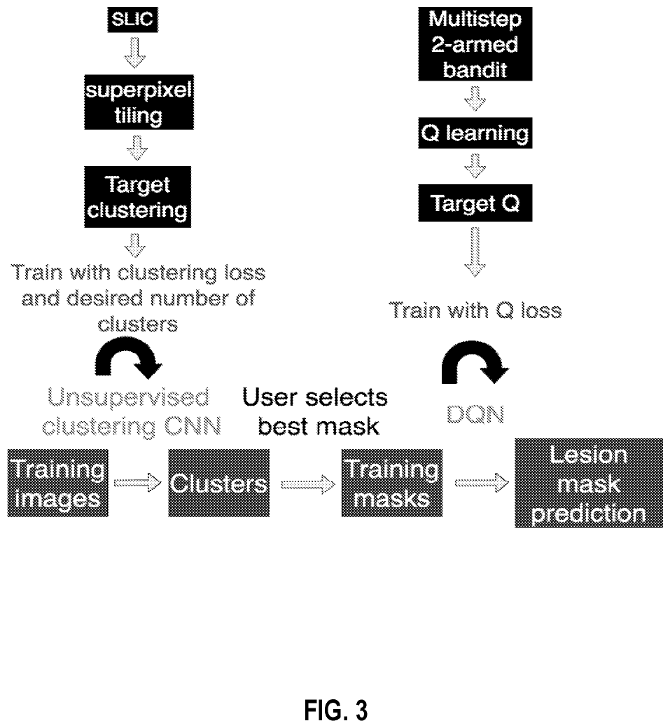

The network, as shown in FIG. 3, comprises 3 convolutional layers. 3×3 kernels with NC=100 channels and zero padding are used so as to maintain the H×W dimensions of the convolutional layers. Hence these layers are of size H×W×NC=240×240×100. Because the third layer also has these dimensions, the NC channel represents a 100-CNN-feature embedding. This provides higher order features than the simpler red-green-blue and x, y-coordinates, and the most important features for clustering are determining by backpropagation. As stated above, loss is calculated as the cross entropy between CNN output and target. Since the target, for each superpixel, can be specified via a one hot encoding vector, the closer all of the CNN output pixels in the superpixel are to being of the same class and the class matching the one hot encoding vector, the higher the log and the lower the negative sum of log values, thus lower loss.

Training the clustering CNN is somewhat unique in that it ends when the number of clusters/classes, N_{cl} reaches down to 25. The clustering CNN trains to make output pixel features more homogeneous within superpixels, but also across superpixels. This represents the agglomerative building up of increasingly larger and “higher level” clusters, starting from the tiny superpixels (roughly 240×240 pixels÷10,000 superpixels 6 pixels per superpixel) and building up to what would ultimately be N_{cl}=1 (all of the image being in one class). Then it is up to us to determine the optimal number of classes at which to stop the training. Based on trial and error, it is found that N_{cl}=25 is a good number in terms of producing masks that encompass important structures, including the lesions. Hence, training is set to conclude as soon as N_{cl} reaches down to 25. Training to the goal of 25 classes typically takes on the order of 20 epochs, comprising a few seconds of training time.

Since it is desired that the user to interactively oversee the selection of lesion masks, and not wait around for very long, the network should be trained almost instantaneously. As such, candidate lesion masks can be provided by the CNN from 2 and the user can select the correct masks in real time. In order to achieve fast training, the relatively large learning rate of 0.1 may be used. However, with this higher learning rate, the risk against which has to be mitigated is that the tapering off in N_{cl} during training could occur too fast, or “skip” over intermediate values. Were this to occur, intermediate-sized features in the images might not be adequately factored into the ultimate clustering, comprising a loss of valuable information. In order to counteract possibly skipping over of intermediate-sized clusters, batch normalization may be applied after each convolutional layer. This keeps the network weights from getting too large. Stochastic gradient descent may also be used as the optimization iterative method, with the momentum value of 0.9. Unlike other optimization algorithms, stochastic gradient descent has no acceleration, which could combine with the large learning rate to make training unstable.

c. Evaluating Clusters and Selecting Best Masks

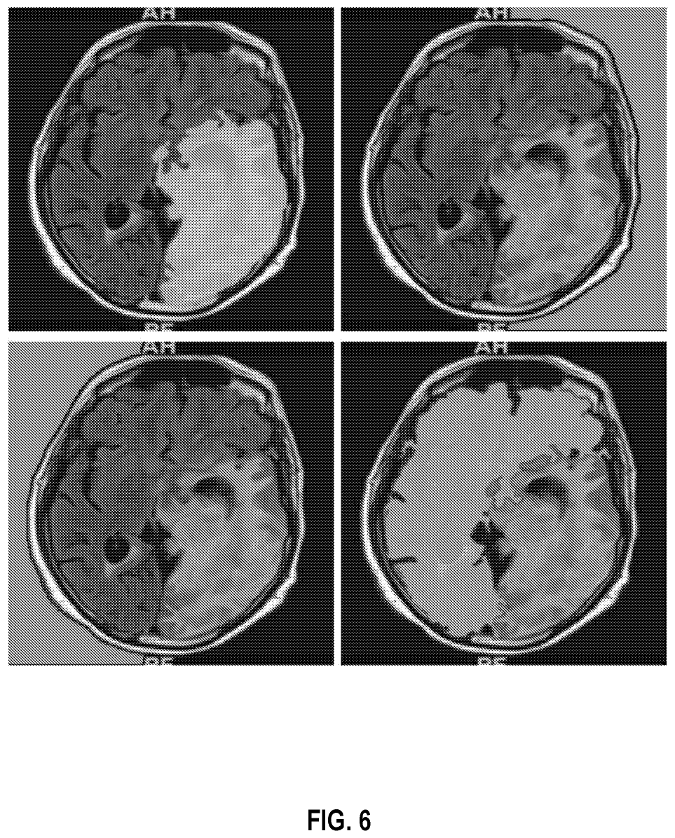

For each image, having generated N_{clusters}, small candidate masks that are likely artifactual may be removed by requiring that all candidate masks be over 1×10³ pixels large. Also, to avoid candidates that are overly large, an upper size boundary may be included, which is the total number of pixels in the image minus 1×10³ pixels. All of the candidate masks may be displayed for the viewer to select the best. This is displayed in FIG. 6. In that case, for example, the user would instantly recognize that first image contains the best mask. It is imagined that in an ultimate implementation, users could click on or dictate to indicate the best image, which would be fluid and efficient process. However, for this proof of principle, the user recorded the best image number by entering it into a python array. In the proof of principle, the center of mass points are used for each mask as this fiduciary point. Any point, even one selected at random from the image, could serve as this fiduciary point.

The user clicking on the best cluster may be envisioned for lesion mask selection. This would provide for the recording of a point within the lesion. This may be used as a fiducial point p_{fid}.

Proceeding as above for each of the 10 training set images, an array of length 10 containing indices of the best mask selections may be obtained for each image. Then, the 10 best masks may be reproduced to accompany the raw images by calling the array. Having obtained the 10 training masks, the task of training a separate network to detect and segment lesion masks may be performed without any user interaction.

### IV. Reinforcement Learning for Lesion Segmentation

a. Reinforcement Learning Environment, Definition of States, Actions and Rewards

State space. Here the various states are the different clusters as produced by the unsupervised CNN 2. For example in FIG. 6, the four possible states are the four sub-figures. The state that corresponds to the correct lesion mask is the first (upper left) sub-figure. In general, for an image tiling consisting of N_{cl} clusters, there are N_{cl} different states. For the purposes of simplicity in this proof-of-principle work, the state space may be restricted to two possible clusters, with a cluster overlaying the mask [symbol] and its complement [symbol] .

As constructed thus far, the scenario fits the framework of a multi(two)-armed bandit problem. This being the case, the multistep sequence of states sᵢ, which would be required to employ the Bellman Equation for updating Q, may be not had. Five subsequent states may thus be allowed to be explored per episode of training. As such, 5 transitions can be stored in the replay memory buffer each episode.

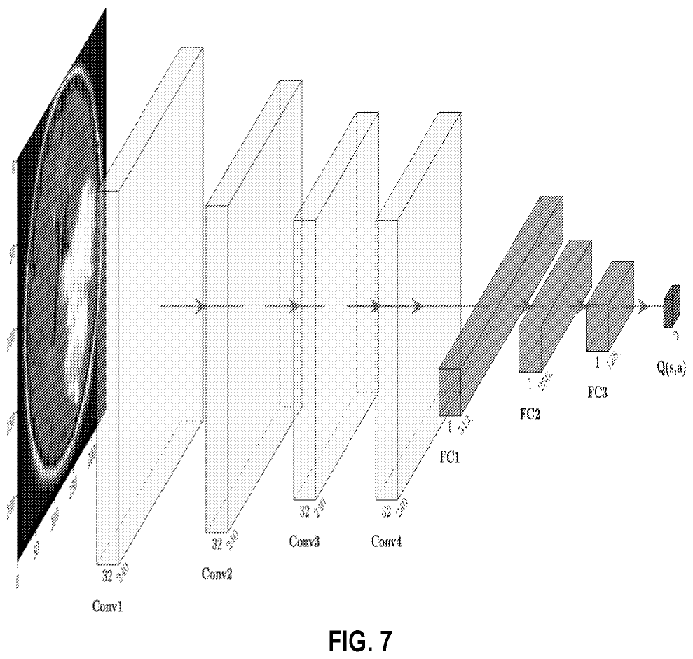

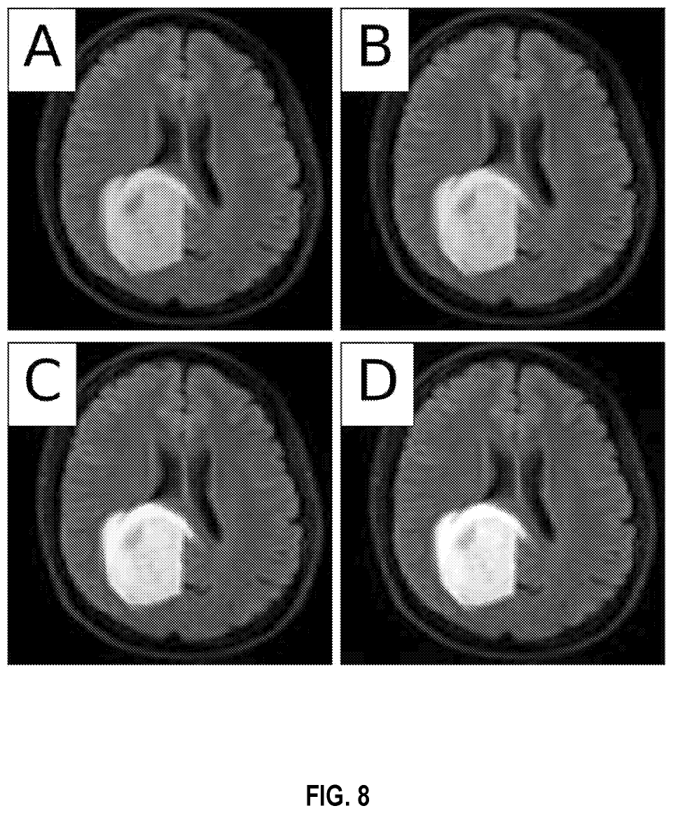

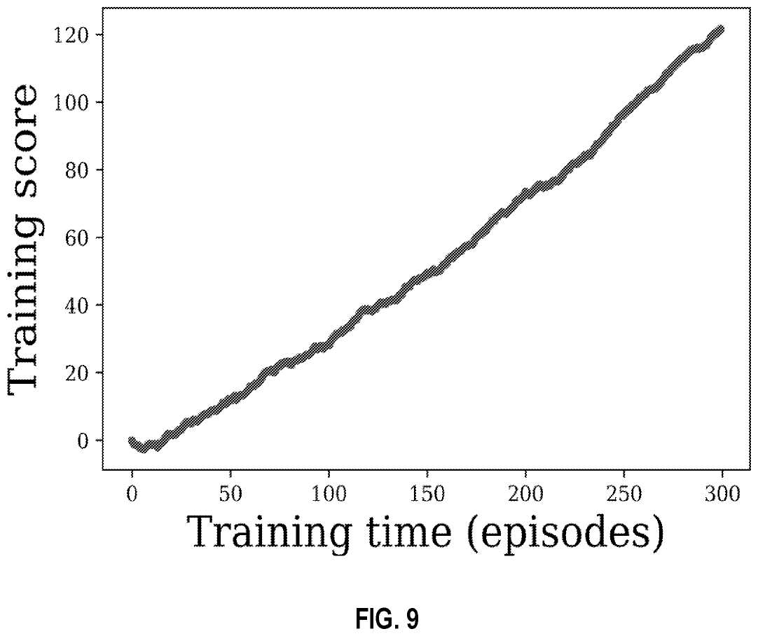

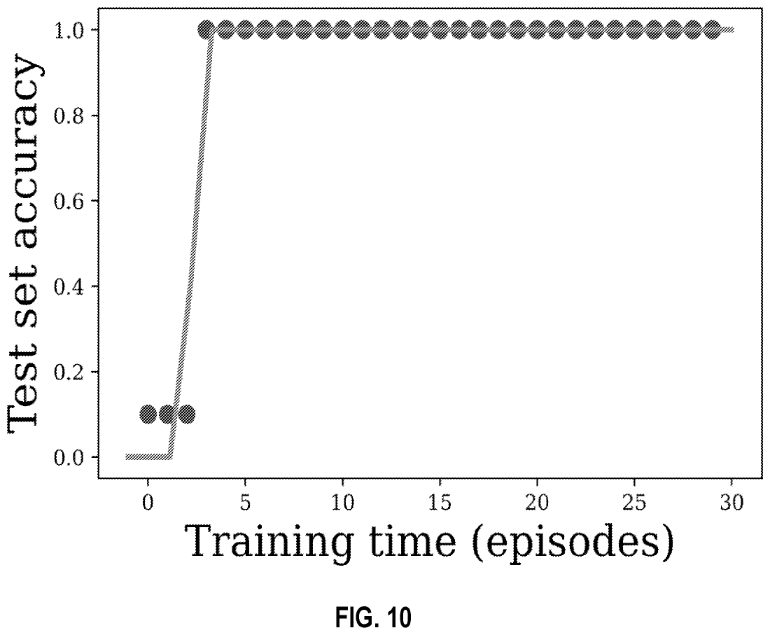

As in FIG. 6, color-coded clusters were overlaid onto the grayscale images to represent states sᵢ. The initial input image s₁ has the lesion mask colored in red, as shown in FIG. 7. For subsequent steps of environmental sampling for Q-learning, in general at time t the state sᵢ may be defined as:

$${s}_{t} = \{ \begin{matrix}red mask , if {a}_{t - 1} = 1 \\ green mask , if {a}_{t - 1} = 2\end{matrix} \qquad ( 1 )$$

where aₜ₋₁ is the action taken in the previous step.

Action space. The actions the agent can take consist of selecting the cluster in the image tiling that represents the lesion mask. In general, there are N_{cl} possible actions. In the simplified environment of the present disclosure, N_{cl}=2 is evaluated, so that the action represents selection of either [symbol] or [symbol] ^{C}. More specifically, the action selects a cluster as lesion mask by selecting the region to which p_{f} belongs. For the training set images, since the center of mass and the points of interest were selected, these are all inside the lesion masks.

In other words, the action space, generally AϵN₀^{Ncl}, but in the simplified case A∈N₀² is defined by:

$$A = ( \begin{matrix}1 \\ 2\end{matrix} ) = ( \begin{matrix}predict {p}_{f} ∈ M \\ predict {p}_{f} ∈ {M}^{C}\end{matrix} ) \qquad ( 2 )$$

Reward structure. It is sought to reward and incentivize choosing the correct cluster, while penalizing incorrect cluster selection. The reward scheme is thus given by:

$${r}_{t} = \{ \begin{matrix}+ 1 , if {a}_{t - 1} = 1 and point is within the lesion \\ + 1 , if {a}_{t - 1} = 2 and point is outside the lesion \\ - 1 , if {a}_{t - 1} = 1 and point is outside the lesion \\ - 1 , if {a}_{t - 1} = 2 and point is within the lesion\end{matrix} \qquad ( 3 )$$

b. Training: Deep Q Network

A convolutional neural network (CNN) is used, which is named a Deep Q network (DQN) to approximate the function for Qₜ(a). The architecture of the DQN is displayed in FIG. 7, and is very similar to DQNs. As before, it employs 3 kerns with stride of 2 and padding such that resulting filter sizes are unchanged. There are four convolutional layers, following up exponential linear unit (elu) activation functions. The last convolutional layer is followed by fully connected layers, ultimately producing a two-node output. The two output nodes correspond to the set of two Q(s, a) values, which depend on the state s and the two possible actions aₜ=1, 2. Q(s, a) is well-known from reinforcement learning as the action value function. Mean squared error loss is used, with batch size of n_{batch}=16 and learning rate of 1×10⁻⁴.

The DQN loss is the difference between output Q values, Q_{DQN}, and the “target” Q value, Q_{target}. The former is computed by a forward pass, F_{DQN}(sₜ) of the DQN, Q_{DQN}^{(t)}=F_{DQN}(sₜ). The latter is computed by the sampling the environment via the Bellman equation/temporal difference learning, as below.

c. Q-Learning Via TD(0) Temporal Difference Learning

As training learns the functional approximation of Q, bringing Q_{DQN} closer to Q_{target}, it is desired to simultaneously to optimize the latter toward the best possible Q value, Q*, by sampling from the environment. This may be achieved via temporal difference Q-learning in its simplest form: TD(0). With TD(0), Q_{target}^{(t)} get can be updated by way of the Bellman Equation:

Q_{target}^{(t)}=rₜ+γ maxₐQ(sₜ₊₁,a) (4)

where γ is the discount factor and maxₐQ(sₜ₊₁, a) is equivalent t the state value function V(sₜ₊₁). The most important part of the environment sampled is the reward value rt.

Over time, with this sampling, Q_{target}^{(t)} converges toward the optimal Q function, Q*. In the implementation, for each episode, the agent was allowed to sample the image for 20 steps. γ=0.99 is used, a frequently used value that, being close to 1, emphasizes current and next states over but includes those further in the future.

Q-learning is off-policy, in the sense that the policy for sampling state-action space is not the same that is followed to select new actions. Each action at is selected at time step t according to the off-policy epsilon-greedy algorithm, which seeks to balance exploration of various states with exploiting of known best policy, according to:

$${a}_{t} \{ \begin{matrix}{max}_{a ϵ A} \{ {Q}_{t} ( a ) \} , with probability ∈ \\ random action in A , with probability {1}_{- ∈}\end{matrix} \qquad ( 5 )$$

for the parameter ϵ<1. An initial ϵ of 0.7 was used to allow for adequate exploration. As Q-learning proceeds and it is wished to increasingly favor exploitation of a better known and more optimal policy, c may be set to decrease by a rate of 1×10⁻⁴ per episode. The decrease continued down to a minimum value ϵₘᵢₙ=1×10⁻⁴, so that some amount of exploring would always take place.

d. Replay Memory Buffer

Using Q-learning, states, actions taken, next states and rewards from the actions may be stored as transition values. More formally, for time t, the given state sₜ, action at, resulting in reward rₜ and bringing the agent may be stored to new state sₜ₊₁. These values are collected in a tuple, called a transition, [symbol] =(sₜ, aₜ, rₜ, sₜ₊₁). For each successive time step, successive transitions were stacked as rows in a transition matrix T. This was done up to a maximum size of N_{memory}=1,800 rows. This is the replay memory buffer, which allows the DQN to learn from past experience sampling from the environments of the various training images and states. After reaching N_{memory}=1,800 rows, ∀t>N_{memory}, new rows [symbol] are added while the earlier rows are removed from T.

During DQN training, batches of batch size nbatch transitions are randomly sampled from T. This allows a thorough and well distributed sampling of environments and states so that Q_{DQN} is as generalized as possible.

In all, for N_{episodes}=300 episodes were sampled, each consisting of 5 successive states, each of which begins with s₁, which is randomly selected for each episode among the 10 training sets.

### 3. Results

### I. Applied of Trained UDC+RL to Testing Set

For each of the 10 testing set images, it is predicted which to cluster ( [symbol] or [symbol] ^{C}) the fidelity point p_{f} belongs. In this case, for simplicity lesion mask center of mass points were used. For each image, a state may be generated as was done for the training images. Then, each state may be run through the trained DQN and extract the best action as the index of the larger of the two predicted Q values, i.e., argmax(Q_{DQN}). This selects the predicted lesion mask.

### II. Training a U-Net for Comparison

It is sought to compare the performance of RL to Supervised Deep Learning. Given that the task here is lesion mask generation/segmentation, the Supervised CNN used is the U-net architecture that was applied successfully to segment brain aneurysms and meningiomas.

The 16-layer U-net was trained on the training set of 0 images and corresponding masks for 50 epochs. Epoch is used in analogy to the episodes from RL. A batch size of 4, Adam optimizer with learning rate of 1×10⁻⁵, loss function given by the negative Dice Similarity score between network output and hand annotated mask were used.

These parameters and network architecture provided accurate segmentation when provided with training set sizes in the hundreds, further increasing by data augmentation. However, in this case, given the extremely small training set size, the network began overfitting the training data early in the training process and wound up badly overfitting the training set, an unsurprising result. The result was not generalizable to the separate testing set, for which the Dice score was 16%.

### III. Comparison Between Unsupervised Deep Clustering+Reinforcement Learning Segmentation and Supervised Deep Learning and U-Net

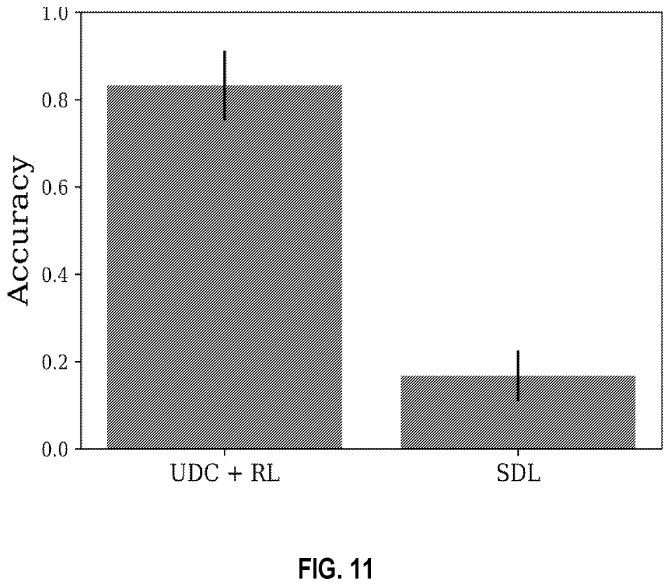

The average Dice Similarity Score for UDC+RL segmentation was 83%, while again that for the trained Deep Supervised Network with U-net architecture was 16%. The difference was statistically significant with a p-value of 5.3×10⁻¹⁴. A visual comparison of the performance of the two trained networks is shown as a box plot in FIG. 11.

### 4. Discussion

It is shown that a combination of unsupervised deep clustering and deep reinforcement learning can produce accurate lesion segmentations. Furthermore, it is able to do so with very small training set, similar to results in recent lesion localization work with RL. This together with the fact that even for that small training set, the user was only required to select the best mask from the candidates produced by the unsupervised clustering CNN. The user did have to perform a single contour tracing annotation.

This was an initial proof-of-principle work with some important limitations and goals. For simplicity, the number of clusters produced were restricted by the clustering CNN to be N_{cl} 2 clusters or classes, the lesion mask and its complement. In general, the clustering CNN would tile the image into N_{cl} clusters. Through trial and error, it was found that for these images, around 25 clusters gave the best segmentation of important structures. The general approach would be a slight generalization of that presented here, using N_{cl} possible actions, which would select the cluster of interest. The cluster ultimately selected would be the predicted mask. The initial tiling into superpixels by SLIC was just one of many initial schemes that can be incorporated into a CNN-based clustering algorithm. Others may prove more effective for the types of images under analysis, and a comparison between different approaches is another topic.

Finally, the ultimate goal is extension of the approach to fully three-dimensional image stacks. This would provide lesion volumes, as opposed to the two-dimensional areas.

### C. Deep Reinforcement Learning Based Image Classification

Presented herein are systems and methods for deep reinforcement learning-based image classification that achieves perfect testing set accuracy for magnetic resonance imaging (Mill) brain tumors) with a minimal set of images (e.g., only 30 images). The classification may be applied to any type of modality, such as radiology (e.g., Mill, x-rays, computed tomography scans, and ultrasound), histopathology (e.g., whole slide imaging), and photography (e.g., images and video frames), among others. It is proposed to use deep reinforcement learning with a multistep Markov Decision Process to perform image classification. Having successive states permits use of the Bellman equation for the reinforcement learning agent to explore the environment and record transitions. For training, the images to be classified are converted into states whose class can be identified by some overlaid component to the image. For example, in the proof-of-principle application to classifying brain MM images into normal and tumor-containing, a red overlay and green overlay may be used to distinguish between the two class predictions. This can be used for any number of classes however, for example with different color overlays such as blue, yellow, etc., or some other image featured placed into the image such as for example an ingrained number.

In this application, correct class prediction (the action) provides the reinforcement learning agent with a reward of +1, while incorrect prediction penalizes with a reward of −1. The next state, if correctly predicted, is the image in green overlay. If an incorrect prediction is made, the next step is the red overlay.

Purpose: Image classification may be the fundamental task in imaging artificial intelligence. Reinforcement learning can achieve high accuracy for lesion localization and segmentation even with minuscule training sets. Here, reinforcement learning for image classification may be introduced. In particular, the approach may be applied to normal vs. tumor-containing 2D MRI brain images.

Materials and Methods: multi-step image classification may be applied to allow for combined Deep Q-learning and TD(0) Q-learning. The model may be trained on a set of 30 images (15 normal and 15 tumor-containing). A separate set of 30 images (15 normal and 15 tumor-containing) may be tested. For comparison, a supervised deep learning classification network may be trained and tested on the same set of training and testing images.

Results: Whereas the supervised approach quickly over-fit the training data and as expected performed poorly on the testing set (57% accuracy, just over random guessing), the reinforcement learning approach achieved an accuracy of 100%.

Conclusion: A proof-of-principle application of reinforcement learning to classification of brain tumors is shown. Perfect testing set accuracy may be achieved with a training set of merely 30 images

### 1. Introduction

Image classification may be the fundamental task of artificial intelligence (AI) in radiology. Essentially all AI classification currently practiced, like the tasks of localization and segmentation, falls within the category of supervised deep learning.

Supervised deep learning (SDL) classification research necessitates acquiring and often pre-processing a large number of appropriate images consisting of the various categories of interest. Typically, hundreds and often thousands or tens of thousands of images are needed for successful training. Radiologists must label each image, specifying the class/category to which each belongs. Often to increase (somewhat artificially) the training set, augmentation operations are performed. Once enough data is gathered, processed, and labeled, it can be fed into a convolutional neural network (CNN) that predicts image classes from the output.

SDL in general suffers from three crucial limitations that is sought to be addressed here through reinforcement learning:
1 As above, SDL requires many curated and labeled images to train effectively.
2 Lack of generalizability renders SDL susceptible to fail when applied to images from new scanners, institutions, and/or patient populations. Importantly, this limits clinical utility.
3 The “black box” phenomenon of non-understandable AI, in which algorithm opaqueness hinders trust of the technology. Trust is paramount for consequential health care decisions. Obscurity also limits contributions from those without extensive AI experience but with advanced domain knowledge (e.g., radiologists or pathologists).

The concept of radiological reinforcement learning (RL) may be introduced. It is shown that RL can address at least two of the above challenges when applied to lesion localization and segmentation.

Another fundamental task of deep learning is classification. Classifying an image into two generalized categories (normal and abnormal) is widely viewed as a fundamental task. As such, and as two-outcome classification can be generalized to any number of different classes, it is sought here to use RL for two-category classification as a proof-of-principle.

### 2. Methods

### I. Data Collection

Sixty two-dimensional image slices may be collected from a brain tumor database. All images were T1-weight post-contrast and obtained at the level of the lateral ventricles. Of the 60 image slices, 30 were judged by a neuroradiologist to be normal in appearance. The other 30 contained enhancing high grade gliomas. Thirty images (15 normal and 15 tumor-containing) may be employed for the training set. The other 30 (15 normal and 15 tumor-containing) were assigned to the testing set.

### II. Reinforcement Learning Environment, Definition of States, Actions, and Rewards

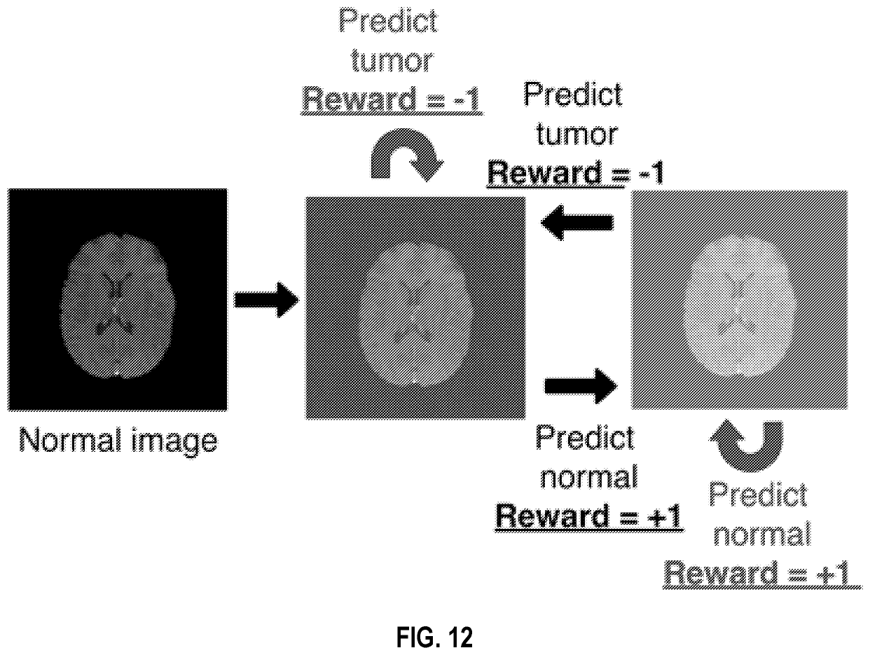

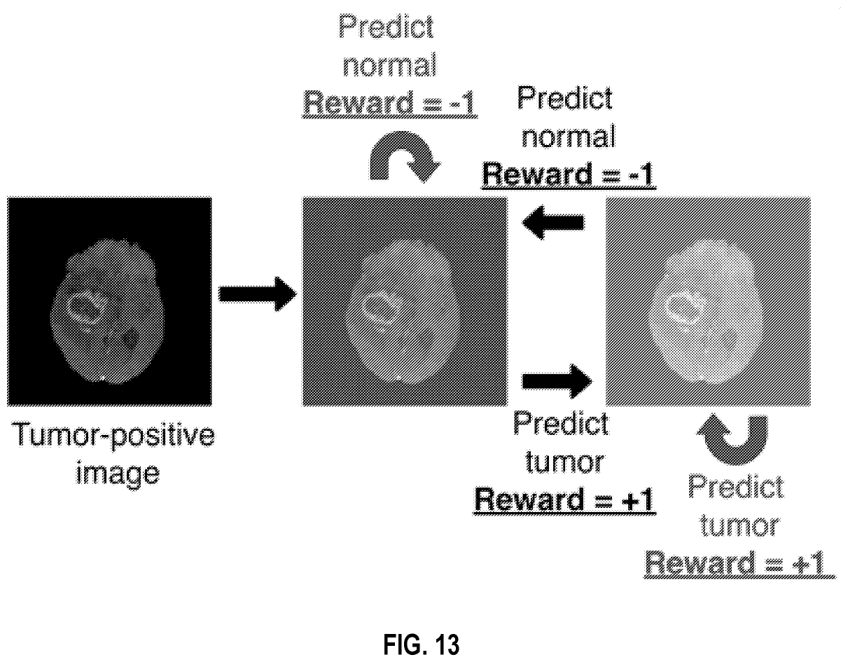

In keeping with standard discrete-action RL, the framework used to produce optimal policy is the Markov Decision Process (MDP). The MDP for this system is illustrated in FIGS. 12 and 13. The former illustrates the MDP for a normal image. The grayscale representation of the image is overlaid in red or green to represent the states. For the purpose of illustration, in these figures, the alpha value for transparency was set higher than in these actual calculations (0.5 vs. 0.1) to make the colors appear sharper.

The grayscale image is converted to red-overlay, the latter representing initial state, sᵢ. At each step in the episode (5 steps per episode during training), the agent takes an action. That action, represented by either 0 or 1, predicts whether the image belongs to the normal or tumor-containing class, respectively. If the action predicts the correct class, the next state is green-overlay. If it predicts the wrong class, which in the case of a normal image would be to predict tumor-containing, the state would remain red-overlay or flip from green-overlay to red-overlay. The reverse is true for the tumor-containing image, shown in FIG. 13. If the action is 0, predicting normal image, the next state is red-overlay, whereas if it makes the correct prediction of tumor-containing (action at =1), the next state sₜ₊₁ is green-overlay.

The agent is provided a reward of +1 for taking the correct action/class prediction, and is penalized with a reward of −1 for a wrong action/prediction. This is also shown in FIGS. 12 and 13. The ultimate goal of RL training is to maximize total cumulative reward.

### III. Training

An off-policy c-greedy strategy that permits exploration of non-optimal states may be employed. This allows the agent to learn about the environment by exploring states with a randomness that over time gives way to more deterministic, on-policy actions as the agent learns the environment and gets closer to an optimal policy. Again, ε=0.7 may be used for initial random sampling, slowly decreasing to the minimal value εₘᵢₙ=×10⁻⁴.

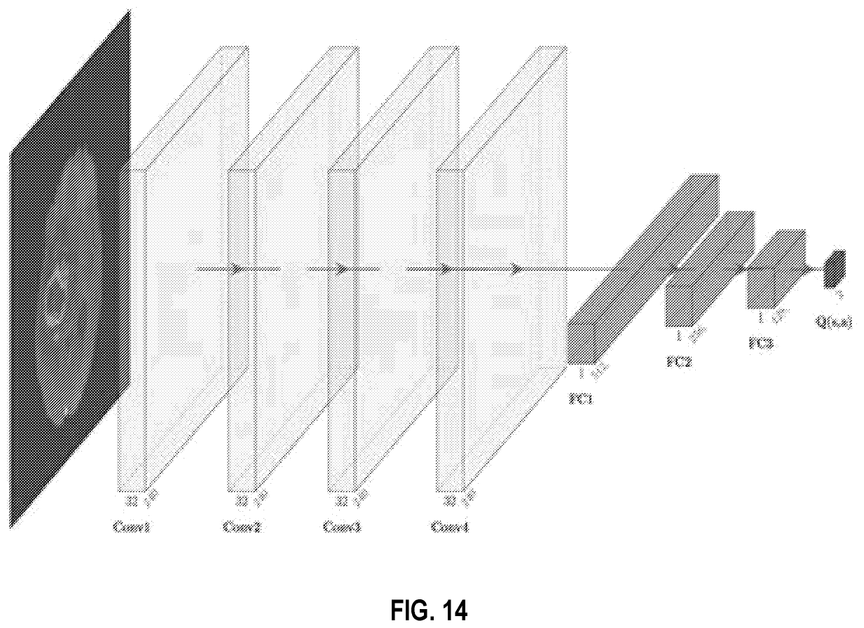

A Deep Q network (DQN) may be also employed in tandem with TD(0) Q-learning. The former computes actions from input state via the DQN, which is basically a CNN, displayed in FIG. 14. The architecture is essentially identical to that used in the recent work for lesion localization and segmentation. The two outputs from this network are the state-action value function Q(sₜ, aₜ). Q(sₜ, aₜ) computes the value of taking action at in state sₜ.

These agent samples states and learns about the environment via the reward, which refines the version of Q that is called Q_{target}. These may be sampled via temporal difference Q-learning in its simplest form: TD⁽⁰⁾. Doing so, for time t, Q(t) may be updated via the Bellman Equation:

Q_{target}=rₜγ maxₐQ(sₜ₊₁,a) (1)

where γ=0.99 is the discount factor, which reflects the relative importance of immediate vs. most distant future rewards, and maxₐQ(sₜ₊₁, a) is equivalent to the state value function V (sₜ₊₁).

With repeated sampling by Equation 1, Q(t) eventually converges toward the optimal Q function, Q*. As implied by the name, Q_{target} serves as the target in the DQN from FIG. 14. Hence, minimizing the loss between the network output Q_{DQN} and Q_{target} via backpropagation in combination with sampling the environment through the Bellman Equation, it is arrived at:

_{t→∞}^{lim}(Q_{DQN}(t))=Q* (2)

By following the above-described process, a CNN/DQN approximation of the optimal Q function may be arrived at. This may be allowed to act as per the optimal policy thereafter. It can be done so in state s by selecting action a=maxₐQ(s, a), where Q(s, a) is produced by a forward pass of the trained DQN on input state s.

As described in earlier work, the data on which the DQN trains is obtained by the “memory” of prior state-action-next state-reward tuples, stored in a so-called transition matrix T. T is of size 4×N_{memory}, N_{memory} being the replay memory buffer size. The value of N_{memory}=1,500 may be used based on recent experience, noting that this tends to produce enough samples to represent the agent's experience, while not overwhelming the CPU capacity. During DQN training, batches of size n_{batch}=32 transitions are randomly sampled from T.

At each step of training, a normal or tumor-containing image is sampled randomly with equal probability. Each episode of training consists of five steps as per FIGS. 12 and 13. The model may be trained for a total of 300 episodes. Regarding the DQN, the Adam optimizer may be used with learning rate of 1×10⁻⁴ and using mean squared error loss between Q_{DQN} and Q_{target}. 3×3 convolutional kernels may be used, with weights initialized by the standard Glorot initialization.

At each step of each episode, a new row of T is calculated, a new value of Q_{target} can be computed and compared to Q_{DQN} for an additional element of the loss, and another iteration of forward and backpropagation can occur. Hence the DQN is trained for a total of N_{episode}×nₛₜₑₚₛ=300×5=1, 500 “epochs.” In order to keep N_{memory} fixed at 1, 500, older transitions are discarded from T in favor of newly computed transitions.

### IV. Supervised Deep Learning (SDL) Classification for Comparison

To compare SDL and RL-based classification, the same 30 training set images may be trained with a CNN with architecture essentially identical to that of the DQN. The CNN also consisted of convolutional layers followed by elu activation employing 3×3 filters. As for the DQN, this was followed by three fully connected layers. The network outputs a single node, which is passed through a sigmoid activation function given the direct binary nature of the CNN's prediction (normal vs. tumor-containing). The loss used here is binary cross entropy. Other training hyperparameters were the same as for the DQN. The supervised CNN was trained for 300 epochs.

### 3. Results

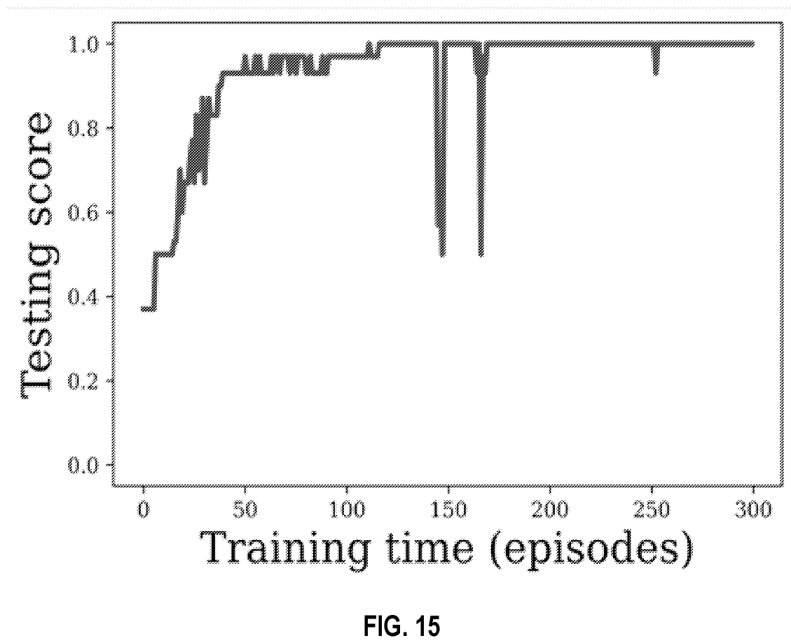

The testing process for the RL approach consisted of making a single step prediction on the testing set images with initial states of red-overlay. FIG. 15 shows the testing set accuracy as a function of training time. Steady learning may be generalized to the testing set, essentially plateauing at 100% accuracy within 200 episodes. No strict analogue for training time exists between RL and SDL. However, the most analogous measures of episodes and epochs may be used, respectively.

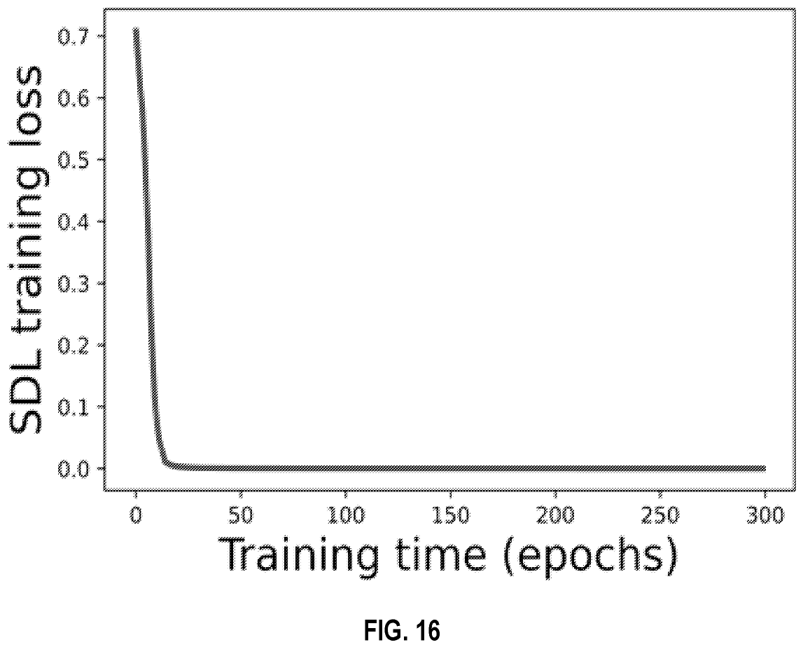

The loss during training of the supervised CNN is shown in FIG. 16. The network is seen to train properly, with an initial sharp drop in loss as it quickly overfits the exceedingly small training set.

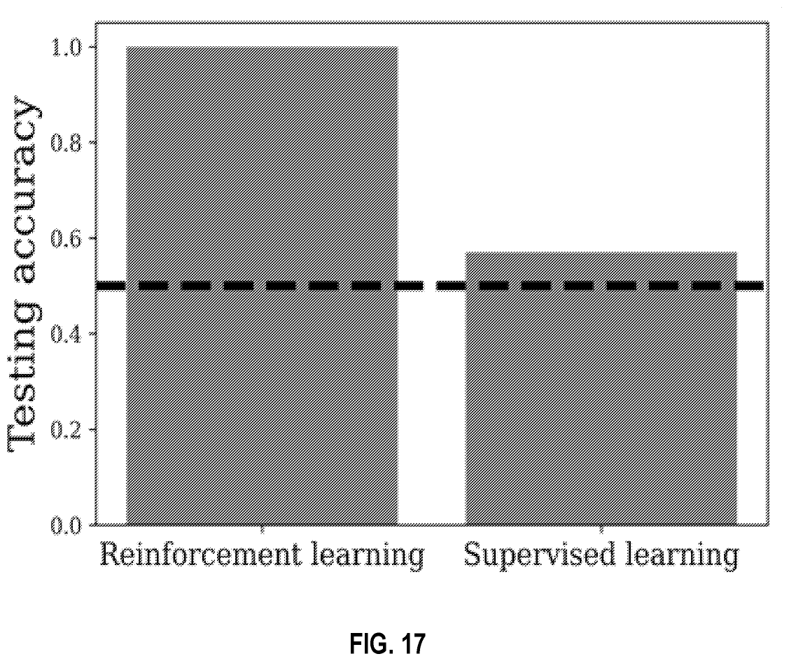

The testing set accuracy of RL and SDL may be compared in FIG. 17. In contrast to the 100% accuracy of RL, SDL has a mere 57% accuracy for the testing set, just above a 50% random guess. This is due to the fact that SDL is bound to overfit the very small training set whereas RL learns general principles that can be applied with success to the separate testing set.

### 4. Discussion

It is shown that, when applied to a small training set, reinforcement learning vastly outperforms the more other supervised deep learning for lesion localization, segmentation, and classification.

D. Image Noise with Multi-Step Reinforcement Learning for Medical Image Analysis

Purpose: A multistep reinforcement learning (RL) is used to perform multiple image analysis tasks. Namely, the approach for lesion localization and image classification may be used on brain MM. Improved analysis is demonstrated by adding random image noise during training. Such improvement may be shown for the task of two-class classification, by adding random image noise during training. However, multistep RL with random noise added to the training images could be used in any artificial intelligence image analysis task, such as lesion/object localization or segmentation.

Methods: Multistep Markov Decision Process (MDP) RL algorithms were applied to and trained on a 3D brain Mill database. The MDP-RL both with and without image noise may be trained. Two classes were present: “normal” (tumor-free) and tumor-positive.

Results: MDP-RL trained with noisy images achieved 100% testing set accuracy. Further, it produced many candidate policies with perfect accuracy. On the other hand, MDP trained on noiseless images attained 96% accuracy. It did so for only a single policy produced, with all other policies reaching lower testing set accuracies.

Conclusion: Exposure to random noise amplifies MDP-RL's ability to sample environments thoroughly. It does so by making successive states in the MDP slightly different, although they belong to the same class. It is thus shown that adding noise produces more robust MDP-RL algorithms.

### 1. Methods

### I. Data Collection

A data set of 3D image volumes may be used. Half had normal brain Mills, the other half with brain metastases, totaling 64 patients. These may be partitioned into 40 training set images and the remaining 24 into the testing set. Both training and testing sets were class balanced, evenly divided between normal and tumor-containing images.

a. Action Selection

The epsilon-greedy algorithm may be used during training, which balances exploration by taking and learning from random actions, and exploitation, in which the current optimal action is chosen. Exploration consists of selecting either of actions a₁ or a₂ at random, with equal probability. Exploitation is obtained from the argmax of Q(a₁) and Q(a₂), computed as the output nodes from forward pass of the Deep Q Network (DQN) on state s. The probability of exploration is 1−ϵ, where ϵ starts at 0.7 and decreases to 0.5 over the course of 2,000 episode training. However, it is noted that ϵ can be further decremented down to nearly zero, thereby highly favoring exploitation toward the end of training. Since the goal was to find locally optimal policies, a relatively high exploration rate throughout the training was deemed appropriate.

b. Rewards

Upon selection selecting action at from state sₜ at time t, the reward received rₜ is defined according to:

$${r}_{t} = \{ \begin{matrix}1 , if {a}_{t} represents the correct class prediction for state {s}_{t} \\ - 1 , if {a}_{t} represents the wrong class prediction for state {s}_{t}\end{matrix} \qquad ( 1 )$$

c. States

Each state consisted of a 36×64×64 post-contrast T1-weighted image volume, along with a scalar quantity indicating whether the previous step's class prediction (normal vs. tumor-containing) was correct. This prediction correctness is denoted as pred_corr. It is defined by:

$$pred\_corr = \{ \begin{matrix}1 , if prediction is correct \\ 0 , if prediction is wrong\end{matrix} \qquad ( 2 )$$

d. Replay Memory Buffer

A tensor called the replay memory buffer may be populated during training. The replay memory buffer may be sampled for backpropagation of the Deep Q Network (DQN). The current state, action taken, reward received, and next state, St, at, rₜ, and sₜ+1, respectively, may be stored in the replay memory buffer.

The replay memory buffer tensor T is of size 4×N_{memory}, where N_{memory} is the replay memory buffer size. The value of N_{memory}=1,500 may be used based on recent experience, noting that this tends to produce enough samples to represent the agent's experience while not overwhelming CPU capacity.

During DQN backpropagation, batches of size n_{batch}=32 transitions may be randomly sampled from T. At given episode i, the state sᵢ is forward passed through the DQN to produce action aᵢ, producing a reward rᵢ. These are stored in the tuple/i^{th} row of T as Tᵢ=(sᵢ, aᵢ, rᵢ, sᵢ₊₁).

e. Sampling from the Replay Memory Buffer for DQN Backpropagation

Once T is adequately populated, sampling batches from the buffer for backpropagation may begin. The loss needed for doing so is given by mean squared error or L2 loss between the two state-action values, Q_{DQN} and Q_{target}, where:
Q_{DQN}(St, a) is obtained by forward propagating state s through the DQN, where action a is selected in an off-policy manner using the epsilon greedy algorithm.
Q_{target} is obtained by sampling the environment and employing the Bellman equation. Here the TD(0) formulation of temporal different learning may be used: Q_{target}=rₜ γ*maxₐQ_{DQN}(sₜ₊₁, a). maxₐQ_{DQN}(sₜ₊₁, a) represents the optimal action of the next step in the MDP.

Hence the loss over a batch is given by:

loss=L₂({Q_{DQN}}_{batch},{Q_{DQN}}_{batch}). (3)

The loss function enforces that the total cumulative reward expressed as the DQN approximation to the Q function be similar to the total cumulative reward that reflects the environment.

f. Deep Q Network (DQN)

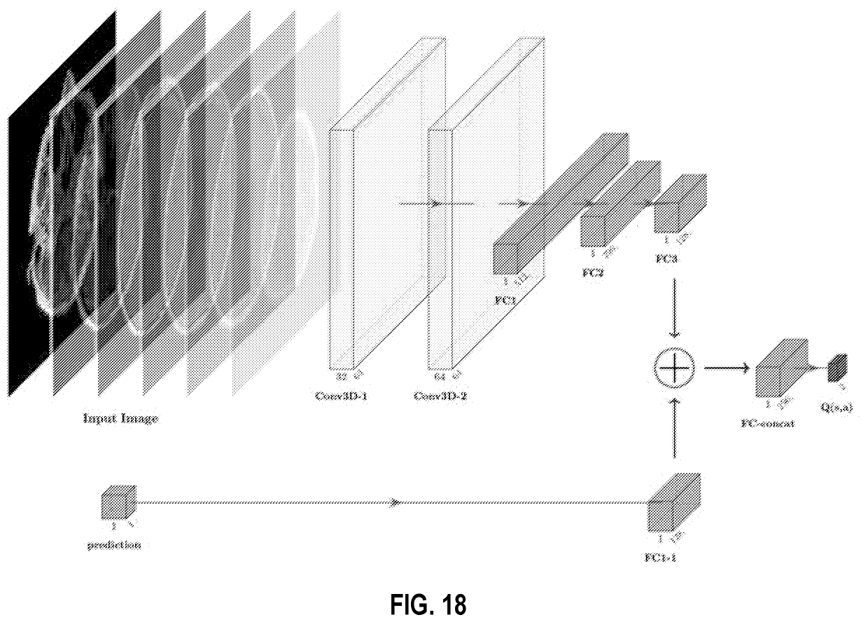

The DQN architecture is depicted in FIG. 18. The image volume undergoes 3D convolutions. Then the last convolutional layer is flattened and passed to a succession of fully connected layers. In a separate, parallel pathway, pred_corr is passed to a flattened layer. The latter is concatenated with the last fully connected layer of the image volume network branch. This concatenated layer is then connected to a two-node output. The output nodes represent the two Q values, Q(a₁) and Q(a₂), where the two possible actions a₁ and a₂ are defined as follows:
a₁: predict normal
a₂: predict tumor-containing

Hyperparameters are as follows:
batch size 32
kernels of size 5×5×5
stride of (2, 2, 2)
zero padding of (1, 1, 1)
Glorot initial weight randomization
ReLU activations
Mean squared error loss
Adam optimizer
learning rate 1×10⁻⁴
training length 2,000 episodes

### II. Reinforcement Learning Using MDP

a. MDP Without Added Image Noise

RL classification may be performed with a multistep MDP of 5 steps per episode. The Bellman Equation may be used to update target Q values based on a sampling of the environment via the reward.

b. MDP with Added Image Noise

The calculations of RL with MDP were repeated, except that the image part of the states had random noise added. The intuition was that the trained DQN could recognize underlying structures/patterns in the image beneath the noise, thereby providing robustness. It is hypothesized that this would leverage the more thorough environmental sampling that MDP offers.

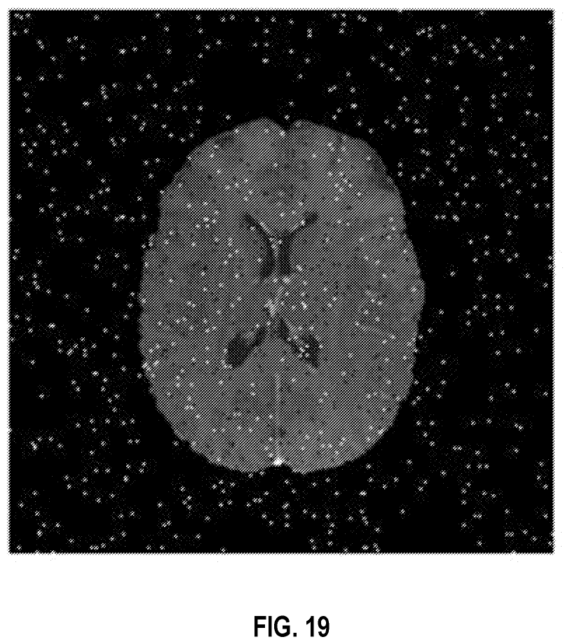

“Salt and pepper” noise may be added to the images. Such noise consisted of a random selection of pixels converted to black (pixel intensity 0) or white (pixel intensity 255). For these 3D images, noise may be generated for each 2D image slice, replacing from 100 to 200 pixels. This top of this range represented an upper bound pixel replacement proportion of 5%, low enough to leave the overall image identifiable. An example of a 2D noise-added image is shown in FIG. 19.

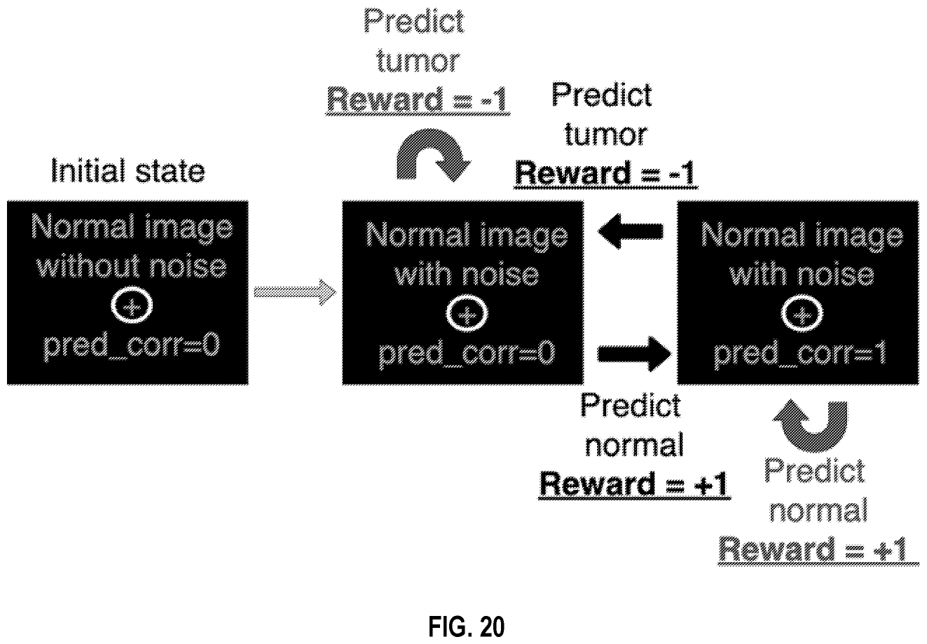

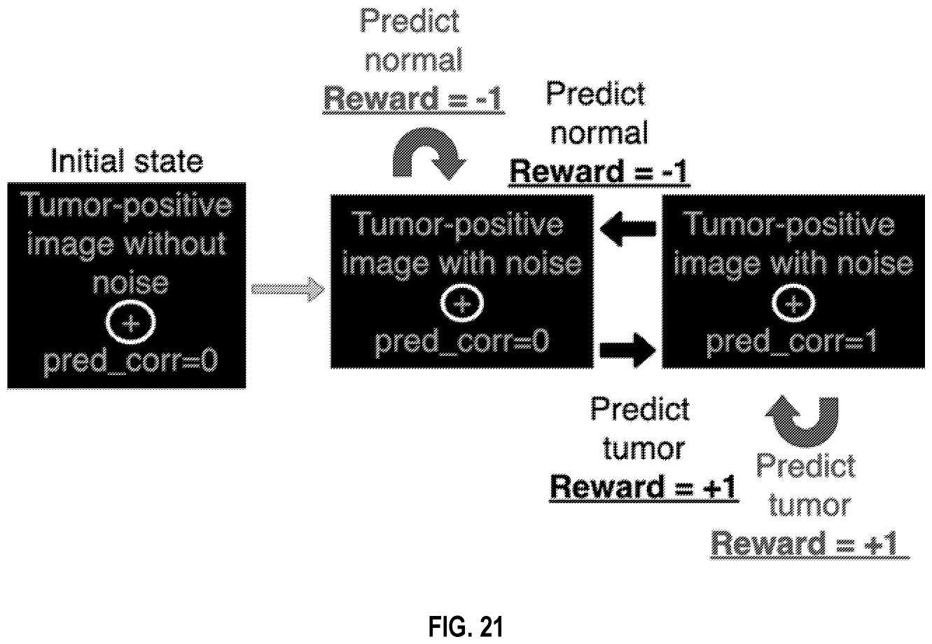

The MDP for noisy images is essentially the same as for MDP without added noise. The difference is that, while the initial state in the episode contains the grayscale image, subsequent steps use a state with noise added to the image, as above. Schematic illustrations of the MDP for a normal (without tumor) and tumor-containing image and state are shown in FIGS. 20 and 21, respectively.

### III. Training: Deep Q Network Architecture, Parameters, and Hyperparameters

Again, as shown in FIG. 18, for the DQN, a two-input architecture may be used. On one branch, the image volumes, again of size 64×64×36 voxels, were fed into a 3D convolutional neural network as input. The 3D convolutional kernels were of size 5×5×5. Initially randomized weights in the kernels may be used as per the Glorot distribution. Stride and padding were set as (2, 2, 2) and (1, 1, 1), respectively. The first convolutional layer has 32 channels, followed by a 64-channel layer. ReLU activation is employed after each convolutional step. The second convolutional layer is then flattened and passed to a fully connected layer of size 512 nodes; itself connected to a 256- then 64-node fully connected layer.

Separately, the scalar pred_corr, defined as zero if the previous step's prediction was wrong or one if correct, is connected to a 64-node fully connected layer. This layer is then concatenated with the 64-node fully connected layer from the image convolutions. In this manner, the DQN information about image volume and whether the previous prediction of image class was correct may be included.

The concatenated 128-node layer is finally connected to two output nodes, Q(a=0) and Q(a=1).

All of the testing set images may be individual run for predictions on the testing set after each set of 10 training episodes. Testing consisted of one step of applying the DQN to the input state: testing set image and initial pred_corr=0. Then, the argmaxₐ(Q(s, a)) may be computed, and this action was the predicted class. In other words, exploitation mode may be employed for the testing set.

### 2. Results

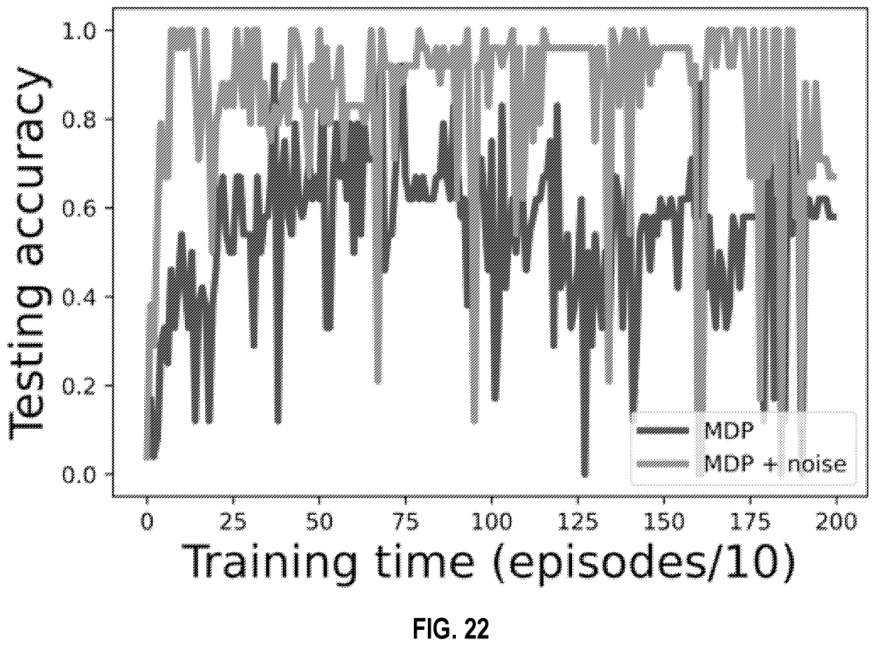

The testing set accuracy may be displayed as a function of training time in FIG. 22. MDP with noisy images produces a policy with the highest testing set accuracy of 100%; in fact, it produces many such policies. In contrast, MDP without noisy images produces a single policy with maximum testing set accuracy of 96%.

### 3. Discussion

MDP has the advantage that it can sample the environment in multiple steps per episode, thereby benefiting from losses that reflect information about the environment. As such, Information about the environment may be incorporated into the DQN. By adding random image noise, only the essential parts of the image are retained in the DQN, reflecting the underlying structure that determines image class.

### E. Systems and Methods for Models Established Using Reinforcement Learning to Perform Localization on Biomedical Images

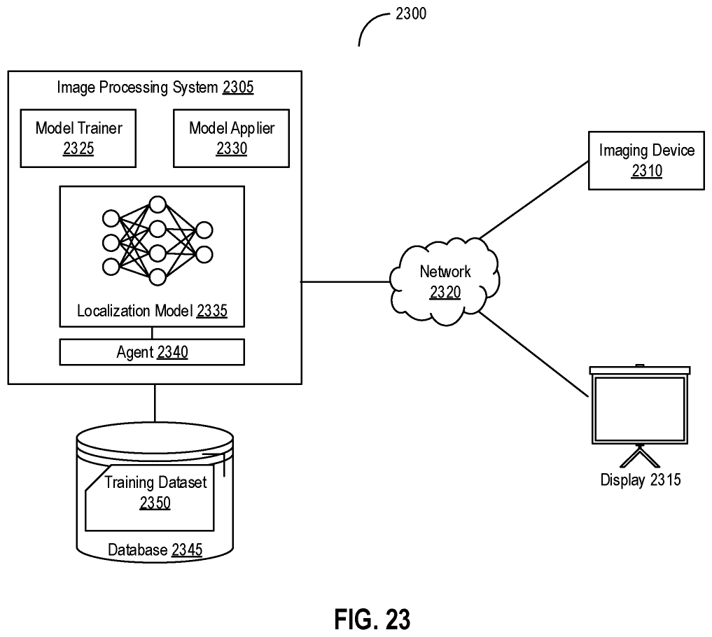

Referring now to FIG. 23, depicted is a block diagram of a system 2300 for localizing images. In overview, the system 2300 may include at least one image processing system 2305, at least one imaging device 2310, and at least one display 2315, communicatively coupled via at least one network 2320. The image processing system 2305 may include at least one model trainer 2325, at least one model applier 2330, at least one localization model 2335 for managing at least one agent 2340, and at least one database 2345, among others. The database 2345 may store, maintain, or otherwise include at least one training dataset 2350. Each of the components in the system 2300 as detailed herein may be implemented using hardware (e.g., one or more processors coupled with memory) or a combination of hardware and software as detailed herein in Section H. Each of the components in the system 2300 may implement or execute the functionalities detailed herein, such as those described in Sections A-D.

In further detail, the image processing system 2305 itself and the components therein, such as the model trainer 2325, the model applier 2330, and the localization model 2335 may have a training mode and a runtime mode (sometimes herein referred to as an evaluation or inference mode). Under the training mode, the image processing system 2305 may invoke the model trainer 2325 to train the localization model 2335 using the training dataset 2350. Under the runtime, the localization model 2335 may invoke the model applier 2330 to apply the localization model 2335 to acquired images from the imaging device 2310.

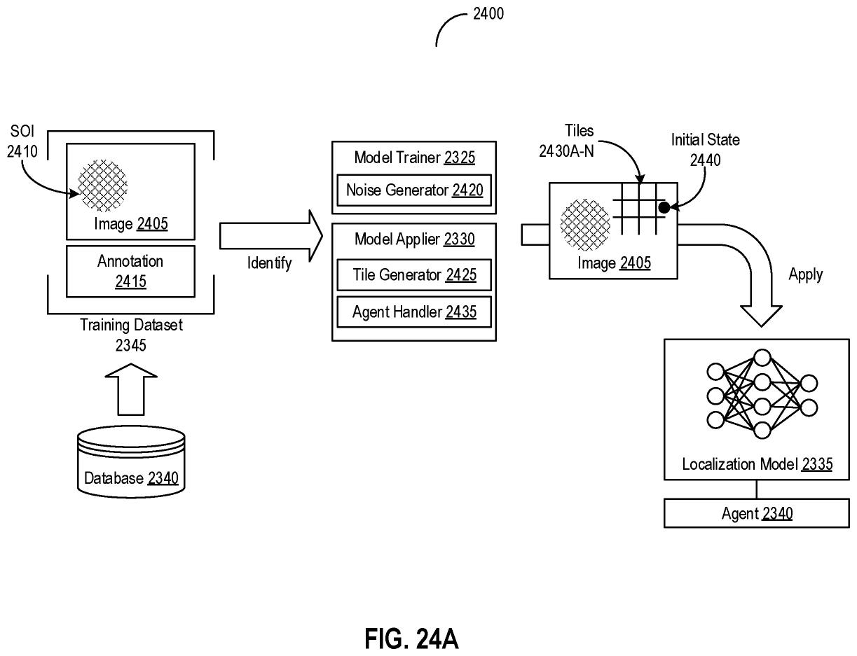

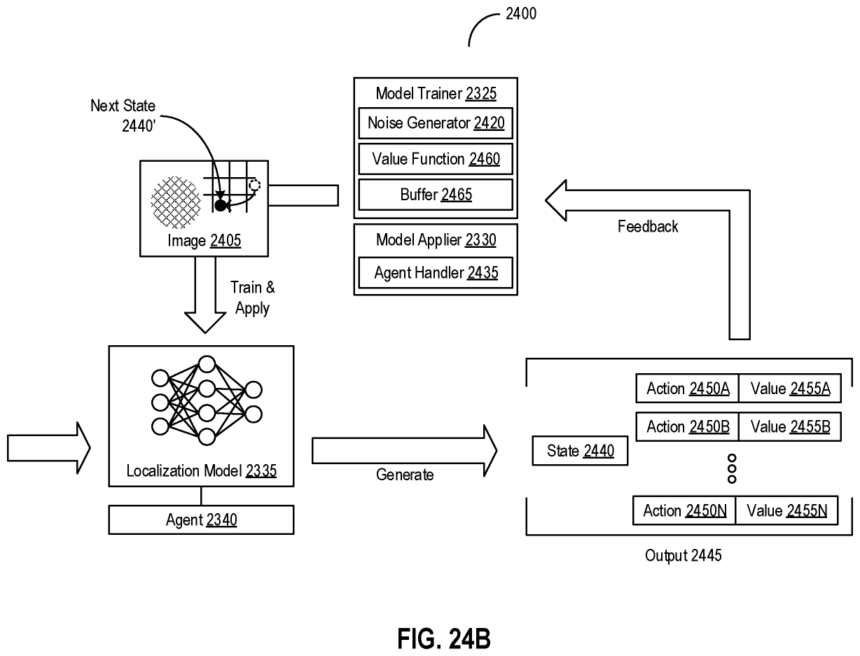

Referring now to FIGS. 24A and 24B, depicted are block diagrams of a process 2400 for training the localization model 2335 in the system 2300 for localizing images. The process 2400 may include operations performed by the image processing system 2305 under the training mode. Starting with FIG. 24A, the model trainer 2325 executing on the image processing system 2305 may initialize, train, or otherwise establish the localization model 2335. The localization model 2335 may include a set of transform layers with kernel parameters to manage the agent 2340. In initializing, the model trainer 2325 may set or assign values (e.g., random values) to the parameters in a set of transform layers of the localization model 2335. The agent 2340 may have a state with respect to an input to the localization model 2335. To train the localization model 2335, the model trainer 2325 may access the database 2340 to fetch, retrieve, or identify the training dataset 2345. With the identification, the model trainer 2325 may train the localization model 2335 using the training dataset 2345. The training of the localization model 2335 may be in accordance with reinforcement learning.

The training dataset 2345 may identify or include one or more examples. Each example may include at least one image 2405 (sometimes herein referred to as a sample image or example image). The image 2405 may be acquired, derived, or otherwise be of a sample (or object). The image 2405 may be a two-dimensional section of the sample or a three-dimensional volume of the sample (e.g., human subject). For example, the image 2405 may include a set of two-dimensional cross-sections (e.g., a front, a sagittal, a transverse, or an oblique plane) acquired from the three-dimensional volume. The image 2405 may be defined in terms of pixels, in two-dimensions or three-dimensions. In some embodiments, the image 2405 may be part of a video acquired of the sample over time. For example, the image 2405 may correspond to a single frame of the video acquired of the sample over time at a frame rate.

The image 2405 may be acquired using any number of imaging modalities or techniques. For example, the image 2405 may be a tomogram acquired in accordance with a tomographic imaging technique, such as a magnetic resonance imaging (MRI) scanner, a nuclear magnetic resonance (NMR) scanner, X-ray computed tomography (CT) scanner, an ultrasound imaging scanner, and a positron emission tomography (PET) scanner, and a photoacoustic spectroscopy scanner, among others. The image 2405 may be a single instance of acquisition (e.g., X-ray) in accordance with the imaging modality, or may be part of a video (e.g., cardiac MM) acquired using the imaging modality. Although the present disclosure discusses the image 2405 primarily in terms of a tomogram, other imaging modalities besides those listed above may be supported by the image processing system 2305.

The image 2405 may include at least one at least one structure of interest (SOI) 2410 (also referred herein as a region of interest (ROI)). The SOI 2410 may correspond to an area, section, or part of the image 2405 that corresponds to feature in the sample (or object) from which the image 2405 is acquired. In some embodiments, the SOI 2410 may correspond to a condition (e.g., a presence or lack thereof) of the feature in the sample. For example, the SOI 2410 may correspond to a part of the image 2405 depicting a lesion in a magnetic resonance imaging (MM) scan of a brain of a human subject. The condition in this example may correspond to whether the brain has the tumor or does not have any tumor.

For each image 2405, the training dataset 2345 may identify or include at least one annotation 2415. The annotation 2415 may define, specify, or otherwise identify the SOI 2410 within the associated image 2405. The annotation 2415 may identify a location of the SOI 2410 within the image 2405. For example, the annotation 2415 may specify pixel coordinates (e.g., in the x, y axis or x, y, z axis) of the SOI 2410 depicted in the image 2405. In some embodiments, the annotation 2415 may identify the condition associated with the SOI 2410 in the associated image 2405. The annotation 2415 may have been manually generated or input by a user (e.g., a clinician) examining the image 2405 to facilitate the training of the localization model 2335.

To prepare for training the localization model 2335, the model trainer 2325 may use at least one noise generator 2420 to include, insert, or otherwise add random noise to the image 2405. Upon identification form the training dataset 2345, the noise generator 2420 may invoke the noise generator 2420 to generate the random noise. The random noise may change a value in a subset of pixels within the image 2405 from an original value. The noise generator 2420 may generate the random noise using any type of noise, such as Gaussian noise, salt-and-pepper noise, uniform noise, anisotropic noise, shot noise, quantization noise, interference noise, and phase noise, among others. Upon generation, the noise generator 2420 may add the random noise to the subset of pixels within the image 2405. In some embodiments, the model trainer 2325 may skip or omit the addition of the random noise to the image 2405.

In conjunction, the model applier 2330 executing on the image processing system 2305 may invoke or use at least one tile generator 2425 to define, identify, or otherwise generate a set of tiles 2430A-N (hereinafter generally referred to as tiles 2430) from the image 2405. Each tile 2430 may correspond to a subsection or a portion of the image 2405. In some embodiments, the set of tiles 2430 may be defined in the example for the image 2405 in the training dataset 2345. The generation of tiles 2430 by the tile generator 2425 may be in accordance with a grid pattern for the image 2430. In some embodiments, the tile generator 2425 may partition or divide the image 2430 into the set of tiles 2430 in accordance with the grid pattern. The set of tiles 2430 may overlap with one another in accordance with a set ratio. The ratio may range from 5% to 95% overlap between adjacent pairs or groups of tiles 2430. In some embodiments, the model applier 2330 may omit the generation of the tiles 2430 from the image 2605.

In addition, the model applier 2330 may invoke or use at least one agent handler 2435 to set or assign an initial state 2440 for the agent 2340 of the localization model 2335. The state 2440 may identify or indicate a position of the agent 2340 within the image 2405. In some embodiments, the agent handler 2435 may use the pixel coordinates of the entire image 2405 as an action space for the agent 2340. The agent space may correspond to a set of possible positions for the agent 2340. The initial position of the agent 2340 may correspond to at least one pixel coordinate with the image 2405. In some embodiments, the agent handler 2435 may select, determine, or identify the at least one pixel coordinate as the position for the initial state 2440 of the agent 2340. The identification of the pixel coordinate may be at random or a set pixel coordinate (e.g., top left or bottom right coordinate). With the identification, the agent handler 2435 may assign the initial state 2440 of the agent 2340 to the pixel coordinate.

In some embodiments, the agent handler 2435 may use the set of tiles 2430 to define an action space for the agent 2340. The action space may define to a set of possible positions correspond to tiles 2430 for the agent 2340. In some embodiments, the set of possible positions may correspond to a fraction of a tile 2430 (e.g., quarter or half of a dimension of each tile 2430). The initial position of the agent 2340 may correspond to at least one tile 2430 of the image 2405. From the set of tiles 2430, the agent handler 2345 may select or identify at least one tile 2430 as the position for the initial state 2440 of the agent 2340. The identification of the tile 2430 may be at random or at a set position (e.g., top left tile 2430 or bottom right tile 2430). With the identification, the agent handler 2435 may assign the initial state 2440 of the agent 2340 to the tile 2430.

The model applier 2330 may apply the image 2405 from the training dataset 2345 to the localization model 2335. The initial state 2440 may be added onto the image 2405 or separately from the image 2405 during the application to the localization model 2335. In some embodiments, the model applier 2330 may apply the initial state 2440 of the agent 2340 in addition with the image 2405 to the localization model 2335. In some embodiments, the model applier 2330 may add or insert a graphical indicator corresponding to the initial state 2440 into the image 2405 prior to application. The graphical indicator may be, for example, highlighted portion of the image 2405 corresponding to the tile 2430 for the state 2440.

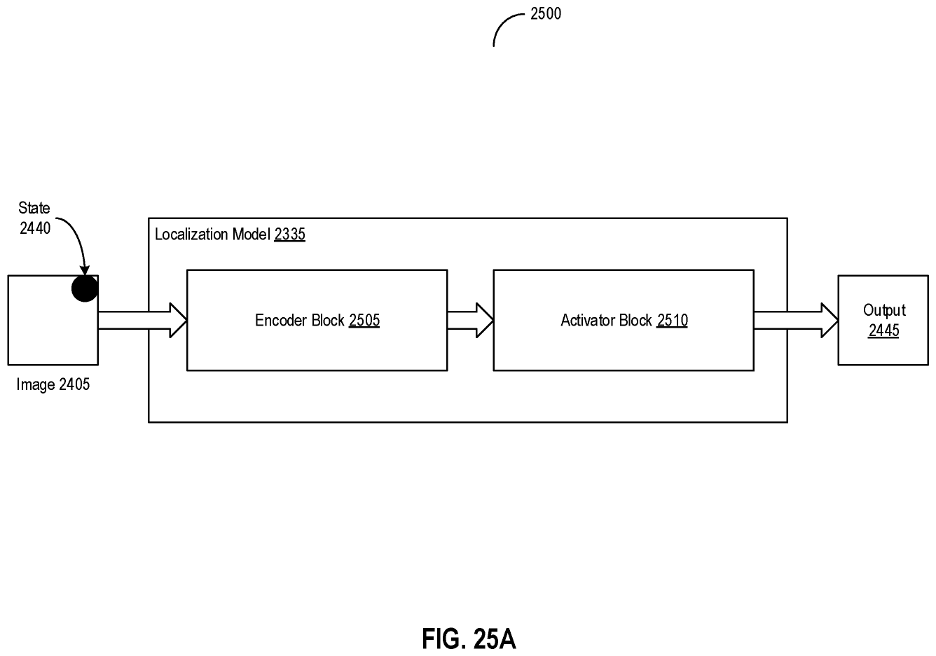

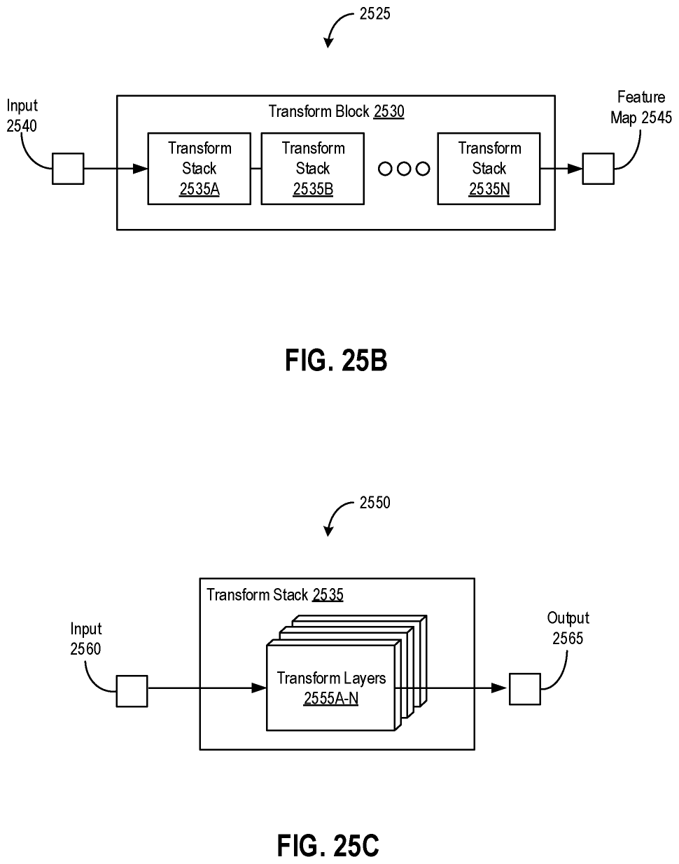

In applying, the model applier 2330 may input or feed the image 2405 along with the assigned state 2440 to the localization model 2335. The localization model 2335 may have a set of transform layers with kernel parameters (sometimes referred herein as parameters or weights) for managing the agent 2340. The set of transform layers in the localization model 2335 may be used to approximate a value function established using reinforcement learning, such as a Q-function. The architecture of the set of transform layers and the kernel parameters of the localization model 2335 may be in accordance with a convolutional neural network (CNN), a fully connected (FC) network, a transformer neural network, or any combination thereof, among others. The architecture of the set of transform layers and the kernel parameters of the localization model 2335 is detailed herein in conjunction with FIGS. 25A-C. In feeding, the model applier 2330 may process the input image 2405 along with the assigned state 2440 for the agent 2340 in accordance with the kernel parameters of the set of transform layers in the localization model 2335.

Moving now to FIG. 24B, from feeding and processing the image 2405 in accordance with the localization model 2335, the model applier 2330 may produce or generate at least one output 2445. The output 2445 may be used to determine the location of the at least one SOI 2410 within the image 2405. The output 2445 may include or identify the state 2440 of the agent 2340 corresponding to the position within the image 2405. In some embodiments, the output 2445 may identify the state 2440 corresponding to the tile 2430 of the set of tiles 2430 within the image 2405. The state 2440 in the output 2445 may correspond to the state 2440 assigned by the agent handler 2435, prior to the application to the localization model 2335 or the current state of the agent 2340. For example, the state 2440 identified in the output 2445 may correspond to the pixel coordinate in the image 2405 or one tile 2430 from the set.

In addition, the output 2445 produced by the localization model 2335 may include or identify a set of actions 2450A-N (hereinafter generally referred to as actions 2450) to be performed by the agent 2340 with respect to the position. Each action 2450 may correspond to, define, or identify the next state 2440′ to which to transition or move the agent 2340. The action 2450 may be to maintain the agent 2340 at the current position (e.g., current pixel or tile 2340) corresponding to the previous state 2440. The action 2450 may also be to move the agent 2340 to another position (e.g., different pixel or tile 2340) in the image 2405. When the action space is the pixel coordinates of the image 2405, the action 2450 may correspond to the next pixel coordinate within the image 2405 to which to transition the agent 2340. When the action space is the set of tiles 2430 form the image 2405, the action 2450 may correspond to the next tile 2430 within the set of tiles 2430 to which to move the agent 2340.

For each action 2450, the output 2445 generated by the localization model 2335 may include or identify at least one value 2455A-N (hereinafter generally referred to value 2445). Each value 2455 may correspond to or identify a degree to which the associated action 2445 conforms to or deviates from the optimal transition for the agent 2340 from the state 2440 to determine the location of the SOI 2410 in the image 2405. For example, the value 2455 may correspond to a Q value determined from the Q function approximated by the set of transform layers in the localization model 2335. In general, the value 2455 may be positive, if the associated action 2450 is to move the agent 2340 into the SOI 2410. Conversely, the value 2455 may be negative, if the associated action 2450 is to maintain or move the agent 2340 away from the SOI 2410 in the image 2405.

With the generation, the model trainer 2325 may select or identify at least one expected value from the value function 2460 against which to compare at least one value 2445 of the output 2445. The value function 2460 may include, identify, or define at least one reward value and at least one penalty value. The reward value may be used when the position or state 2440 to which to move the agent 2340 under the action 2450 corresponds to the location of the SOI 2410 as identified in the annotation 2415. The reward value may be, for example, a positive integer or numerical value. In contrast, the penalty value may be used when the position or state 2440 to which to move the agent 2340 under the action 2450 does not correspond to the location of the SOI 2410 as identified in the annotation 2415. The penalty value may be, for example, a negative integer or numerical value.

For at least one action 2450 in the identified in the output 2445, the model trainer 2325 may identify the subsequent position of the agent 2340 in the image 2450. In some embodiments, the model trainer 2325 may select the action 2450 corresponding to the maximum value 2455 for the identification. In some embodiments, the model trainer 2325 may identify the action 2450 from the set of actions 2450 in accordance with sampling protocol. For example, the model trainer 2325 may select the action 2450 at random or identify the action 2450 with the highest value 2455 in accordance with the epsilon-greedy algorithm. Upon the identification, the model trainer 2325 may compare the subsequent position for the agent 2340 with the location for the SOI 2410 identified by the annotation 2415. If the position of the agent 2340 corresponds to the location of the SOI 2410, the model trainer 2325 may select the reward value from the value function 2460. On the other hand, if the position of the agent 2340 does not correspond to the location of the SOI 2410, the model trainer 2325 may select the penalty value from the value function 2460. The selected value may correspond to the expected or target value (also referred herein as a target Q value) to be generated by the localization model 2335.

With the selection from the value function 2460, the model trainer 2325 may determine at least one loss metric (sometimes herein referred to as an error metric) for the output 2445 generated by the localization model 2335. The determination of the loss metric may be based on the expected value selected from the value function 2460 and the value 2455 of the output 2445, among other factors. The loss metric may indicate a degree of deviation of the output 2445 from the expected result, such as the determination of the location of the SOI 2410 as identified in the annotation 2415. In particular, the loss metric may correspond to the degree of deviation of the set of values 2455 in the output 2445 generated by the localization model 2335 from the behavior as indicated in the value function 2460. The loss metric may be calculated in accordance with any number of loss functions, such as a Huber loss, norm loss (e.g., L1 or L2), mean squared error (MSE), a quadratic loss, and a cross-entropy loss, among others. In general, the higher the loss metric, the more the output may have deviated from the expected result of the input. Conversely, the lower the loss metric, the lower the output may have deviated from the expected result.

Using the loss metric, the model trainer 2325 may modify, set, or otherwise update at least one kernel parameter in the set of transform layers of the localization model 2335. The updating of the set of transform layers in the localization model 2335 may be in accordance with an optimization function (e.g., the Bellman equation). The optimization function may define one or more rates or parameters at which the weights of the localization model 2335 are to be updated. The updating of the localization model 2335 may be to align the values 2455 in the outputs 2445 from the localization model 2335 to the expected value as identified in the value function 2460.

In some embodiments, the model trainer 2325 may store and maintain at least a portion of the output 2445 on at least one buffer 2465 (sometimes herein referred to as an experience replay buffer). The model trainer 2325 may generate at least one entry to store on the buffer 2465 using the output 2445. The entry may identify or include the state 2440 of the agent 2340, at least one action 2450, and at least one value 2455 selected from the current iteration. For example, the action 2450 included in the entry may correspond to the highest value 2455. In some embodiments, the entry may include the expected value for the action 2450 selected from the value function 2460. The entry may be used in subsequent iterations of the application of the localization model 2335 while training.

The model applier 2330 may determine whether to perform another iteration of the application of the image 2450 to the localization model 2335. In some embodiments, the mode applier 2330 may maintain a counter to keep track of a number of iterations. Upon production of the output 2445, the model applied 2330 may compare the number of iterations to a maximum number of iterations. The maximum number of iterations may be a fixed number (e.g., 100 epochs). In some embodiments, the model applier 2330 may determine or identify the maximum number of iterations based on a number of tiles 2430 defining the action space for the agent 2340. For example, the maximum number of iterations may be a multiple (e.g., 5 or 10 times) of the number of tiles 2430.

If the number of iterations performed is greater than or equal to the maximum number, the model applier 2330 may cease the application of the image 2405 to the localization model 2335. The model trainer 2325 may retrieve or identify the subsequent example in the training dataset 2345, from which to identify the next image 2405 to apply. The model applier 2330 and the model trainer 2325 may repeat the functionalities described above with the next example of the training dataset 2345. Conversely, if the number of iterations performed is less than the maximum number, the model applier 2330 may perform another iteration of the application of the image 2405 to the localization model 2335.

For a subsequent iteration of the application, the agent handler 2435 of the model applier 2330 may identify or select the next state 2440′ to which to transition the agent 2340 based on the set of actions 2450 and the set of values 2455. In some embodiments, the agent handler 2435 may select the state 2440′ for the agent 2340 corresponding to the action 2450 with the maximum value 2445. In some embodiments, the agent handler 2435 may select the next state 2440′ corresponding to the action 2450 with the maximum expected value as identified by the value function 2465. The next state 2440′ may identify or indicate a subsequent position (e.g., next pixel coordinate or tile 2430) of the agent 2340 within the image 2405. The subsequent position may correspond to the next prediction by the agent 2340 as to the location of the SOI 2410 in the image 2405. When the action space for the agent 2340 includes the pixel coordinates, the next state 2440′ may correspond to at least one pixel coordinate. When the action space for the agent 2340 includes the set of tiles 2430, the next state 2440′ may correspond to at least one tile 2430.

In some embodiments, the model trainer 2325 may use a different state to use as the next state 2440′ instead of the state 2440′ selected by the agent handler 2435 of the model applier 2330 for the subsequent iteration. After multiple iterations, the buffer 2465 may identify or include multiple entries. As discussed above, each entry may include a state 2440 of the agent 2340, at least one action 2450, and at least one value 2455 from one of the previous iterations. The model trainer 2325 may access the buffer 2465 to identify, sample, or select at least one entry. The selection of the entry may be at random or in accordance with a set rate (e.g., selection from two or three previous iterations). Upon selection, the model trainer 2325 may parse the entry to identify the state 2440 and the action 2450, among other information. Once selected, the model trainer 2325 may use the state 2440 and the action 2450 from the sampled entry of the buffer 2465 for the next iteration. The state 2440 and the action 2450 for the agent sampled from the buffer 2465 may be used, rather than the state 2440′ selected by the agent handler 2435.

Upon identification of the next state 2440′, the model trainer 2325 and the model applier 2330 may repeat many of the functionalities described above in processing the image 2405. For example, the model trainer 2325 may generate random noise to add to the image 2405 prior to application. The random noise added to the model trainer 2325 may be different from previous iteration. In turn, the model applier 2330 may apply the image 2405 along with the state 2440′. In feeding, the model applier 2330 may feed the image 2405 along with the state 2440′ to the localization model 2335. The model applier 2330 may process the image 2405 with the next state 2440′ in accordance with the kernel parameters of the set of transform layers in the localization model 2335. Again, from processing the image 2405, the model applier 2330 may produce or generate another output 2445. The output 2445 may identify the state 2440′ of the agent 2340, a set of actions 2450 to be performed by the agent 2340, and a set of corresponding values 2455.

The model trainer 2325 may in turn update at least one kernel parameter in the set of transform layers of the localization model 2335 using the output 2445 generated for the next state 2440′ and the value function 2460. The updating of the kernel parameters in the localization model 2325 may be repeated until a convergence condition. The convergence condition may be when the value function approximated by the localization model 2335 is within a threshold of the target value function corresponding to the value function 2460. In some embodiments, the model trainer 2325 may store and maintain the kernel parameters in the set of transform layers of the localization model 2335.

Referring now to FIG. 25A, depicted is a block diagram of an architecture 2500 of the localization model 2335 of the system 2300 for localizing images. Under the architecture 2500, the localization model 2335 may include at least one encoder block 2505 and at least one activator block 2510, among others. The kernel parameters and the set of transform layers of the localization model 2335 may be configured, arrayed, or otherwise arranged across the encoder block 2505 and the activator block 2510. The encoder block 2505 and the activator block 2510 may be connected with one another in configuration, such as in series (e.g., as depicted) or in parallel, or any combination thereof.

The localization model 2335 may have at least one input and at least one output. The input and the output may be related to one another via the set of transform layers across the encoder block 2505 and the activator block 2510. The input may include the image 2405 and the state 2440, and may correspond to an input of the encoder block 2505. The output of the encoder block 2505 may include a feature map generated from the image 2405 using the set of transform layers in accordance with the associated set of transform layers, and may be fed forward as the input to the activator block 2510. The output of the activator block 2510 may be a feature map corresponding to the output 2445 as discussed above, and may serve as the output of the overall localization model 2335.

Referring now to FIG. 25B, depicted is a block diagram of an architecture 2525 of a transform block 2530 in the localization model 2335 of the system 2300 for localizing images. The transform block 2530 may be used to implement the encoder block 2505 and the activator block 2510 in the localization model 2335. For example, the encoder block 2505 and the activator block 2510 may each be an instance of the block 2530. Under the architecture 2525, the block 2530 may include one or more transform blocks 2535A-N (hereinafter generally referred to as a transform block 2535). The set of transform stack 2325 can be arranged in series (e.g., as depicted) or parallel configuration, or in any combination. In a series configuration, the input of one transform stack 2325 may include the output of the previous transform stack 2325 (e.g., as depicted). In parallel configuration, the input of one transform stack 2325 may include the input of the entire block 2530.

The block 2530 may include at least one input 2540 and at least one output feature map 2545. The kernel parameters arranged across the transform stacks 2535 may define the relationship between the input 2540 and the output 2545. When used to implement the encoder block 2505, the input 2540 may correspond to the image 2405 and the state 2440, and the output may be the feature map 2545. When used to implement the activator block 2510, the input 2540 may include the feature map generated by the encoder block 2505, and the output may be the output 2445 for the overall localization model 2335.

Referring now to FIG. 25C, depicted is a block diagram of an architecture 2550 of a set of transform layers 2530 in a transform block 2550 in the localization model 2335 of the system 2300 for localizing images. The transform stack 2325 may be used to implement the encoder block 2505 and the activator block 2510. The transform stack 2535 may include a set of transform layers 2555A-N (hereinafter generally referred to as transform layers 2555). The transform stack 2535 may include at least one input 2560 and at least output 2565. The input 2560 and the output 2565 may be related to each other via the set of kernel parameters defined across the transform layers 2555. The set of transform layers 2565 can be arranged in any configuration such as in series or in parallel, or any combination thereof. For example, under series configuration, the transform layers 2565 may have an output of one transform layer 2565 fed as an input to a succeeding transform layer 2565.

Each transform layer 2565 may have a non-linear input-to-output characteristic. The transform layer 2565 may comprise a convolutional layer, a normalization layer, and an activation layer (e.g., a rectified linear unit (ReLU)), among others. When used to implement the encoder block 2505, the transform layers 2555 of the transform stack 2535 may be configured or arranged as a convolutional neural network (CNN) or a transformer neural network. For example, the convolutional layer, the normalization layer, and the activation layer (e.g., a softmax function or rectified linear unit (ReLU)) in the transform layers 2555 may be arranged in accordance with CNN. When used to implement the activator block 2510, the transform layers 2555 may be configured or arranged as a fully-connected layer (FCL) or a transformer neural network. For example, the transform layers 2555 may include the activation layers (e.g., a softmax function or rectified linear unit (ReLU)).

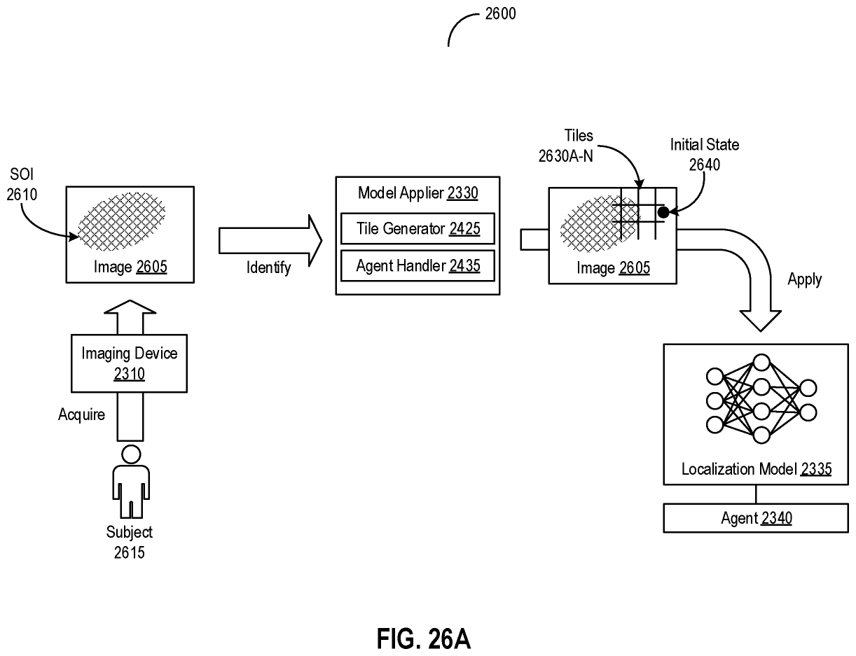

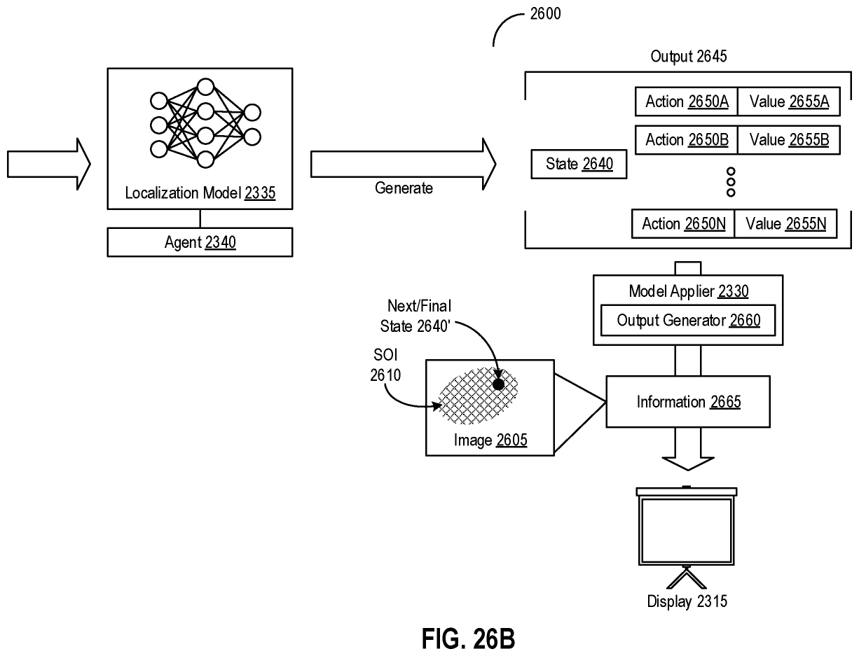

Referring now to FIGS. 26A and 26B, depicted are block diagrams of a process 2600 for using models in the system 2300 for localizing images. The process 2600 may include operations performed by the image processing system 2305 under the runtime or evaluation mode. The operations of process 2600 may include at least some of the operations in process 2400 to train the localization model 2335. Starting with FIG. 26A, the imaging device 2310 may produce, output, or otherwise generate at least one image 2605. The image 2605 may be similar to the image 2405 as discussed above, but may be acquired during the runtime mode. The image 2605 may include at least one structure of interest (SOI) 2610 (also referred herein as a region of interest (ROI)). The SOI 2610 may correspond to an area, section, or part of the image 2605 that corresponds to feature in the sample (or object) from which the image 2605 is acquired. In some embodiments, the SOI 2610 may correspond to a condition (e.g., a presence or lack thereof) of the feature in the sample. For example, the SOI 2610 may correspond to a part of the image 2605 depicting a lesion in a magnetic resonance imaging (MM) scan of a brain of a human subject. The condition in this example may correspond to whether the brain has the tumor or does not have any tumor.

The image 2605 may be derived or acquired from at least one subject 2615. The subject 2615 may include any object used to derive the image 2605. For example, the subject 2615 may include a human, an animal, a plant, or a cellular organism, among others. The image 2605 may be acquired, derived, or otherwise be of a sample (or object). The image 2605 may be a two-dimensional section of the sample or a three-dimensional volume of the sample (e.g., human subject). For example, the image 2605 may include a set of two-dimensional cross-sections (e.g., a front, a sagittal, a transverse, or an oblique plane) acquired from the three-dimensional volume. The image 2605 may be defined in terms of pixels, in two-dimensions or three-dimensions. In some embodiments, the image 2605 may be part of a video acquired of the sample over time. For example, the image 2605 may correspond to a single frame of the video acquired of the sample over time at a frame rate.

In generating the image 2605, the imaging device 2310 may acquire from at least one subject 2615 in accordance with any number of imaging modalities or techniques. For example, the imaging device 2310 may use a tomographic imaging technique, such as magnetic resonance imaging (MM), nuclear magnetic resonance (NMR) imaging, X-ray computed tomography (CT), ultrasound imaging, positron emission tomography (PET) imaging, and photoacoustic spectroscopy, among others. The image 2605 generated by the imaging device 2310 may be a tomogram, such as an MM image, a NMR image, CT image, ultrasound image, X-ray image, and PET image, among others. Upon acquisition and generation, the imaging device 2310 may send, transmit, or otherwise provide the image 2605 to the imaging processing system 2305. While discussed primarily in terms of tomograms and tomographs, the imaging device 2310 may support other imaging modalities besides the ones listed above, such as optical photography or microscopy, among others.

The model applier 2330 may receive, retrieve, or otherwise identify the image 2605. In some embodiments, the model applier 2330 may identify the image 2605 of the subject 2615 acquired via the imaging device 2310. Upon identification, the model applier 2330 may invoke or use the tile generator 2425 to define, identify, or otherwise generate a set of tiles 2630A-N (hereinafter generally referred to as tiles 2630) from the image 2610. Each tile 2630 may correspond to a subsection or a portion of the image 2605. The generation of tiles 2630 by the tile generator 2425 may be in accordance with a grid pattern for the image 2630. In some embodiments, the tile generator 2425 may partition or divide the image 2630 into the set of tiles 2630 in accordance with the grid pattern. The set of tiles 2630 may overlap with one another in accordance with a set ratio. The ratio may range from 5% to 95% overlap between adjacent pairs or groups of tiles 2630. In some embodiments, the model applier 2330 may omit the generation of the tiles 2630 from the image 2605.

In addition, the model applier 2330 may invoke or use the agent handler 2435 to set or assign an initial state 2640 for the agent 2340 of the localization model 2335. The state 2640 may identify or indicate a position of the agent 2340 within the image 2605. In some embodiments, the agent handler 2435 may use the pixel coordinates of the entire image 2605 as an action space for the agent 2340. The agent space may correspond to a set of possible positions for the agent 2340. The initial position of the agent 2340 may correspond to at least one pixel coordinate with the image 2605. In some embodiments, the agent handler 2435 may select, determine, or identify the at least one pixel coordinate as the position for the initial state 2640 of the agent 2340. The identification of the pixel coordinate may be at random or a set pixel coordinate (e.g., top left or bottom right coordinate). With the identification, the agent handler 2435 may assign the initial state 2640 of the agent 2340 to the pixel coordinate.

In some embodiments, the agent handler 2435 may use the set of tiles 2630 to define an action space for the agent 2340. The action space may define to a set of possible positions correspond to tiles 2630 for the agent 2340. In some embodiments, the set of possible positions may correspond to a fraction of a tile 2630 (e.g., quarter or half of a dimension of each tile 2630) or multiples of tiles 2630 (e.g., 5 to 20 tiles over from current tile). The initial position of the agent 2340 may correspond to at least one tile 2630 of the image 2405. From the set of tiles 2630, the agent handler 2345 may select or identify at least one tile 2630 as the position for the initial state 2460 of the agent 2340. The identification of the tile 2630 may be at random or at a set position (e.g., top left tile 2630 or bottom right tile 2630). With the identification, the agent handler 2435 may assign the initial state 2460 of the agent 2340 to the tile 2630.

The model applier 2330 may apply the image 2605 from the training dataset 2345 to the localization model 2335. The initial state 2640 may be added onto the image 2605 or separately from the image 2605 during the application to the localization model 2335. In some embodiments, the model applier 2330 may apply the initial state 2640 of the agent 2340 in addition with the image 2605 to the localization model 2335. In some embodiments, the model applier 2330 may add or insert a graphical indicator corresponding to the initial state 2640 into the image 2605 prior to application. The graphical indicator may be, for example, highlighted portion of the image 2605 corresponding to the tile 2630 for the state 2640. In applying, the model applier 2330 may input or feed the image 2605 along with the assigned state 2640 to the localization model 2335. The model applier 2330 may process the input image 2605 along with the assigned state 2640 for the agent 2340 in accordance with the kernel parameters of the set of transform layers in the localization model 2335.

Moving onto FIG. 26B, from feeding and processing the image 2605 in accordance with the localization model 2335, the model applier 2330 may produce or generate at least one output 2645. The output 2645 may be used to determine the location of the at least one SOI 2610 within the image 2605. The output 2645 may include or identify the state 2640 of the agent 2340 corresponding to the position within the image 2605. In some embodiments, the output 2645 may identify the state 2640 corresponding to the tile 2630 of the set of tiles 2630 within the image 2605. The state 2640 in the output 2645 may correspond to the state 2640 assigned by the agent handler 2435, prior to the application to the localization model 2335 or the current state of the agent 2340. For example, the state 2640 identified in the output 2645 may correspond to the pixel coordinate in the image 2605 or one tile 2630 from the set.

In addition, the output 2645 produced by the localization model 2335 may include or identify a set of actions 2650A-N (hereinafter generally referred to as actions 2650) to be performed by the agent 2340 with respect to the position. Each action 2650 may correspond to, define, or identify the next state 2640′ to which to transition or move the agent 2340. The action 2650 may be to maintain the agent 2340 at the current position (e.g., current pixel or tile 2340) corresponding to the previous state 2640. The action 2650 may also be to move the agent 2340 to another position (e.g., different pixel or tile 2340) in the image 2605. When the action space is the pixel coordinates of the image 2605, the action 2650 may correspond to the next pixel coordinate within the image 2605 to which to transition the agent 2340. When the action space is the set of tiles 2630 form the image 2605, the action 2650 may correspond to the next tile 2630 within the set of tiles 2630 to which to move the agent 2340.

For each action 2650, the output 2645 generated by the localization model 2335 may include or identify at least one value 2655A-N (hereinafter generally referred to value 2645). Each value 2655 may correspond to or identify a degree to which the associated action 2645 conforms to or deviates from the optimal transition for the agent 2340 from the state 2640 to determine the location of the SOI 2610 in the image 2605. For example, the value 2655 may correspond to a Q value determined from the Q function approximated by the set of transform layers in the localization model 2335. In general, the value 2655 may be positive, if the associated action 2650 is to move the agent 2340 into the SOI 2610. Conversely, the value 2655 may be negative, if the associated action 2650 is to maintain or move the agent 2340 away from the SOI 2610 in the image 2605.

With the generation of the output 2645, the model applier 2330 may determine whether to perform another iteration of the application of the image 2650 to the localization model 2335. In some embodiments, the mode applier 2330 may maintain a counter to keep track of a number of iterations. Upon production of the output 2645, the model applied 2330 may compare the number of iterations to a maximum number of iterations. The maximum number of iterations may be a fixed number (e.g., 100 epochs). In some embodiments, the model applier 2330 may determine or identify the maximum number of iterations based on a number of tiles 2630 defining the action space for the agent 2340. For example, the maximum number of iterations may be a multiple (e.g., 5 or 10 times) of the number of tiles 2630.

If the number of iterations performed is less than the maximum number, the model applier 2330 may perform another iteration of the application of the image 2405 to the localization model 2335. For the next iteration, the agent handler 2635 of the model applier 2330 may identify or select the next state 2640′ to which to transition the agent 2340 based on the set of actions 2650 and the set of values 2645. In some embodiments, the agent handler 2635 may select the state 2640′ for the agent 2340 corresponding to the action 2650 with the maximum value 2645. The next state 2640′ may identify or indicate a subsequent position (e.g., next pixel coordinate or tile 2630) of the agent 2340 within the image 2605. The subsequent position may correspond to the next prediction by the agent 2340 as to the location of the SOI 2610 in the image 2605. When the action space for the agent 2340 includes the pixel coordinates, the next state 2640′ may correspond to at least one pixel coordinate. When the action space for the agent 2340 includes the set of tiles 2630, the next state 2640′ may correspond to at least one tile 2630.

Upon identification of the next state 2640′, the model applier 2330 may repeat many of the functionalities described above in processing the image 2605. For example, the model applier 2330 may apply the image 2605 along with the state 2640′. In feeding, the model applier 2330 may feed the image 2605 along with the state 2640′ to the localization model 2335. The model applier 2330 may process the image 2605 with the next state 2640′ in accordance with the kernel parameters of the set of transform layers in the localization model 2335. Again, from processing the image 2605, the model applier 2330 may produce or generate another output 2645. The output 2645 may identify the state 2640′ of the agent 2340, a set of actions 2650 to be performed by the agent 2340, and a set of corresponding values 2655. The model applier 2330 may determine whether to perform another iteration again.

Conversely, if the number of iterations performed is greater than or equal to the maximum number, the model applier 2330 may cease the application of the image 2405 to the localization model 2335. In addition, the model applier 2330 may identify or determine the location corresponding to the SOI 2610 within the image 2605 based on the output 2645. To determine, the model applier 2330 may identify or select a final state 2640′ to which to transition the agent 2340 based on the set of actions 2650 and the set of values 2655. In some embodiments, the agent handler 2635 may select the final state 2640′ for the agent 2340 corresponding to the action 2650 with the maximum value 2645. By the time that the model applier 2330 terminates iterations, the agent 2340 of the localization model 2335 may have been continuously positioned on the SOI 2610 in the image 2605. As such, the final state 2640′ may identify the position of the agent 2340 as in the SOI 2610 of the image 2605. From the final state 2640′ for the agent 2340, the model applier 2330 may determine the location of the SOI 2610 within the image 2605.

Using the determined location of the SOI 2610, the model applier 2330 may invoke or use at least one output generator 2660 to generate information 2665. The information 2665 may identify or include the location of the SOI 2610 within the image 2605. The location may be identified in terms of pixel coordinates within the image 2605 or the set of tiles 2630 defined from the image 2605. In some embodiments, the information 2665 may include the original image 2605 itself and the location of the SOI 2610. In some embodiments, the information 2665 may include the image 2605 with the graphical indicator corresponding to the final state 2640′ of the agent 2340 within the image 2605 to identify the location of the SOI 2610. In some embodiments, the output generator 2660 may use a template to generate the information 2665 for output. For example, the template may be a radiology report with empty fields, and the output generator 2660 may populate the empty fields with the location of the SOI 2610 to use as the information 2665 for output.

Upon generation, the output generator 2660 of the model applier 2330 may provide the information 2665. In some embodiments, the model applier 2330 may send, transmit, or otherwise provide the information 2665 for presentation via the display 2315. The display 2315 may render, display, or present the information 2665, such as the image 2605 and the location of the SOI 2610 within the image 2605. For example, the output generator 2660 may provide the information 2665 to present via a graphical user interface on the display 2315 to display the image 2605 and the location of the SOI 2610 within the image 2605. In some embodiments, the model applier 2330 may store and maintain the information 2665 on a database accessible from the image processing system 2305.

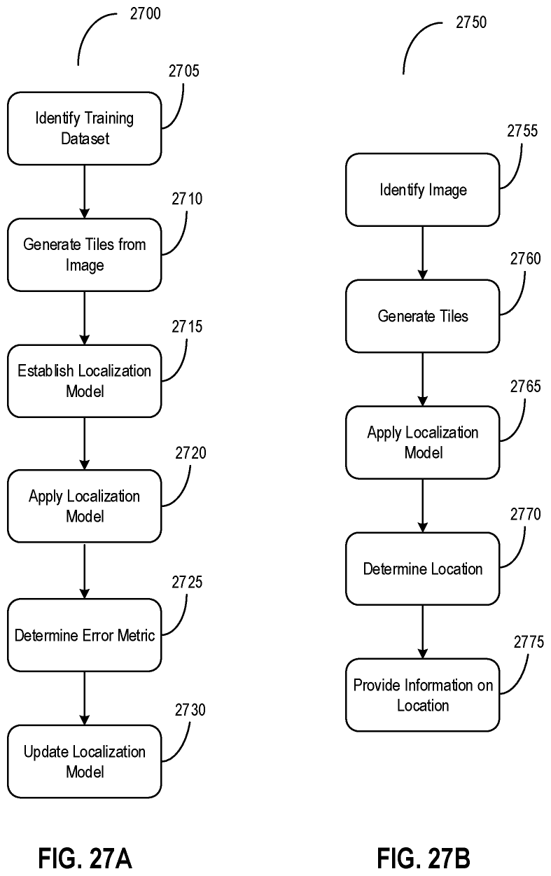

Referring now to FIG. 27A, depicted is a flow diagram of a method 2700 of training models to localize images. The method 2700 may be performed by or implementing using the system 2300 described herein in conjunction with FIGS. 23-26B or the system 3800 as described herein in conjunction with Section H. Under method 2700, a computing system may identify a training dataset including an image and an annotation (2705). The computing system may generate a set of tiles from the image (2710). The computing system may establish a localization model using the training dataset (2715). The computing system may apply the localization model to the image (2720). The computing system may determine an error metric using an output of the localization model (2725). The computing system may update the localization model using the error metric (2730).

Referring now to FIG. 27B, depicted is a flow diagram of a method 2750 of localizing images. The method 2700 may be performed by or implementing using the system 2300 described herein in conjunction with FIGS. 23-26B or the system 3800 as described herein in conjunction with Section H. Under method 2750, a computing system may identify an image (2755). The computing system may generate a set of tiles from the image (2760). The computing system may apply a localization model to the image (2765). The computing system may determine a location of a structure of interest in the image (2770). The computing system may provide information on the location (2775).

### F. Systems and Methods for Models Established Using Reinforcement Learning to Perform Segmentation of Biomedical Images

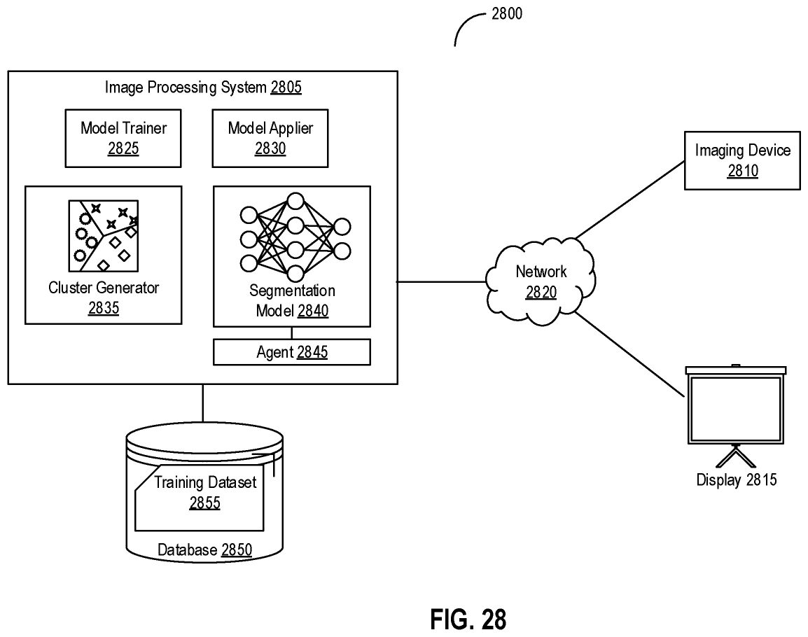

Referring now to FIG. 28, depicted is a block diagram of a system 2800 for segmenting images. In overview, the system 2800 may include at least one image processing system 2805, at least one imaging device 2810, and at least one display 2815, communicatively coupled via at least one network 2820. The image processing system 2805 may include at least one model trainer 2825, at least one model applier 2830, at least one cluster generator 2835, at least one segmentation model 2840 for managing at least one agent 2845, and at least one database 2850, among others. The database 2850 may store, maintain, or otherwise include at least one training dataset 2855. Each of the components in the system 2800 as detailed herein may be implemented using hardware (e.g., one or more processors coupled with memory) or a combination of hardware and software as detailed herein in Section H. Each of the components in the system 2800 may implement or execute the functionalities detailed herein, such as those described in Sections A-D.

In further detail, the image processing system 2805 itself and the components therein, such as the model trainer 2825, the model applier 2830, the cluster generator 2835 and the segmentation model 2840 may have a training mode and a runtime mode (sometimes herein referred to as an evaluation or inference mode). Under the training mode, the image processing system 2805 may invoke the model trainer 2825 to train the cluster generator 2835 and the segmentation model 2840 using the training dataset 2850. Under the runtime, the segmentation model 2840 may invoke the model applier 2830 to apply the cluster generator 2835 and segmentation model 2840 to acquired images from the imaging device 2810.

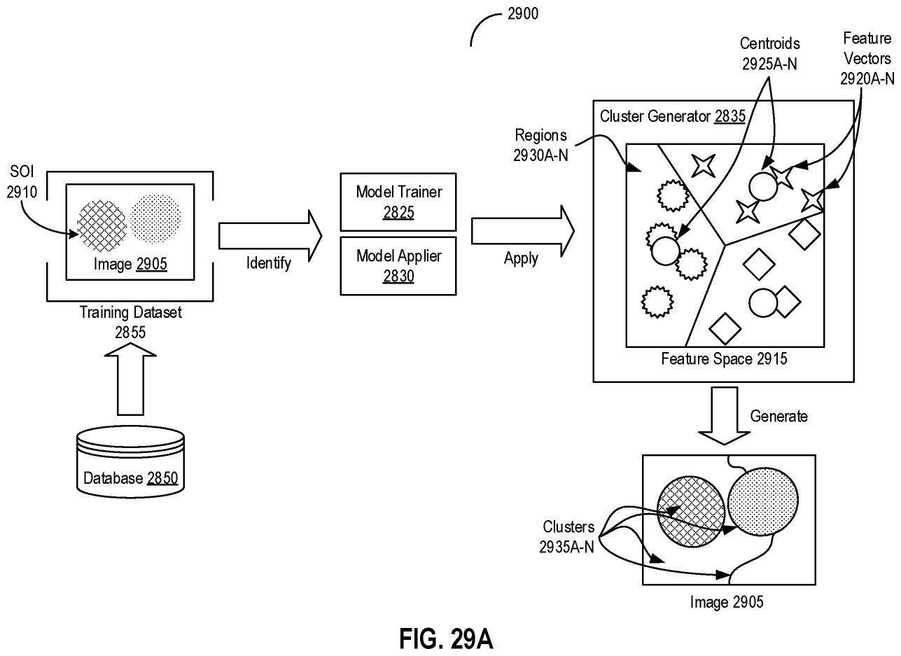

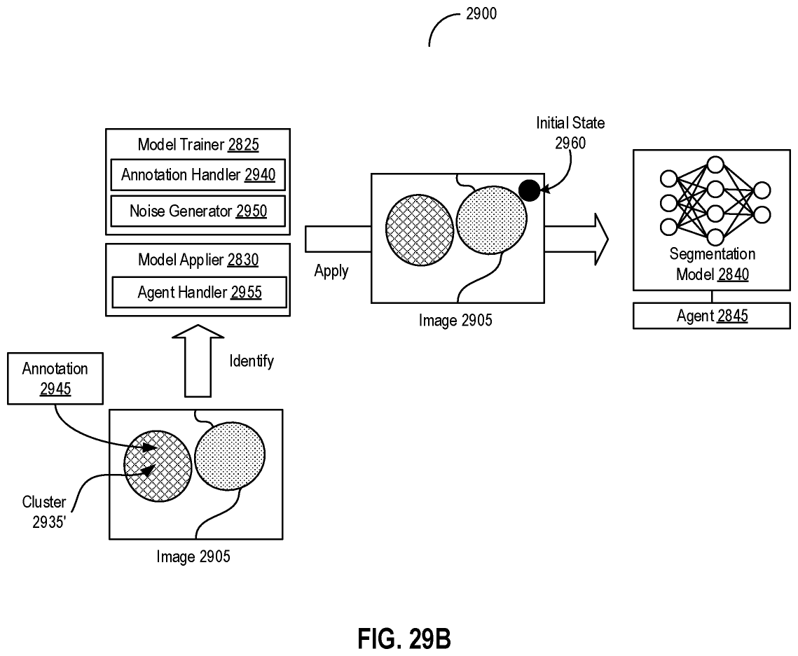

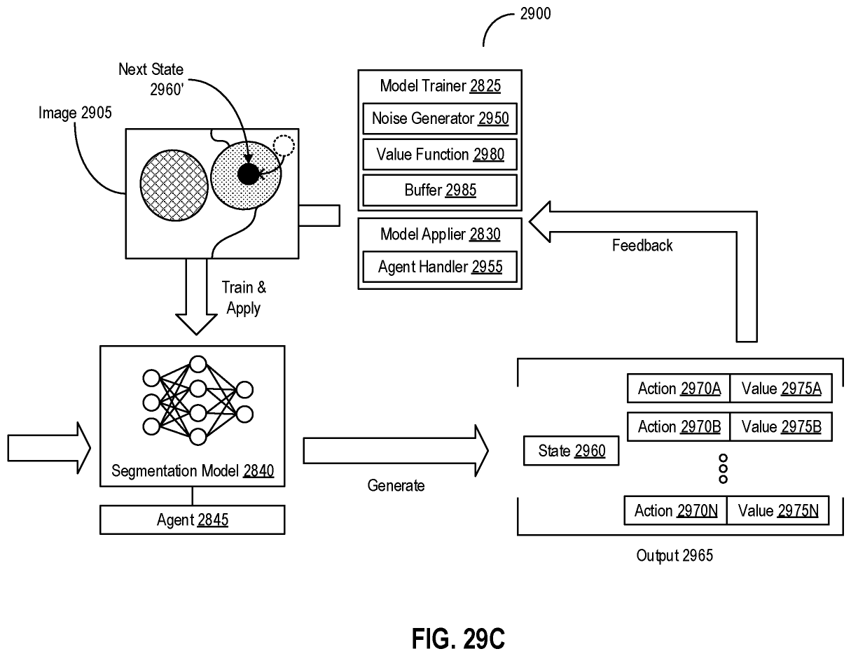

Referring now to FIGS. 29A-C, depicted are block diagrams of a process 2900 for training models in the system 2800 for segmenting images. The process 2900 may include operations performed by the image processing system 2805 under the training mode. Starting with FIG. 29A, the model trainer 2825 executing on the image processing system 2805 may access the database 2840 to fetch, retrieve, or identify the training dataset 2845. The identification of the training dataset 2855 by the model trainer 2825 may be in preparation for training and establishing the segmentation model 2840.

The training dataset 2855 may identify or include one or more examples. Each example may include at least one image 2905 (sometimes herein referred to as a sample image or example image). The image 2905 may be acquired, derived, or otherwise be of a sample (or object). The image 2905 may be a two-dimensional section of the sample or a three-dimensional volume of the sample (e.g., human subject). For example, the image 2905 may include a set of two-dimensional cross-sections (e.g., a front, a sagittal, a transverse, or an oblique plane) acquired from the three-dimensional volume. The image 2905 may be defined in terms of pixels, in two-dimensions or three-dimensions. In some embodiments, the image 2905 may be part of a video acquired of the sample over time. For example, the image 2905 may correspond to a single frame of the video acquired of the sample over time at a frame rate.

The image 2905 may be acquired using any number of imaging modalities or techniques. For example, the image 2905 may be a tomogram acquired in accordance with a tomographic imaging technique, such as a magnetic resonance imaging (MRI) scanner, a nuclear magnetic resonance (NMR) scanner, X-ray computed tomography (CT) scanner, an ultrasound imaging scanner, and a positron emission tomography (PET) scanner, and a photoacoustic spectroscopy scanner, among others. The image 2905 may be a single instance of acquisition (e.g., X-ray) in accordance with the imaging modality, or may be part of a video (e.g., cardiac MM) acquired using the imaging modality. Although the present disclosure discusses the image 2905 primarily in terms of a tomogram, other imaging modalities besides those listed above may be supported by the image processing system 2805.

The image 2905 may include at least one at least one structure of interest (SOI) 2910 (also referred herein as a region of interest (ROI)). The SOI 2910 may correspond to an area, section, or part of the image 2905 that corresponds to feature in the sample (or object) from which the image 2905 is acquired. In some embodiments, the SOI 2910 may correspond to a condition (e.g., a presence or lack thereof) of the feature in the sample. For example, the SOI 2910 may correspond to a part of the image 2905 depicting a lesion in a magnetic resonance imaging (MM) scan of a brain of a human subject. The condition in this example may correspond to whether the brain has the tumor or does not have any tumor.

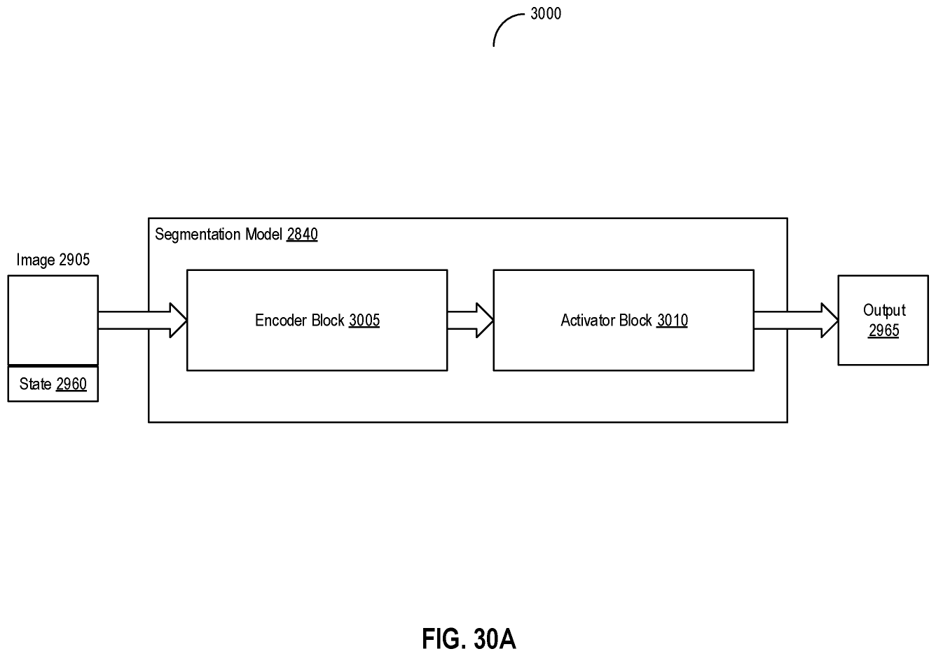

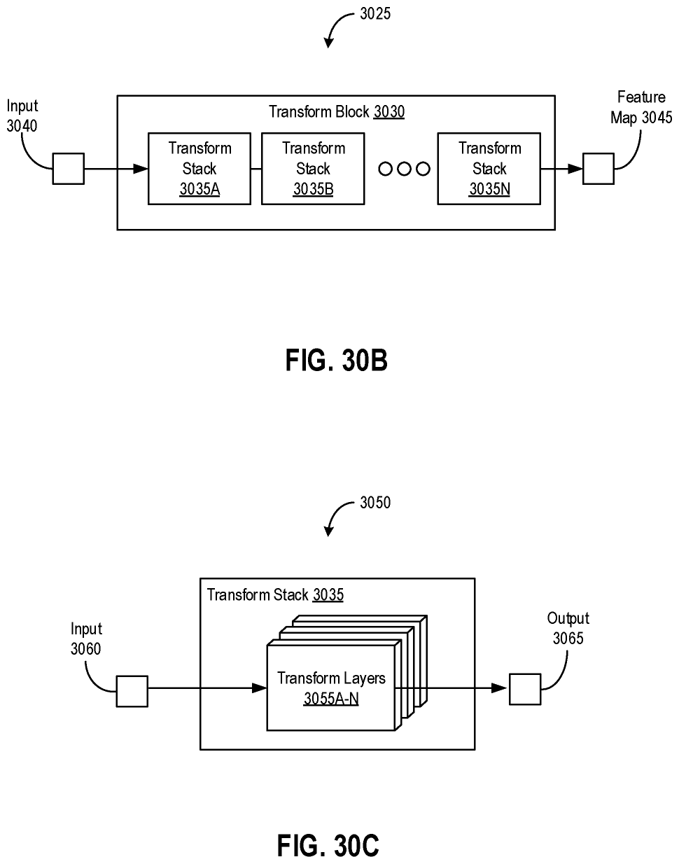

In conjunction, the model trainer 2825 may also initialize, train, or otherwise establish the cluster generator 2835, prior to application of the image 2905. The cluster generator 2835 may be any algorithm or model used to perform clustering analysis on the image 2905 or feature maps derived from the image 2905. The clustering analysis may include, for example, hierarchical clustering (e.g., linkage clustering), centroid-based clustering (e.g., k-means), distribution-based clustering (e.g., Gaussian mixture models), and density-based clustering (e.g., density-based spatial clustering or DBSCAN), among others. In some embodiments, the cluster generator 2835 may include a set of transform layers with kernel parameters (sometimes referred herein as parameters or weights). The architecture of the set of transform layers and the kernel parameters of the cluster generator 2835 may be in accordance with a convolutional neural network (CNN), a fully connected (FC) network, a transformer neural network, or any combination thereof, among others. The architecture of the set of transform layers and the kernel parameters of the cluster generator 2835 is detailed herein in conjunction with FIGS. 30A-C. In some embodiments, the cluster generator 2835 may have been already trained and established.

The cluster generator 2835 may include or define at least one feature space 2915. The feature space 2915 may be an n-dimensional space in which each feature vector 2920A-N (hereinafter generally referred to feature vector 2920) can be defined, referenced, or mapped. Each feature vector 2920 may correspond to a segment, portion, or sub-section of the image 2905. The feature space 2915 may define or otherwise include a set of centroids 2925A-N (hereinafter generally referred to as centroids 2925). Each centroid 2925 may correspond to a point in the n-dimensional feature space 2915. Upon initialization during the training process, the set of centroids 2925 in the cluster generator 2835 may be assigned a set value (e.g., a random value).

The set of centroids 2925 may be used to delineate, demarcate, or otherwise define a corresponding set of regions 2930A-N (hereinafter generally referred to as regions 2930) within the feature space 2915. The number of centroids 2925 and the number of regions 2930 may be pre-set or pre-assigned to a value (e.g., a fixed value). Each region 2930 may correspond to a common latent feature shared among the feature vectors 2920 within the feature space 2915 in the region 2930, and at least one of the regions 2930 may correspond to the SOI 2910 in the image 2905. Each region 2930 may correspond to a portion of the feature space 2915. In some embodiments, each region 2930 may correspond to the portion of the feature space 2915 based on a distance about the associated centroid 825 in the feature space 2915. The distance may be, for example, proximity in terms of Euclidean distance or L-norm distance, among others, to the centroid 825 defining the respective region 2930.

The model trainer 2825 may use training data to train or establish the cluster generator 2835. The training data may be separate from the training dataset 2855, may include images (e.g., similar to the image 2905), and may be stored and maintained on the database 2855. The training of the cluster generator 2835 may be in accordance with the used clustering algorithm. For example, upon initialization, the model trainer 2825 may assign the set of centroids 2925 in the cluster generator 2835 may be assigned a set point (e.g., a random value) within the feature space 2915. The model trainer 2825 may feedback the images of the training data to generate features 2920 to include into the feature space 2915. For each region 2930, the model trainer 2825 may identify the set of features 2920 within the region 2930. Using the identified set of features 2920, the model trainer 2825 may determine a new centroid 2925 for the region 2930. The model trainer 2825 may repeat this process of determine the new set of centroids 2925 until a convergence condition for the clustering algorithm implemented by the cluster generator 2835. Once trained, the cluster generator 2835 may be used by the model applier 2830 to apply and process the image 2905.

With the identification, the model applier 2830 executing on the image processing system 2850 may apply the image 2905 to the cluster generator 2835. In applying, the model applier 2830 may feed and process the image 2905 in accordance with the kernel parameters in the set of transform layers of the cluster generator 2835. In some embodiments, the model applier 2830 may generate a set of tiles from the image 2905, and may feed the tiles into the cluster generator 2835. From feeding the image 2905, the model applier 2830 may generate the set of feature vectors 2920. Each feature vector 2920 may correspond to a segment or portion of the image 2905, and may correspond to a point within the feature space 2915. For each feature vector 2920, the model applier 2830 may determine or identify the corresponding region 2930 to which to assign the feature vector 2920. To identify, the model applier 2830 may calculate or determine a distance between the point corresponding to the feature vector 2920 and each centroid 2925 within the feature space 2915. The distance may be determined in accordance with Euclidean distance or L-norm distance, among others.

Based on the distances to the centroids 2925 within the feature space 815, the model applier 2830 may assign the feature vector 2920 to one of the regions 2930. For example, the model applier 2830 may assign the feature vector 2920 to the region 2930 associated with the most proximate centroid 2925 within the feature space 815. In some embodiments, the model applier 2830 may identify the region 2930 to which to assign the feature vector 2920 based on the values along the dimensions of the feature vector 2920. The model applier 2830 may compare the values along the dimensions of the feature vector 2920 with the values of the feature space 815 associated with the set of regions 2930. Based on the comparison, the model applier 2830 may assign the feature vector 2920 to the region 2930 in which the values along the dimensions reside.

Using the assignments of the feature vectors 2920 to the respective regions 2930, the model applier 2830 may identify, determine, or otherwise generate a set of clusters 2935A-N (hereinafter generally referred to as clusters 2935) from the image 2905. Each cluster 2935 may correspond to a region or an area in the image 2905 having a common visual characteristic. For example, in the depicted example, the first cluster 2935A may correspond to the left circular area, the second cluster 2935B may correspond to the right circular area, the third cluster 2935C may correspond to a generally left part of the background, and the fourth clusters 2935D may correspond to a generally right part of the background in the image 2905. The number of clusters 2935 in the image 2905 may correspond to the number of regions 2930 (and by extension the number of centroids 2925) in the feature space 2915 as defined by the cluster generator 2835.

For each feature vector 2920, the model applier 2830 may determine or identify the corresponding portion in the image 2905. The model applier 2830 may also identify the region 2930 to which the feature vector 2920 is assigned to. Based on these identifications, the model applier 2830 may set or assign the corresponding portion of the image 2905 to one of the clusters 2935. Each cluster 2935 may have a corresponding region 2930 in the feature space 2915, and the portions of the image 2905 assigned to the cluster 2935 may be associated with the corresponding feature vector 2920 mapped to the feature space 2915. In accordance with the correspondences, the model applier 2830 may assign each portion in the image 2905 to one of the clusters 2935. The clusters 2935 may partition or divide the image 2905, and may in aggregate may form the entirety, if not a majority, of the image 2905. In some embodiments, the model applier 2830 may identify the set of pixels forming the portion in the image 2905. With the identification, the model applier 2830 may store and maintain an association between each pixel in the image 2905 with one of the clusters 2935.

Moving onto FIG. 29B, the model trainer 2825 may invoke or use at least one annotation handler 2940 to retrieve, receive, or at least identify at least one annotation 2945 for the image 2905. The annotation 2945 may label or identify the cluster 2935 corresponding to the SOI 2910 within the image 290. The annotation 2945 may have been manually generated or input by a user (e.g., a clinician) examining the image 2905 with the clusters 2935 to facilitate the training of the segmentation model 2840. To that end, in some embodiments, the model trainer 2825 may present or provide information using the set of clusters 2935 from the image 2905. The information may include the image 2905 itself and the set of clusters 2935 forming the image 2905. For example, the model trainer 2825 may present the image 2905 with the clusters 2935 highlighted using different colors via a display of another computing device to the user. Using the information, the user may select the cluster 2935′ from the set of clusters 2935 containing the SOI 2910. The model trainer 2825 may use the selection of the cluster 2935′ to generate the annotation 2945. In turn, the model trainer 2825 may retrieve, identify, or receive the annotation 2945 identifying the selection of the cluster 2935′. The cluster 2935′ identified in the annotation 2945 may contain the SOI 2910 in the image 2905.

In conjunction, the model trainer 2825 may invoke or use at least one noise generator 2950 to include, insert, or otherwise add random noise to the image 2905. Upon identification of the image 2905 from the training dataset 2855, the noise generator 2950 may invoke the noise generator 2950 to generate the random noise. The random noise may change a value in a subset of pixels within the image 2905 from an original value. The noise generator 2950 may generate the random noise using any type of noise, such as Gaussian noise, salt-and-pepper noise, uniform noise, anisotropic noise, shot noise, quantization noise, interference noise, and phase noise, among others. Upon generation, the noise generator 2950 may add the random noise to the subset of pixels within the image 2905. In some embodiments, the model trainer 2825 may skip or omit the addition of the random noise to the image 2905.

The model applier 2830 may invoke or use at least one agent handler 2955 to set or assign an initial state 2960 for the agent 2845 of the segmentation model 2840. The initial state 2960 may identify or indicate a selection of one of the clusters 2935 in the image 2905. The initial state 2960 may correspond to the initial prediction for the cluster 2935 in which the SOI 2910 of the image 2905 is within. For example, the state 2960 may correspond to an identifier (e.g., a number or a set of alphanumerical values) referencing the particular cluster 2935. In some embodiments, the model applier 2830 may use the set of clusters 2935 to define an action space for the agent 2845. The agent space may correspond to a set of possible positions for the agent 2845, and may be referenced using the identifiers for the clusters 2935. In some embodiments, the agent handler 2955 may select, determine, or identify one of the clusters 2935 as the initial state 2960 of the segmentation model 2845. The selection of the initial cluster 2935 may be at random or a set cluster (e.g., the cluster on the top right as depicted). With the identification, the agent handler 2955 may assign the initial state 2960 of the agent 2845 to the selected cluster 2935.

The model applier 2830 may apply the image 2905 to the segmentation model 2840. In some embodiments, the model applier 2830 may apply the initial state 2960 of the agent 2845 in addition with the image 2905 to the segmentation model 2840. In some embodiments, the model applier 2830 may apply the segmentation model 2840 to the state 2960 separately from the image 2905. For example, the model applier 2830 may append the identifier for the cluster 2935 to the image 2905 in applying the segmentation model 2840. In some embodiments, the initial state 2960 may be added onto the image 2905. In some embodiments, the model applier 2830 may add or insert a graphical indicator corresponding to the initial state 2960 into the image 2905 prior to application. The graphical indicator may be, for example, highlighted portion of the image 2905 corresponding to the selected cluster 2935 for the state 2960.

In applying, the model applier 2830 may input or feed the image 2905 along with the assigned state 2960 to the segmentation model 2840. The segmentation model 2840 may have a set of transform layers with kernel parameters (sometimes referred herein as parameters or weights) for managing the agent 2845. The set of transform layers in the segmentation model 2840 may be used to approximate a value function established using reinforcement learning, such as a Q-function. The architecture of the set of transform layers and the kernel parameters of the segmentation model 2840 may be in accordance with a convolutional neural network (CNN), a fully connected (FC) network, a transformer neural network, or any combination thereof, among others. The architecture of the set of transform layers and the kernel parameters of the segmentation model 2840 is detailed herein in conjunction with FIGS. 30A-C. In feeding, the model applier 2830 may process the input image 2905 along with the assigned state 2960 for the agent 2845 in accordance with the kernel parameters of the set of transform layers in the segmentation model 2840.

Continuing with FIG. 29C, from feeding and processing the image 2905 in accordance with the segmentation model 2840, the model applier 2830 may produce or generate at least one output 2965. The output 2965 may be used to determine the cluster 2935 in which the at least one SOI 2910 is in within the image 2905. The output 2965 may include or identify the state 2960 of the agent 2845 corresponding to the selection of the cluster 2935 within the image 2905. The state 2960 in the output 2965 may correspond to the state 2960 assigned by the agent handler 2955, prior to the application to the segmentation model 2840 or the current state of the agent 2845. For example, the state 2960 of the output 2965 may identify the initial selection of the cluster 2935 by the agent 2845 in the image 2905.

In addition, the output 2965 produced by the segmentation model 2840 may include or identify a set of actions 2970A-N (hereinafter generally referred to as actions 2970) to be performed by the agent 2845 with respect to the selection of the cluster 2935. The set of actions 2970 may be within the definition of the action space. Each action 2970 may correspond to, define, or identify the next state 2960′ to which to transition or move the agent 2845. The action 2970 may be to maintain the agent 2845 at the current selection of the cluster 2935 corresponding to the previous state 2960. The action 2970 may also be to change the selection of the previously selected cluster 2935 to a different cluster 2935.

For each action 2970, the output 2965 generated by the segmentation model 2840 may include or identify at least one value 2975A-N (hereinafter generally referred to value 2975). Each value 2975 may correspond to or identify a degree to which the associated action 2945 conforms to or deviates from the optimal transition for the agent 2845 from the state 2960 to determine the cluster 2935′ containing the SOI 2910 in the image 2905. For example, the value 2975 may correspond to a Q value determined from the Q function approximated by the set of transform layers in the segmentation model 2840. In general, the value 2975 may be positive, if the associated action 2970 is to move the agent 2845 into or toward the cluster 2935′ containing the SOI 2910. Conversely, the value 2975 may be negative, if the associated action 2970 is to maintain or move the agent 2845 away from the cluster 2935 containing the SOI 2910 in the image 2905.

With the generation, the model trainer 2825 may select or identify at least one expected value from the value function 2980 against which to compare at least one value 2975 of the output 2965. The value function 2980 may include, identify, or define at least one reward value and at least one penalty value. The reward value may be used when the selection of the cluster 2935 by the agent 2845 according to the action 2970 corresponds to the cluster 2935′ including the SOI 2910 as identified in the annotation 2945. The reward value may be, for example, a positive integer or numerical value. In contrast, the penalty value may be used when the selection of the cluster 2935 by the agent 2845 according to the action 2970 does not correspond to the cluster 2935′ including the SOI 2910 as identified in the annotation 2945. The penalty value may be, for example, a negative integer or numerical value.

For at least one action 2970 in the identified in the output 2965, the model trainer 2825 may identify the subsequent selection of the cluster 2935 by the agent 2845 in the image 2950. In some embodiments, the model trainer 2825 may select the action 2970 corresponding to the maximum value 2975 for the identification. In some embodiments, the model trainer 2830 may identify the action 2970 from the set of actions 2970 in accordance with sampling protocol. For example, the model trainer 2830 may select the action 2970 at random or identify the action 2970 with the highest value 2975 in accordance with the epsilon-greedy algorithm. Upon the identification, the model trainer 2825 may compare the subsequent selection of the cluster 2935 for the agent 2845 with the cluster 2935′ containing the SOI 2910 identified by the annotation 2945. If the selection by the agent 2845 corresponds to the cluster 2935′ including the SOI 2910, the model trainer 2825 may select the reward value from the value function 2980. On the other hand, if the selection by the agent 2845 does not correspond to the cluster 2935′ including the SOI 2910, the model trainer 2825 may select the penalty value from the value function 2980. The selected value may correspond to the expected or target value (also referred herein as a target Q value) to be generated by the segmentation model 2840.

With the selection from the value function 2980, the model trainer 2825 may determine at least one loss metric (sometimes herein referred to as an error metric) for the output 2965 generated by the segmentation model 2840. The determination of the loss metric may be based on the expected value selected from the value function 2980 and the value 2975 of the output 2965, among other factors. The loss metric may indicate a degree of deviation of the output 2965 from the expected result, such as the selection of the cluster 2935′ containing the SOI 2910 as identified in the annotation 2945. In particular, the loss metric may correspond to the degree of deviation of the set of values 2975 in the output 2965 generated by the segmentation model 2840 from the behavior as indicated in the value function 2980. The loss metric may be calculated in accordance with any number of loss functions, such as a Huber loss, norm loss (e.g., L1 or L2), mean squared error (MSE), a quadratic loss, and a cross-entropy loss, among others. In general, the higher the loss metric, the more the output may have deviated from the expected result of the input. Conversely, the lower the loss metric, the lower the output may have deviated from the expected result.

Using the loss metric, the model trainer 2825 may modify, set, or otherwise update at least one kernel parameter in the set of transform layers of the segmentation model 2840. The updating of the set of transform layers in the segmentation model 2840 may be in accordance with an optimization function (e.g., the Bellman equation). The optimization function may define one or more rates or parameters at which the weights of the segmentation network 2840 are to be updated. The updating of the segmentation model 2840 may be to align the values 2975 in the outputs 2945 from the segmentation model 2840 to the expected value as identified in the value function 2980.

In some embodiments, the model trainer 2825 may store and maintain at least a portion of the output 2965 on at least one buffer 2985 (sometimes herein referred to as an experience replay buffer). The model trainer 2825 may generate at least one entry to store on the buffer 2985 using the output 2965. The entry may identify or include the state 2960 of the agent 2845, at least one action 2970, and at least one value 2975 selected from the current iteration. For example, the action 2970 included in the entry may correspond to the highest value 2975. In some embodiments, the entry may include the expected value for the action 2970 selected from the value function 2980. The entry may be used in subsequent iterations of the application of the segmentation model 2840 while training.

The model applier 2830 may determine whether to perform another iteration of the application of the image 2950 to the segmentation model 2840. In some embodiments, the mode applier 2830 may maintain a counter to keep track of a number of iterations. Upon production of the output 2965, the model applied 2830 may compare the number of iterations to a maximum number of iterations. The maximum number of iterations may be a fixed number (e.g., 100 epochs). In some embodiments, the model applier 2830 may determine or identify the maximum number of iterations based on a number of clusters 2935 defining the action space for the agent 2845. For example, the maximum number of iterations may be a multiple (e.g., 5 or 10 times) of the number of clusters 2935.

If the number of iterations performed is greater than or equal to the maximum number, the model applier 2830 may cease the application of the image 2905 to the segmentation model 2840. The model trainer 2825 may retrieve or identify the subsequent example in the training dataset 2855, from which to identify the next image 2905 to apply. The model applier 2830 and the model trainer 2825 may repeat the functionalities described above with the next example of the training dataset 2855. Conversely, if the number of iterations performed is less than the maximum number, the model applier 2830 may perform another iteration of the application of the image 2905 to the segmentation model 2840.

For a subsequent iteration of the application, the agent handler 2955 of the model applier 2830 may identify or select the next state 2960′ to which to transition the agent 2845 based on the set of actions 2970 and the set of values 2975. In some embodiments, the agent handler 2955 may select the state 2960′ for the agent 2845 corresponding to the action 2970 with the maximum value 2975. In some embodiments, the agent handler 2955 may select the next state 2960′ corresponding to the action 2970 with the maximum expected value as identified by the value function 2965. The next state 2960′ may identify or indicate the subsequent selection of the cluster 2935 for the agent 2845. The subsequent selection may correspond to the next prediction by the agent 2845 as to the cluster 2935 containing the SOI 2910 in the image 2905.

In some embodiments, the model trainer 2825 may use a different state to use as the next state 2960′ instead of the state 2960′ selected by the agent handler 2955 for the subsequent iteration. After multiple iterations, the buffer 2895 may identify or include multiple entries. As discussed above, each entry may include a state 2960 of the agent 2845, at least one action 2970, and at least one value 2975 from one of the previous iterations. The model trainer 2825 may access the buffer 2895 to identify, sample, or select at least one entry. The selection of the entry may be at random or in accordance with a set rate (e.g., selection from two or three previous iterations). Upon selection, the model trainer 2825 may parse the entry to identify the state 2960 and the action 2970, among other information. Once selected, the model trainer 2825 may use the state 2960 and the action 2970 from the sampled entry of the buffer 2895 for the next iteration. The state 2960 and the action 2970 for the agent sampled from the buffer 2895 may be used, rather than the state 2960′ selected by the agent handler 2955

Upon identification of the next state 2960′, the model trainer 2825 and the model applier 2830 may repeat many of the functionalities described above in processing the image 2905. For example, the model trainer 2825 may generate random noise to add to the image 2905 prior to application. The random noise added to the model trainer 2825 may be different from previous iteration. In turn, the model applier 2830 may apply the image 2905 along with the state 2960′. In feeding, the model applier 2830 may feed the image 2905 along with the state 2960′ to the segmentation model 2840. The model applier 2830 may process the image 2905 with the next state 2960′ in accordance with the kernel parameters of the set of transform layers in the segmentation model 2840. Again, from processing the image 2905, the model applier 2830 may produce or generate another output 2965. The output 2965 may identify the state 2960′ of the agent 2845, a set of actions 2970 to be performed by the agent 2845, and a set of corresponding values 2975.

Referring now to FIG. 30A, depicted is a block diagram of an architecture 3000 of the segmentation model 2835 of the system 2800 for segmenting images. Under the architecture 3000, the segmentation model 2840 may include at least one encoder block 3005 and at least one activator block 3010, among others. The kernel parameters and the set of transform layers of the segmentation model 2840 may be configured, arrayed, or otherwise arranged across the encoder block 3005 and the activator block 3010. The encoder block 3005 and the activator block 3010 may be connected with one another in configuration, such as in series (e.g., as depicted) or in parallel, or any combination thereof.

The segmentation model 2840 may have at least one input and at least one output. The input and the output may be related to one another via the set of transform layers across the encoder block 3005 and the activator block 3010. The input may include the image 2905 and the state 2960, and may correspond to an input of the encoder block 3005. The output of the encoder block 3005 may include a feature map generated from the image 2905 using the set of transform layers in accordance with the associated set of transform layers, and may be fed forward as the input to the activator block 3010. The output of the activator block 3010 may be a feature map corresponding to the output 2965 as discussed above, and may serve as the output of the overall segmentation model 2840.

Referring now to FIG. 30B, depicted is a block diagram of an architecture 3025 of a transform block 3030 in the segmentation model 2840 of the system 2800 for segmenting images. The transform block 3030 may be used to implement the encoder block 3005 and the activator block 3010 in the segmentation model 2840. In some embodiments, the transform block 3030 may be used in the cluster generator 2835 in generating the feature vectors 2920. For example, the encoder block 3005 and the activator block 3010 may each be an instance of the block 3030. Under the architecture 3025, the block 3030 may include one or more transform blocks 3035A-N (hereinafter generally referred to as a transform block 3035). The set of transform stack 2825 can be arranged in series (e.g., as depicted) or parallel configuration, or in any combination. In a series configuration, the input of one transform stack 2825 may include the output of the previous transform stack 2825 (e.g., as depicted). In parallel configuration, the input of one transform stack 2825 may include the input of the entire block 3030.

The block 3030 may include at least one input 3040 and at least one output feature map 3045. The kernel parameters arranged across the transform stacks 3035 may define the relationship between the input 3040 and the output 3045. When used to implement the encoder block 3005, the input 3040 may correspond to the image 2905 and the state 2960, and the output may be the feature map 3045. When used to implement the activator block 3010, the input 3040 may include the feature map generated by the encoder block 3005, and the output may be the output 2965 for the overall segmentation model 2840. When used to implement the cluster generator 2835, the input 3040 may correspond to the image 2905 (or tiles generated from the image 2905) and the output 3045 may correspond to the feature vectors 2920.

Referring now to FIG. 30C, depicted is a block diagram of an architecture 3050 of a set of transform layers 3030 in a transform block 3050 in the segmentation model 2840 of the system 2800 for segmenting images. The transform stack 2825 may be used to implement the encoder block 3005 and the activator block 3010 of the segmentation model 2840. In some embodiments, the transform stack 2825 may be used to implement the cluster generator 2835. The transform stack 3035 may include a set of transform layers 3055A-N (hereinafter generally referred to as transform layers 3055). The transform stack 3035 may include at least one input 3060 and at least output 3065. The input 3060 and the output 3065 may be related to each other via the set of kernel parameters defined across the transform layers 3055. The set of transform layers 3055 can be arranged in any configuration such as in series or in parallel, or any combination thereof. For example, under series configuration, the transform layers 3055 may have an output 3065 of one transform layer 3055 fed as an input 3060 to a succeeding transform layer 3055.

Each transform layer 3055 may have a non-linear input-to-output characteristic. The transform layer 3055 may comprise a convolutional layer, a normalization layer, and an activation layer (e.g., a rectified linear unit (ReLU)), among others. When used to implement the encoder block 3005, the transform layers 3055 of the transform stack 3035 may be configured or arranged as a convolutional neural network (CNN). For example, the convolutional layer, the normalization layer, and the activation layer (e.g., a softmax function or rectified linear unit (ReLU)) in the transform layers 3055 may be arranged in accordance with CNN. When used to implement the activator block 3010, the transform layers 3055 may be configured or arranged as a fully-connected layer (FCL). For example, the transform layers 3055 may include the activation layers (e.g., a softmax function or rectified linear unit (ReLU)). When used to implement the cluster generator 2835, the transform layers 3055 of the transform stack 3035 may be configured or arranged as a convolutional neural network (CNN) to generate the feature vectors 2920. For example, the convolutional layer, the normalization layer, and the activation layer (e.g., a softmax function or rectified linear unit (ReLU)) in the transform layers 3055 may be arranged in accordance with CNN.

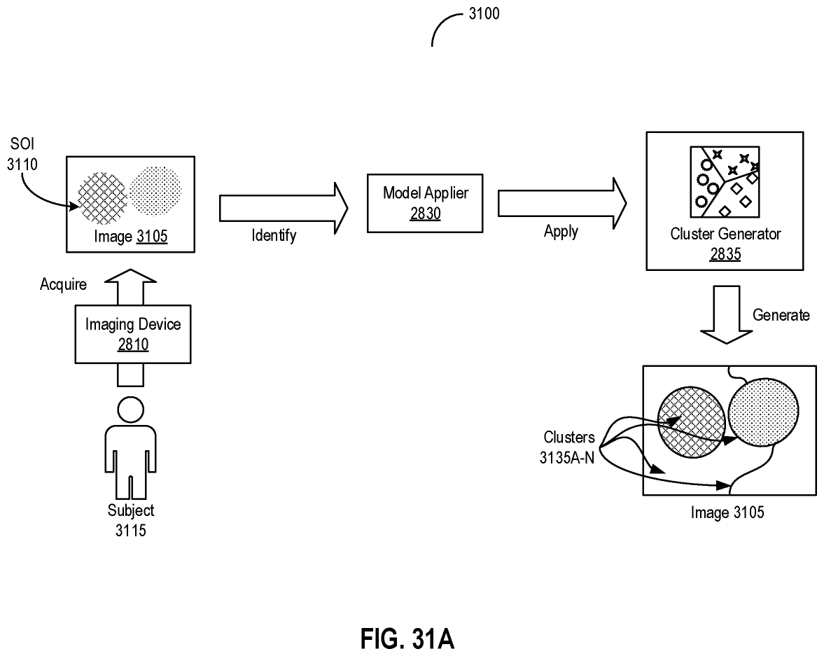

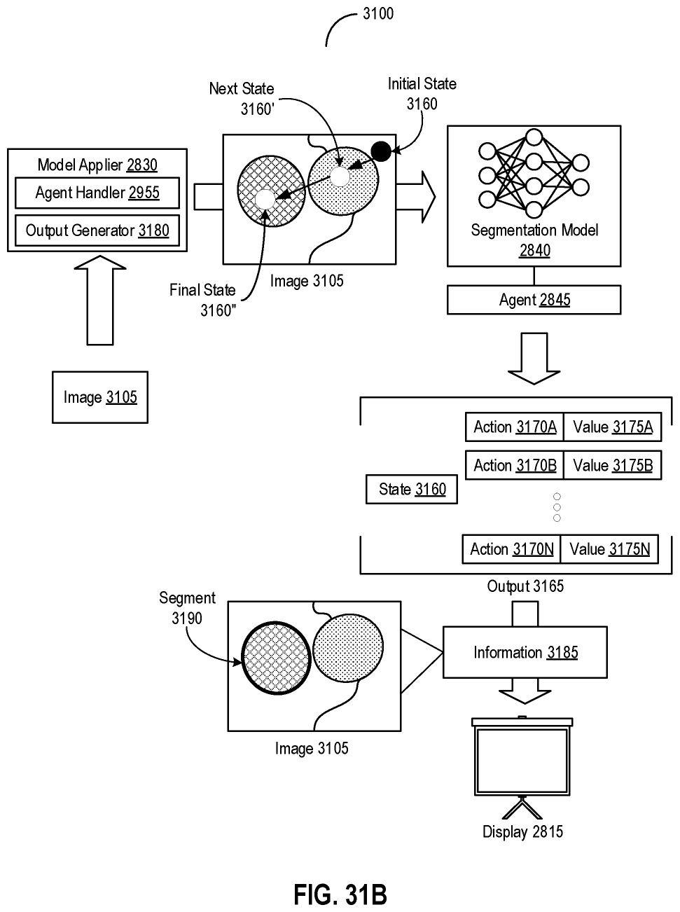

Referring now to FIGS. 31A and 31B, depicted are block diagrams of a process 3100 for using models in the system 2800 for segmenting images. The process 3100 may include operations performed by the image processing system 2805 under the runtime or evaluation mode. The operations of process 3100 may include at least some of the operations in process 2900 to train the segmentation model 2840. Starting with FIG. 31A, the imaging device 2810 may produce, output, or otherwise generate at least one image 3105. The image 3105 may be similar to the image 2905 as discussed above, but may be acquired during the runtime mode. The image 3105 may include at least one structure of interest (SOI) 3110 (also referred herein as a region of interest (ROI)). The SOI 3110 may correspond to an area, section, or part of the image 3105 that corresponds to feature in the sample (or object) from which the image 3105 is acquired. In some embodiments, the SOI 3110 may correspond to a condition (e.g., a presence or lack thereof) of the feature in the sample. For example, the SOI 3110 may correspond to a part of the image 3105 depicting a lesion in a magnetic resonance imaging (MRI) scan of a brain of a human subject. The condition in this example may correspond to whether the brain has the tumor or does not have any tumor.

The image 3105 may be derived or acquired from at least one subject 3115. The subject 3115 may include any object used to derive the image 3105. For example, the subject 3115 may include a human, an animal, a plant, or a cellular organism, among others. The image 3105 may be acquired, derived, or otherwise be of a sample (or object). The image 3105 may be a two-dimensional section of the sample or a three-dimensional volume of the sample (e.g., human subject). For example, the image 3105 may include a set of two-dimensional cross-sections (e.g., a front, a sagittal, a transverse, or an oblique plane) acquired from the three-dimensional volume. The image 3105 may be defined in terms of pixels, in two-dimensions or three-dimensions. In some embodiments, the image 3105 may be part of a video acquired of the sample over time. For example, the image 3105 may correspond to a single frame of the video acquired of the sample over time at a frame rate.

In generating the image 3105, the imaging device 2810 may acquire from at least one subject 3115 in accordance with any number of imaging modalities or techniques. For example, the imaging device 2810 may use a tomographic imaging technique, such as magnetic resonance imaging (MM), nuclear magnetic resonance (NMR) imaging, X-ray computed tomography (CT), ultrasound imaging, positron emission tomography (PET) imaging, and photoacoustic spectroscopy, among others. The image 3105 generated by the imaging device 2810 may be a tomogram, such as an MM image, a NMR image, CT image, ultrasound image, X-ray image, and PET image, among others. Upon acquisition and generation, the imaging device 2810 may send, transmit, or otherwise provide the image 3105 to the imaging processing system 2805. While discussed primarily in terms of tomograms and tomographs, the imaging device 2810 may support other imaging modalities besides the ones listed above, such as optical photography or microscopy, among others.

The model applier 2830 may receive, retrieve, or otherwise identify the image 3105. In some embodiments, the model applier 2830 may identify the image 3105 of the subject 3115 acquired via the imaging device 2810. Upon identification, the model applier 2830 may apply the image 3105 to the cluster generator 2835. In applying, the model applier 2830 may feed and process the image 3105 in accordance with the kernel parameters in the set of transform layers of the cluster generator 2835. In some embodiments, the model applier 2830 may generate a set of tiles from the image 3105, and may feed the tiles into the cluster generator 2835. From feeding the image 3105, the model applier 2830 may generate the set of feature vectors 2920. For each feature vector 2920, the model applier 2830 may determine or identify the corresponding region 2930 to which to assign the feature vector 2920. To identify, the model applier 2830 may calculate or determine a distance between the point corresponding to the feature vector 2920 and each centroid 2925 within the feature space 2915. The distance may be determined in accordance with Euclidean distance or L-norm distance, among others

Based on the distances to the centroids 2925 within the feature space 815, the model applier 2830 may assign the feature vector 2920 to one of the regions 2930. In some embodiments, the model applier 2830 may identify the region 2930 to which to assign the feature vector 2920 based on the values along the dimensions of the feature vector 2920. The model applier 2830 may compare the values along the dimensions of the feature vector 2920 with the values of the feature space 815 associated with the set of regions 2930. Based on the comparison, the model applier 2830 may assign the feature vector 2920 to the region 2930 in which the values along the dimensions reside. Using the assignments of the feature vectors 2920 to the respective regions 2930, the model applier 2830 may identify, determine, or otherwise generate a set of clusters 3135A-N (hereinafter generally referred to as clusters 3135) from the image 3105. Each cluster 3135 may correspond to a region or an area in the image 3105 having a common visual characteristic. The number of clusters 3135 in the image 3105 may correspond to the number of regions 2930 (and by extension the number of centroids 2925) in the feature space 2915 as defined by the cluster generator 2835.

For each feature vector 2920, the model applier 2830 may determine or identify the corresponding portion in the image 3105. The model applier 2830 may also identify the region 2930 to which the feature vector 2920 is assigned to. Based on these identifications, the model applier 2830 may set or assign the corresponding portion of the image 3105 to one of the clusters 3135. Each cluster 3135 may have a corresponding region 2930 in the feature space 2915, and the portions of the image 3105 assigned to the cluster 3135 may be associated with the corresponding feature vector 2920 mapped to the feature space 2915. In accordance with the correspondences, the model applier 2830 may assign each portion in the image 3105 to one of the clusters 3135. The clusters 3135 may partition or divide the image 3105, and may in aggregate may form the entirety, if not a majority, of the image 3105. In some embodiments, the model applier 2830 may identify the set of pixels forming the portion in the image 3105. With the identification, the model applier 2830 may store and maintain an association between each pixel in the image 3105 with one of the clusters 3135

Moving onto FIG. 31B, the model applier 2830 may invoke or use the agent handler 2955 to set or assign an initial state 3160 for the agent 2845 of the segmentation model 2840. For example, the state 3160 may correspond to an identifier (e.g., a number or a set of alphanumerical values) referencing the particular cluster 3135. The state 3160 may identify or indicate a selection of one of the clusters 3135 in the image 3105. The initial state 3160 may correspond to the initial prediction for the cluster 3135 in which the SOI 3110 of the image 3105 is within. In some embodiments, the model applier 2830 may use the set of clusters 3135 to define an action space for the agent 2845. The agent space may correspond to a set of possible positions for the agent 2845, and may be referenced using the identifiers for the clusters 3135. In some embodiments, the agent handler 3155 may select, determine, or identify one of the clusters 3135 as the initial state 3160 of the segmentation model 2845. The selection of the initial cluster 3135 may be at random or a set cluster (e.g., the cluster on the top right as depicted). With the identification, the agent handler 2955 may assign the initial state 3160 of the agent 2845 to the selected cluster 3135.

The model applier 2830 may apply the image 3105 to the segmentation model 2840. In some embodiments, the model applier 2830 may apply the initial state 3160 of the agent 2845 in addition with the image 3105 to the segmentation model 2840. In some embodiments, the model applier 2830 may apply the segmentation model 2840 to the state 3160 separately from the image 3105. For example, the model applier 2830 may append the identifier for the cluster 3135 to the image 3105 in applying the segmentation model 2840. In some embodiments, the initial state 3960 may be added onto the image 3105. In some embodiments, the model applier 2830 may add or insert a graphical indicator corresponding to the initial state 3160 into the image 3105 prior to application. The graphical indicator may be, for example, highlighted portion of the image 3105 corresponding to the selected cluster 3135 for the state 3160. In applying, the model applier 2830 may input or feed the image 3105 along with the assigned state 3160 to the segmentation model 2840. Upon feeding, the model applier 2830 may process the input image 3105 along with the assigned state 3160 for the agent 2845 in accordance with the kernel parameters of the set of transform layers in the segmentation model 2840.

From feeding and processing the image 3105 in accordance with the segmentation model 2840, the model applier 2830 may produce or generate at least one output 3165. The output 3165 may be used to determine the cluster 3135 in which the at least one SOI 3110 is in within the image 3105. The output 3165 may include or identify the state 3160 of the agent 2845 corresponding to the selection of the cluster 3135 within the image 3105. The state 3160 in the output 3165 may correspond to the state 3160 assigned by the agent handler 3155, prior to the application to the segmentation model 2840 or the current state of the agent 2845. For example, the state 3160 of the output 3165 may identify the initial selection of the cluster 3135 by the agent 2845 in the image 3105.

In addition, the output 3165 produced by the segmentation model 2840 may include or identify a set of actions 3170A-N (hereinafter generally referred to as actions 3170) to be performed by the agent 2845 with respect to the selection of the cluster 3135. The set of actions 3170 may be within the definition of the action space. Each action 3170 may correspond to, define, or identify the next state 3160′ to which to transition or move the agent 2845. The action 3170 may be to maintain the agent 2845 at the current selection of the cluster 3135 corresponding to the previous state 3160. The action 3170 may also be to change the selection of the previously selected cluster 3135 to a different cluster 3135.

For each action 3170, the output 3165 generated by the segmentation model 2840 may include or identify at least one value 3175A-N (hereinafter generally referred to value 3175). Each value 3175 may correspond to or identify a degree to which the associated action 3145 conforms to or deviates from the optimal transition for the agent 2845 from the state 3160 to determine the cluster 3135′ containing the SOI 3110 in the image 3105. For example, the value 3175 may correspond to a Q value determined from the Q function approximated by the set of transform layers in the segmentation model 2840. In general, the value 3175 may be positive, if the associated action 3170 is to move the agent 2845 into or toward the cluster 3135′ containing the SOI 3110. Conversely, the value 3175 may be negative, if the associated action 3170 is to maintain or move the agent 2845 away from the cluster 3135 containing the SOI 3110 in the image 3105.

With the generation of the output 3165, the model applier 2830 may determine whether to perform another iteration of the application of the image 3105 to the segmentation model 2840. In some embodiments, the mode applier 2830 may maintain a counter to keep track of a number of iterations. Upon production of the output 3165, the model applied 2830 may compare the number of iterations to a maximum number of iterations. The maximum number of iterations may be a fixed number (e.g., 100 epochs). In some embodiments, the model applier 2830 may determine or identify the maximum number of iterations based on a number of clusters 3135 defining the action space for the agent 2845. For example, the maximum number of iterations may be a multiple (e.g., 5 or 10 times) of the number of clusters 3135.

If the number of iterations performed is less than the maximum number, the model applier 2830 may perform another iteration of the application of the image 3105 to the segmentation model 2840. For the next iteration, the agent handler 3155 of the model applier 2830 may identify or select the next state 3160′ to which to transition the agent 2845 based on the set of actions 3170 and the set of values 3175. In some embodiments, the agent handler 3155 may select the state 3160′ for the agent 2845 corresponding to the action 3170 with the maximum value 3175. The next state 3160′ may identify or indicate the subsequent selection of the cluster 3135 for the agent 2845. The subsequent selection may correspond to the next prediction by the agent 2845 as to the cluster 3135 containing the SOI 3110 in the image 3105.

Upon identification of the next state 3160′, the model applier 2830 may repeat many of the functionalities described above in processing the image 3105. For example, the model applier 2830 may apply the image 3105 along with the state 3160′. In feeding, the model applier 2830 may feed the image 3105 along with the state 3160′ to the segmentation model 2840. The model applier 2830 may process the image 3105 with the next state 3160′ in accordance with the kernel parameters of the set of transform layers in the segmentation model 2840. Again, from processing the image 3105, the model applier 2830 may produce or generate another output 3165. The output 3165 may identify the state 3160′ of the agent 2845, a set of actions 3170 to be performed by the agent 2845, and a set of corresponding values 3175. The model applier 2830 may determine whether to perform another iteration again.

Conversely, if the number of iterations performed is greater than or equal to the maximum number, the model applier 2830 may cease the application of the image 2905 to the segmentation model 2840. In addition, the model applier 2830 may determine or identify at least one segment 3910 corresponding to the SOI 3110 in the image 3905 based on the output 3165. To identify, the model applier 2830 may identify or select a final state 3160″ to which to transition the agent 2845 based on the set of actions 3170 and the set of values 3175. In some embodiments, the agent handler 3135 may select the final state 3160″ for the agent 2845 corresponding to the action 3170 with the maximum value 3175. By the time that the model applier 2830 terminates iterations, the agent 2845 of the segmentation model 2840 may have been continuously selecting the cluster 3135 containing the SOI 3110 in the image 3105. As such, the final state 3160″ may identify the selection of the cluster 3135 by the agent 2845 containing the SOI 3110 of the image 3105. From the final state 3160″ for the agent 2845, the model applier 2830 may identify the segment 3190 corresponding to the SOI 3110 within the image 3105.

Using the determined location of the SOI 3110, the model applier 2830 may invoke or use at least one output generator 3180 to generate information 3185. The information 3185 may identify or include the segment 3190 containing the SOI 3110 within the image 3105. The segment 3190 may be identified in terms of pixel coordinates within the image 3105 or the corresponding cluster 3135. In some embodiments, the information 3185 may include the original image 3105 itself and the segment 3109 including the SOI 3110. In some embodiments, the information 3185 may include the image 3105 with the graphical indicator corresponding to the cluster 3135 associated with the segment 3190. The graphical indicator may be, for example, a highlight or a change in color value to the pixels in the cluster 3135 corresponding to the segment 3190 within the image 3105. In some embodiments, the output generator 3180 may use a template to generate the information 3185 for output. For example, the template may be a radiology report with empty fields, and the output generator 3180 may populate the empty fields with the identified segment 3190 to use as the information 3185 for output.

Upon generation, the output generator 3180 of the model applier 2830 may provide the information 3185. In some embodiments, the model applier 2830 may send, transmit, or otherwise provide the information 3185 for presentation via the display 2815. The display 2815 may render, display, or present the information 3185, such as the image 3105 and the segment 3190 containing the SOI 3110 within the image 3105. For example, the output generator 3180 may provide the information 3185 to present via a graphical user interface on the display 2815 to display the image 3105 and the segment 3190 containing the SOI 3110 within the image 3105. In some embodiments, the model applier 2830 may store and maintain the information 3185 on a database accessible from the image processing system 2805.

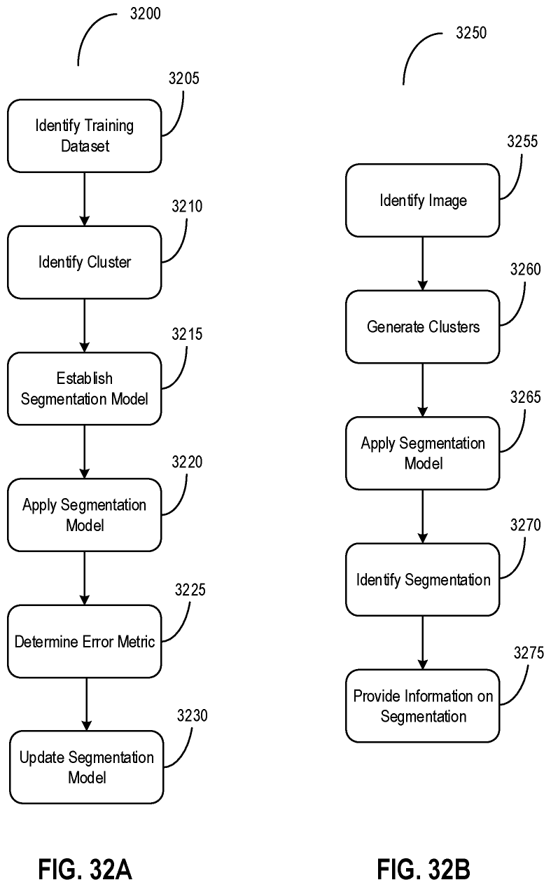

Referring now to FIG. 32A, depicted is a flow diagram of a method 3200 of training models to segment images. The method 3200 may be performed by or implementing using the system 2800 described herein in conjunction with FIGS. 28-32B or the system 3800 as described herein in conjunction with Section H. Under method 3200, a computing system may identify a training dataset including an image (3205). The computing system may identify a cluster from the image (3210). The computing system may establish a segmentation model using the training dataset (3215). The computing system may apply the image to the segmentation model (3220). The computing system may determine an error metric using an output of the segmentation model (3225). The computing system may update the segmentation model using the error metric (3230).

Referring now to FIG. 32B, depicted is a flow diagram of a method 3250 of segmenting images. The method 3250 may be performed by or implementing using the system 2800 described herein in conjunction with FIGS. 28-32B or the system 3800 as described herein in conjunction with Section H. Under method 3250, a computing system may an image (3255). The computing system may generate clusters from the image (3260). The computing system may apply the segmentation model to the image (3265). The computing system may identify a segmentation corresponding to a structure of interest in the image (3270). The computing system may provide information on segmentation (3275).

### G. Systems and Methods for Models Established Using Reinforcement Learning to Perform Classification of Biomedical Images

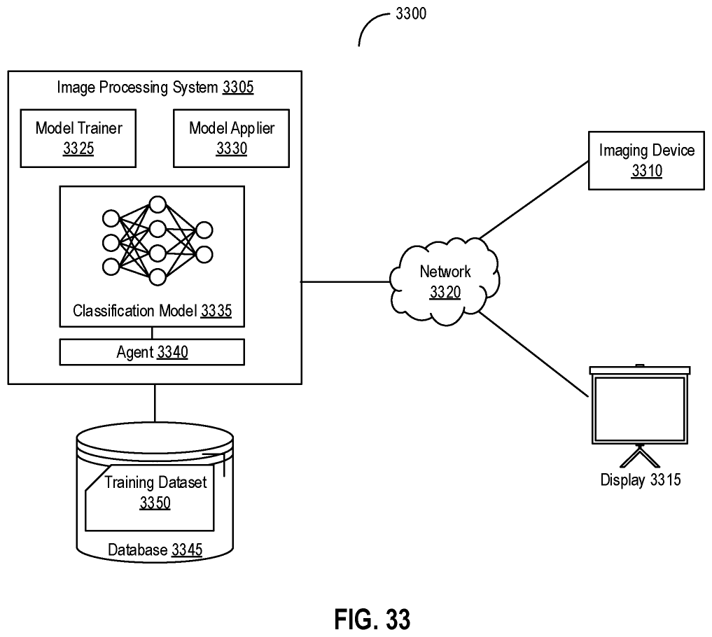

Referring now to FIG. 33, depicted is a block diagram of a system 3300 for classifying images. In overview, the system 3300 may include at least one image processing system 3305, at least one imaging device 3310, and at least one display 3315, communicatively coupled via at least one network 3320. The image processing system 3305 may include at least one model trainer 3325, at least one model applier 3330, at least one segmentation model 3335 for managing at least one agent 3340, and at least one database 3345, among others. The database 3345 may store, maintain, or otherwise include at least one training dataset 3350. Each of the components in the system 3300 as detailed herein may be implemented using hardware (e.g., one or more processors coupled with memory) or a combination of hardware and software as detailed herein in Section H. Each of the components in the system 3300 may implement or execute the functionalities detailed herein, such as those described in Sections A-D

In further detail, the image processing system 3305 itself and the components therein, such as the model trainer 3325, the model applier 3330, and the classification model 3335 may have a training mode and a runtime mode (sometimes herein referred to as an evaluation or inference mode). Under the training mode, the image processing system 3305 may invoke the model trainer 3325 to train the classification model 3335 using the training dataset 3350. Under the runtime, the classification model 3335 may invoke the model applier 3330 to apply the classification model 3340 to new incoming images from the imaging device 3310.

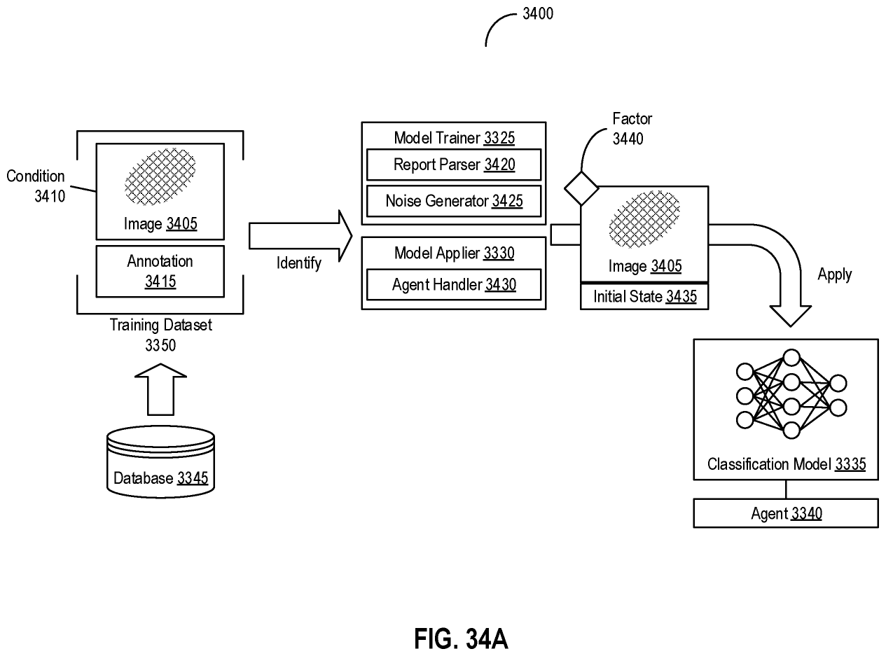

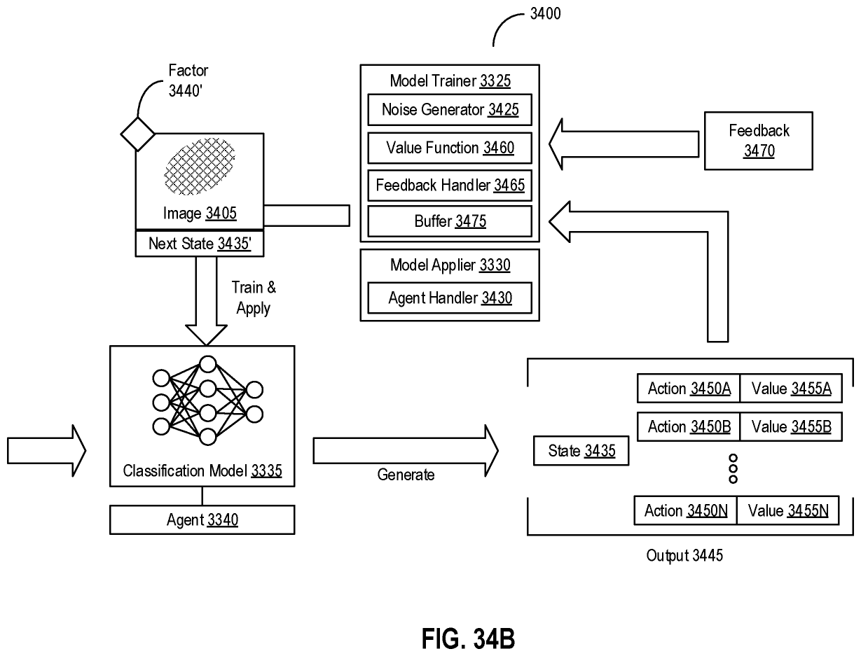

Referring now to FIGS. 34A and 34B, depicted are block diagrams of a process 3400 for training the classification model 3335 in the system 3300 for classifying images. The process 3400 may include operations performed by the image processing system 3305 under the training mode. Starting with FIG. 34A, the model trainer 3325 executing on the image processing system 3305 may initialize, train, or otherwise establish the classification model 3335. The classification model 3335 may include a set of transform layers with kernel parameters to manage the agent 3340. In initializing, the model trainer 3325 may set or assign values (e.g., random values) to the parameters in a set of transform layers of the classification model 3335. The agent 3340 may have a state with respect to an input to the classification model 3335. To train the classification model 3335, the model trainer 3325 may access the database 3345 to fetch, retrieve, or identify the training dataset 3350. With the identification, the model trainer 3325 may train the classification model 3335 using the training dataset 3350. The training of the classification model 3335 may be in accordance with reinforcement learning.

The training dataset 3350 may identify or include one or more examples. Each example may include at least one image 3405 (sometimes herein referred to as a sample image or example image). The image 3405 may be acquired, derived, or otherwise be of a sample (or object). The image 3405 may be a two-dimensional section of the sample or a three-dimensional volume of the sample (e.g., human subject). For example, the image 3405 may include a set of two-dimensional cross-sections (e.g., a front, a sagittal, a transverse, or an oblique plane) acquired from the three-dimensional volume. The image 3405 may be defined in terms of pixels, in two-dimensions or three-dimensions. In some embodiments, the image 3405 may be part of a video acquired of the sample over time. For example, the image 3405 may correspond to a single frame of the video acquired of the sample over time at a frame rate.

The image 3405 may be acquired using any number of imaging modalities or techniques. For example, the image 3405 may be a tomogram acquired in accordance with a tomographic imaging technique, such as a magnetic resonance imaging (MRI) scanner, a nuclear magnetic resonance (NMR) scanner, X-ray computed tomography (CT) scanner, an ultrasound imaging scanner, and a positron emission tomography (PET) scanner, and a photoacoustic spectroscopy scanner, among others. The image 3405 may be a single instance of acquisition (e.g., X-ray) in accordance with the imaging modality, or may be part of a video (e.g., cardiac MM) acquired using the imaging modality. Although the present disclosure discusses the image 3405 primarily in terms of a tomogram, other imaging modalities besides those listed above may be supported by the image processing system 3305.

The image 3405 may have at least one condition 3410 corresponding to a feature in the sample from which the image 3405 is acquired. The condition 3410 may correspond to at least one structure of interest (SOI) (also referred herein as a region of interest (ROI)) depicted in the image 3405. The SOI may correspond to an area, section, or part of the image that corresponds to feature in the sample (or object) from which the image 3405 is acquired. In some embodiments, the SOI may correspond to a condition (e.g., a presence or lack thereof) of the feature in the sample. For example, the SOI may correspond to a part of the image 3405 depicting a lesion in a magnetic resonance imaging (MRI) scan of a brain of a human subject. The condition 3410 in this example may correspond to whether the brain has the tumor or does not have any tumor. In some embodiments, the image 3405 may have multiple conditions 3410, corresponding to different types of SOI within the image 3405.

For each image 3405 in the example, the training dataset 3350 may identify or include at least one annotation 3415. The annotation 3415 may define, specify, or otherwise identify a presence or a lack of the condition 3410 in the sample from which the image 3405 is derived. In some embodiments, the annotation 3415 may identify any characteristic (including presence or absence) associated with the condition 3410. The condition 3410 may correspond to the feature in the sample or the SOI depicted in the image 3405. The annotation 3415 may have been manually generated or input by a user (e.g., a clinician) examining the image 3405 to facilitate the training of the classification model 3335. The annotation 3415 may lack identification of specification locations of the SOI indicating presence or absence of the condition 3410 in the image 3405. The annotation 3415 instead may indicate that the condition 3410 is present somewhere within the image 3405. In some embodiments, the annotation 3415 may identify multiple conditions 3410 (and the presence or absence thereof) for the image 3405. In some embodiments, the training dataset 3350 may lack any annotations 3415 for the image 3405, prior to application of the image 3405 into the classification model 3335.

In some embodiments, the model trainer 3325 may invoke or use at least one report parser 3420 to parse the annotation 3415 to identify the condition 3410 for the image 3405 in the training dataset 3350. The annotation 3415 may be maintained and stored as a report associated with the image 3405. For example, the report may include data generated and input by a user (e.g., the clinician) and may be maintained in the form of a file, such as a text file, a document, or a scanned image, among others, on the database 3345. The report may include an identifier for the image 3405 (e.g., file name of image, subject name, or anonymized subject name) and an identifier for the condition 3410 depicted in the image 3405. In some embodiments, the training dataset 3350 or the database 3345 may lack any report associated with the image 3405, prior to inputting into the classification model 3335.

Upon invocation, the report parser 3420 may access the database 3345 to fetch, retrieve, or identify the report associated with the image 3405. With the identification, the report parser 3420 may parse the report to extract or identify the data. From the data in the report, the report parser 3420 may derive, extract, or identify the condition 3410 associated with the image 3405. For example, when the report is a text file or document, the report parser 3420 may find a field-value pair corresponding to the presence or absence of the condition 3410 for the image 3405. When the report is an image file, the report parser 3420 may apply a computer vision algorithm (e.g., optical character recognition (OCR)) to the image to find text identifying the presence or absence of the condition 3410. With the identification, the report parser 3420 may use the condition 3410 from the report as the annotation 3415 for the image 3405.

With the identifications, the model trainer 3325 may use at least one noise generator 3425 to include, insert, or otherwise add random noise to the image 3405. Upon identification form the training dataset 3350, the model trainer 3325 may invoke the noise generator 3425 to generate the random noise. The random noise may change a value in a subset of pixels within the image 3405 from an original value. The noise generator 3425 may generate the random noise using any type of noise, such as Gaussian noise, salt-and-pepper noise, uniform noise, anisotropic noise, shot noise, quantization noise, interference noise, and phase noise, among others. Upon generation, the noise generator 3425 may add the random noise to the subset of pixels within the image 3405. In some embodiments, the model trainer 3325 may skip or omit the addition of the random noise to the image 3405.

In conjunction, the model applier 3330 executing on the image processing system 3305 may invoke or use at least one agent handler 3430 to set or assign an initial state 3435 for the agent 3340 of the classification model 3335. The initial state 3435 may identify or indicate a classification of the image 3405 as having the presence or absence of the condition 3410. In some embodiments, the agent handler 3430 may use the presence or the absence of each condition 3410 as an action space for the agent 3340. In some embodiments, the agent handler 3430 may select, determine, or identify the classification as one of presence or the absence of the condition 3410 as the initial state 3435 for the agent 3340. The initial state 3435 may correspond to the initial prediction for the classification of the agent 3405 as having or lacking the condition 3410. The identification of the classification of the condition 3410 may be set at random or a set value (e.g., presence of the condition 3410). With the identification, the agent handler 3430 may assign the initial state 3435 to the agent 3340.

Based on the initial state 3435, the agent handler 3430 may determine, assign, or otherwise set at least one factor 3440 for the agent 3405. The initial state 3435 may be associated with the factor 3440 to indicate the classification of the image 3405 as having the presence or absence of the condition 3410. The factor 3440 in turn may indicate or identify the initial state 3435 of the agent 3340 and by extension the classification determined by the agent 3340 for the image 3405. The factor 3440 itself may be an indicator to be input into the classification model 3335 along with the image 3405. The value of the indicator for the factor 3440 may indicate the initial state 3435 of the agent 3340. In some embodiments, the agent handler 3430 may generate the factor 3440 as an indicator (e.g., a Binary value) separate from the image 3405. In some embodiments, the agent handler 3430 may generate the factor 3440 as a graphical indicator to add or insert in the image 3405. For example, the factor 3440 may be a colored overlay, with red indicating a presence of the condition 3410 and green indicating an absence of the condition 3410. In some embodiments, the agent handler 3430 may omit the generation and insertion of the factor 3440.

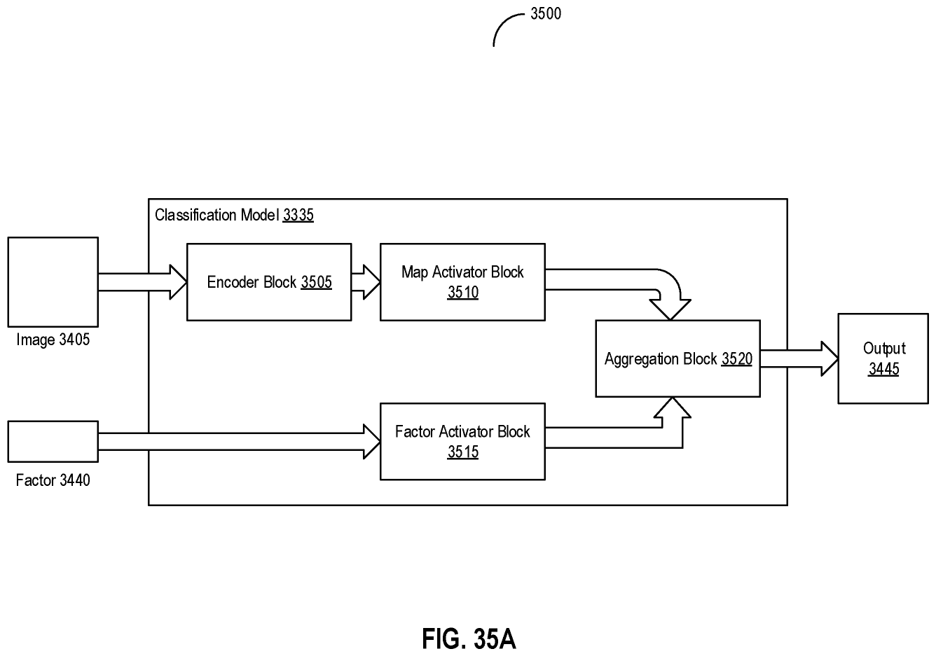

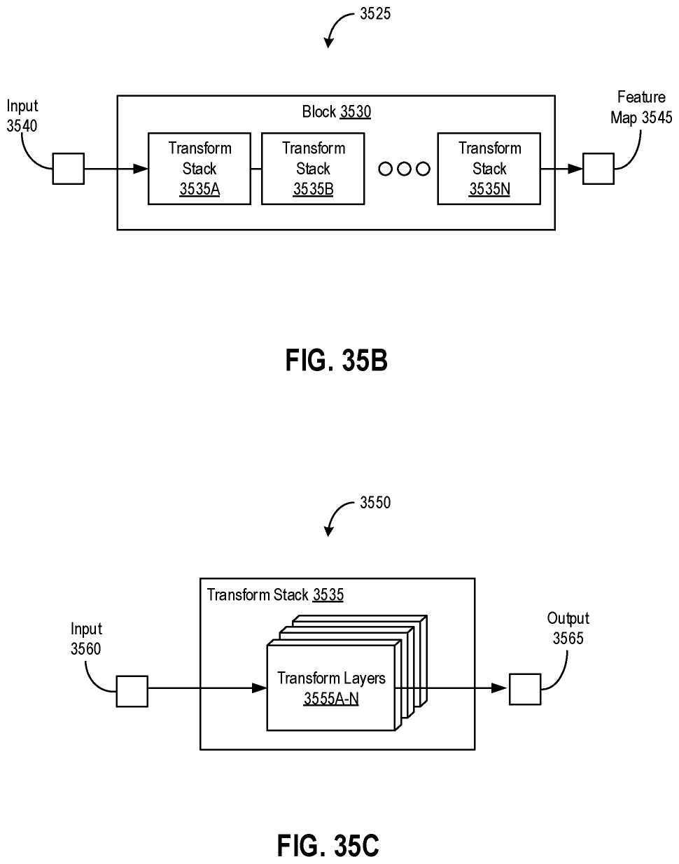

With the assignment, the model applier 3330 may apply the image 3405 to the classification model 3335. The factor 3440 may be added onto the image 3405 using the graphical indicator or separately from the image 3405 as a separate value during the application to the classification model 3335. In some embodiments, the model applier 3330 may apply the image 3405 without the addition of the factor 3440. In applying, the model applier 3330 may input or feed the image 3405 along with the assigned state 3435 to the classification model 3335. The classification model 3335 may have a set of transform layers with kernel parameters (sometimes referred to herein as parameters or weights) for managing the agent 3340. The set of transform layers in the classification model 3335 may be used to approximate a value function established using reinforcement learning, such as a Q-function. The architecture of the set of transform layers and the kernel parameters of the classification model 3335 may be in accordance with a convolutional neural network (CNN), a fully connected (FC) network, a transformer neural network, or any combination thereof, among others. The architecture of the set of transform layers and the kernel parameters of the classification model 3335 is detailed herein in conjunction with FIGS. 35A-C. In feeding, the model applier 3330 may process the input image 3405 along with the factor 3440 in accordance with the kernel parameters of the set of transform layers in the classification model 3335.

Moving onto FIG. 34B, from feeding and processing in accordance with the classification model 3335, the model applier 3330 may produce or generate at least one output 3445. The output 3445 may be used to determine the classification of the image 3405 as having the presence or the absence of the condition 3410. The output 3445 may include or identify the state 3435 of the agent 3340 corresponding to the classification of the image 3405 as having or lacking the condition 3410. The state 3435 in the output 3445 may correspond to the state 3435 assigned by the agent handler 3430, prior to the application to the classification model 3335 or the current state of the agent 3340. For example, the state 3435 of the output 3445 may identify the initial classification by the agent 3340 for the image 3405 as having or lacking the condition 3410.

In addition, the output 3445 produced by the classification model 3335 may include or identify a set of actions 3450A-N (hereinafter generally referred to as actions 3450) to be performed by the agent 3340 with respect to the classification of the image 3405. The set of actions 3450 may be within the definition of the action space, such as the absence or the presence of the condition 3410 in the image 3405. Each action 3450 may correspond to, define, or identify the next state 3435′ to which to transition the agent 3340. The action 3450 may be to maintain the classification determined by the agent 3340 in regard to the condition 3410. For example, the previous classification may have been the absence of the condition 3410, and the action 3450 of the output 3445 may specify the maintenance of the classification as the absence of the condition 3410. The action 3450 may be to change the classification determined by the agent 3340 in regard to the condition 3410. For instance, the previous classification may have been the presence of the condition 3410 in the image 3405, and the action 3450 may indicate changing the classification to the absence of the condition 3410.

For each action 3450, the output 3445 generated by the classification model 3335 may include or identify at least one value 3455A-N (hereinafter generally referred to value 3455). Each value 3455 may correspond to or identify a degree to which the associated action 3450 conforms to or deviates from the optimal transition for the agent 3340 from the state 3435 to determine the classification of the image 3405 as the presence or the absence of the condition 3410. For example, the value 3455 may correspond to a Q value determined from the Q function approximated by the set of transform layers in the classification model 3335. In general, the value 3455 may be positive, if the associated action 3450 is to transition the agent 3340 into or toward the correct classification. Conversely, the value 3455 may be negative, if the associated action 3450 is to maintain the state 3435 of the agent 3340 in the incorrect classification or transition the agent 3340 away from the correct classification.

With the generation, the model trainer 3325 may select or identify at least one expected value from the value function 3460 against which to compare at least one value 3455 of the output 3445. The value function 3460 may include, identify, or define at least one reward value and at least one penalty value. The reward value may be used when the state 3435 to which to transition the agent 3340 under the action 3450 corresponds to the correct classification of the image 3405. The reward value may be, for example, a positive integer or numerical value. In contrast, the penalty value may be used when the state 3435 to which to transition the agent 3340 under the action 3450 does not correspond to the correct classification of the image 3405. The penalty value may be, for example, a negative integer.

To identify the expected value from the value function 3460, the model trainer 3325 may identify the subsequent classification to be determined by the agent 3340 in the image 3405 for at least one action 3450 in the output 3445. In some embodiments, the model trainer 3325 may select the action 3450 corresponding to the maximum value 3455 for the identification. In some embodiments, the model trainer 3330 may identify the action 3450 from the set of actions 3450 in accordance with sampling protocol. For example, the model trainer 3330 may select the action 3450 at random or identify the action 3450 with the highest value 3455 in accordance with the epsilon-greedy algorithm. Upon the identification, the model trainer 3325 may compare the subsequent classification by the agent 3340 as one of the presence or the absence of the condition 3410 against the classification as identified in the annotation 3415. If the subsequent classification matches the classification identified in the annotation 3415, the model trainer 3325 may select the reward value from the value function 3460. On the other hand, if the subsequent classification does not match the classification identified in the annotation 3415, the model trainer 3325 may select the penalty value from the value function 3460. The selected value may correspond to the expected or target value (also referred herein as a target Q value) to be generated by the classification model 3335.

In some embodiments, the model trainer 3325 may invoke or use at least one feedback handler 3465 in the selection of the expected value from the value function 3460. The feedback handler 3465 may generate the annotation 3415 from at least one feedback 3470 associated with the output 3445 produced by the classification model 3335. In generating, the feedback handler 3465 may present or provide information using the output 3345 from the classification model 3335. The information may include the subsequent classification as indicated by the state 3435 to which to transition the agent 3340 based on the action 3450 with the highest value 3455. For example, the model trainer 3325 may present the image 3405 with an indication of the subsequent classification to a user (e.g., a clinician) examining the image 3405 via another computing device.

The feedback handler 3465 may in turn retrieve, identify, or otherwise receive the feedback 3470 (e.g., from the computing device of the examining user). The feedback may be acquired via an input/output (I/O) device as an audio input (e.g., a voice response), a visual input (e.g., a gesture), or a tactile input (e.g., via keyboard or touchscreen), among others. In the example above, the user examining the image 3405 may indicate whether the subsequent classification with respect to the condition 3410 by the agent 3340 is correct or incorrect. The indication from the user may be detected and received via the I/O device of the computing device of the user, and may be the audio input (e.g., voice response), the visual input (e.g., gesture in video), or the tactile input (e.g., text), among others. The indication may identify whether the classification by the agent 3340 is correct or incorrect.

Upon receipt, the feedback handler 3465 may process the feedback 3470 to extract, determine, or identify the indication by the user. When the feedback 3470 is audio input, the feedback handler 3465 may apply speech recognition algorithms to extract or determine the indication by the user. When visual input, the feedback handler 3465 may process the visual input and apply gesture recognition algorithms to determine the indication. When tactile input, the feedback handler 3465 may apply natural language processing (NLP) or token matching to identify the indication by the user. Using the indication, the feedback handler 3465 may generate the annotation 3415. The annotation 3415 may identify whether the classification by the agent 3340 is correct or incorrect. The annotation 3415 may also indicate whether the condition 3410 is present or absent in the image 3405. The model trainer 3325 in turn may use the annotation 3415 to select the expected value from the value function 3460 by comparing against the subsequent classification by the agent 3340 as one of the presence or the absence of the condition 3410 as discussed above.

With the selection from the value function 3460, the model trainer 3325 may determine at least one loss metric (sometimes herein referred to as an error metric) for the output 3445 generated by the classification model 3335. The determination of the loss metric may be based on the expected value selected from the value function 3460 and the value 3455 of the output 3445, among other factors. In some embodiments, the model trainer 3325 may determine the loss metric based on the expected value selected from the value function 3640 using the feedback 3470. The loss metric may indicate a degree of deviation of the output 3445 from the expected result, such as the correct classification for the image 3405 as identified in the annotation 3415. In particular, the loss metric may correspond to the degree of deviation of the set of values 3455 in the output 3445 generated by the classification model 3335 from the behavior as indicated in the value function 3460. The loss metric may be calculated in accordance with any number of loss functions, such as a Huber loss, norm loss (e.g., L1 or L2), mean squared error (MSE), quadratic loss, and cross-entropy loss, among others. In general, the higher the loss metric, the more the output may have deviated from the expected result of the input. Conversely, the lower the loss metric, the less the output may have deviated from the expected result.

Using the loss metric, the model trainer 3325 may modify, set, or otherwise update at least one kernel parameter in the set of transform layers of the classification model 3335. The updating of the set of transform layers in the classification model 3335 may be in accordance with an optimization function (e.g., the Bellman equation). The optimization function may define one or more rates or parameters at which the weights of the classification model 3335 are to be updated. The updating of the classification model 3335 may be to align the values 3455 in the outputs 3445 from the classification model 3335 to the expected value as identified in the value function 3460.

In some embodiments, the model trainer 3325 may store and maintain at least a portion of the output 3445 on at least one buffer 3475 (sometimes herein referred to as an experience replay buffer). The model trainer 3325 may generate at least one entry to store on the buffer 3475 using the output 3445. The entry may identify or include the state 3435 of the agent 3340, at least one action 3450, and at least one value 3455 selected from the current iteration. For example, the action 3450 included in the entry may correspond to the highest value 3455. In some embodiments, the entry may include the expected value for the action 3450 selected from the value function 3460. The entry may be used in subsequent iterations of the application of the classification model 3335 while training.

The model applier 3330 may determine whether to perform another iteration of the application of the image 3405 to the classification model 3335. In some embodiments, the mode applier 3330 may maintain a counter to keep track of a number of iterations. Upon production of the output 3445, the model applied 3330 may compare the number of iterations to a maximum number of iterations. The maximum number of iterations may be a fixed number (e.g., 100 epochs). If the number of iterations performed is greater than or equal to the maximum number, the model applier 3330 may cease the application of the image 3405 to the classification model 3335. The model trainer 3325 may retrieve or identify the subsequent example in the training dataset 3350, from which to identify the next image 3405 to apply. The model applier 3330 and the model trainer 3325 may repeat the functionalities described above with the next example of the training dataset 3350. Conversely, if the number of iterations performed is less than the maximum number, the model applier 3330 may perform another iteration of the application of the image 3405 to the classification model 3335.

For a subsequent iteration of the application, the agent handler 3455 of the model applier 3330 may identify or select the next state 3435′ to which to transition the agent 3340 based on the set of actions 3470 and the set of values 3475. In some embodiments, the agent handler 3455 may select the state 3435′ for the agent 3340 corresponding to the action 3450 with the maximum value 3445. In some embodiments, the agent handler 3455 may select the next state 3435′ corresponding to the action 3450 with the maximum expected value as identified by the value function 3465. The next state 3435′ may identify or indicate the classification for the image 3405 with respect to the condition 3410. The subsequent selection may correspond to the next prediction by the agent 3340 for the proper classification of the image 3405.

In some embodiments, the model trainer 3325 may use a different state to use as the next state 3435′ instead of the state 3435′ selected by the agent handler 3430 for the subsequent iteration. After multiple iterations, the buffer 3475 may identify or include multiple entries. As discussed above, each entry may include a state 3435 of the agent 3340, at least one action 3450, and at least one value 3455 from one of the previous iterations. The model trainer 3325 may access the buffer 3475 to identify, sample, or select at least one entry. The selection of the entry may be at random or in accordance with a set rate (e.g., selection from two or three previous iterations). Upon selection, the model trainer 3325 may parse the entry to identify the state 3435 and the action 3450, among other information. Once selected, the model trainer 3325 may use the state 3435 and the action 3450 from the sampled entry of the buffer 3475 for the next iteration. The state 3435 and the action 3450 for the agent sampled from the buffer 3475 may be used, rather than the state 3435′ selected by the agent handler 3430.

Upon identification of the next state 3435′, the model trainer 3325 and the model applier 3330 may repeat many of the functionalities described above in processing the image 3405. For example, the model trainer 3325 may generate random noise to add to the image 3405 prior to application. The random noise added to the model trainer 3325 may be different from previous iteration. The agent handler 3430 may generate factor 3440′ based on the next state 3435′. The model applier 3330 may apply the image 3405 along with the state 3435′. In feeding, the model applier 3330 may feed the image 3405 along with the state 3435′ to the classification model 3335. The model applier 3330 may process the image 3405 with the next state 3435′ in accordance with the kernel parameters of the set of transform layers in the classification model 3335. Again, from processing the image 3405, the model applier 3330 may produce or generate another output 3445. The output 3445 may identify the state 3435′ of the agent 3340, a set of actions 3450 to be performed by the agent 3340, and a set of corresponding values 3455.

Referring now to FIG. 35A, depicted is a block diagram of an architecture 3500 of the classification model 3335 of the system 3300 for classifying images. Under the architecture 3500, the classification model 3335 may include at least one encoder block 3505, at least one map activator block 3510, at least one factor activator block 3515, and at least one aggregation block 3520, among others. The kernel parameters and the set of transform layers of the classification model 3335 may be configured, arrayed, or otherwise arranged across the encoder block 3505, the map activator block 3510, the factor activator block 3515, and the aggregation block 3520.

The classification model 3335 may have at least one input and at least one output. The input and the output may be related to one another via the set of transform layers across the encoder block 3505, the map activator block 3510, the factor activator block 3515, and the aggregation block 3520. The inputs may include the image 3405 and the factor 3440. In some embodiments, the factor 3440 may be included in the image 3405 as a single input to the classification model 3335. In some embodiments, the image 3405 and the factor 3440 may be separate inputs to the classification model 3335. The output of the classification model 3335 may be the output 3445 as described above.

The blocks may be connected with one another, such as in series, in parallel, or any combination thereof. For example, the encoder block 3505 and the map activator block 3510 may be connected with each other in series. The factor activator block 3515 may be in parallel to the encoder block 3505 and the map activator block 3510. The aggregation block 3520 may be connected in series with the encoder block 3505, the map activator block 3510, and the factor activator block 3515. The input of the encoder block 3505 may include the image 3405. The output of the encoder block 3505 may include a feature map generated from the image 3405, and may be fed forward as the input to the map activator block 3510. The output of the map activator block 3510 may be another feature map, and may be fed forward as the input to the aggregation block 3520. In parallel, the input of the factor activator block 3515 may include the factor 3440, and the output of the factor activator block 3515 may be fed forward to the aggregator block 3520. The aggregator block 3520 may have the feature maps from the map activator block 3510 and the factor activator block 3515 as the input, and may output another feature map corresponding to the output 3445.

Referring now to FIG. 35B, depicted is a block diagram of an architecture 3525 of a transform block 3530 in the classification model 3335 of the system 3300 for classifying images. The transform block 3530 may be used to implement the encoder block 3505 and the map activator block 3510 in the classification model 3335. For example, the encoder block 3505, the map activator block 3510, the factor activator block 3515, and the aggregation block 3520 may each be an instance of the block 3530. Under the architecture 3525, the block 3530 may include one or more transform stacks 3535A-N (hereinafter generally referred to as a transform stack 3535). The set of transform stack 3325 can be arranged in series (e.g., as depicted) or in parallel configuration, or in any combination. In a series configuration, the input of one transform stack 3535 may include the output of the previous transform stack 3535 (e.g., as depicted). In parallel configuration, the input of one transform stack 3535 may include the input of the entire block 3530.

The block 3530 may include at least one input 3540 and at least one output feature map 3545. The kernel parameters arranged across the transform stacks 3535 may define the relationship between the input 3540 and the output 3545. When used to implement the encoder block 3505, the input 3540 may correspond to the image 3405 and the state 3435, and the output may be the feature map 3545. When used to implement the map activator block 3510, the input 3540 may include the feature map generated by the encoder block 3505, and the output may be the feature map 3545. When used to implement the factor activator block 3515, the input 3540 may correspond to the factor 3440, and the output may be the feature map 3545. When used to implement the aggregation block 3520, the input 3540 may correspond to a combination of the feature maps from the map activator block 3510 and factor activator block 3515, and the output may be the overall output 3455 for the overall classification model 3335.

Referring now to FIG. 35C, depicted is a block diagram of an architecture 3550 of a set of transform layers 3555 in the transform stack 3535 in the classification model 3335 of the system 3300 for classifying images. The transform stack 3535 may be used to implement the encoder block 3505 and the map activator block 3510 of the classification model 3335. In some embodiments, the transform stack 3535 may be used to implement the cluster generator 2835. The transform stack 3535 may include a set of transform layers 3555A-N (hereinafter generally referred to as transform layers 3555). The transform stack 3535 may include at least one input 3560 and at least output 3565. The input 3560 and the output 3565 may be related to each other via the set of kernel parameters defined across the transform layers 3555. The set of transform layers 3555 can be arranged in any configuration such as in series or in parallel, or any combination thereof. For example, under series configuration, the transform layers 3555 may have an output of one transform layer 3555 fed as an input to a succeeding transform layer 3555.

Each transform layer 3555 may have a non-linear input-to-output characteristic. The transform layer 3555 may comprise a convolutional layer, a normalization layer, and an activation layer (e.g., a rectified linear unit (ReLU)), among others. When used to implement the encoder block 3505, the transform layers 3555 of the transform stack 3535 may be configured or arranged as a convolutional neural network (CNN). For example, the convolutional layer, the normalization layer, and the activation layer (e.g., a softmax function or rectified linear unit (ReLU)) in the transform layers 3555 may be arranged in accordance with CNN. When used to implemented the map activator block 3510, the factor activation block 3515, or the aggregation block 3520, the transform layers 3555 may be configured or arranged as a fully-connected layer (FCL). For example, the transform layers 3555 may include the activation layers (e.g., a softmax function or rectified linear unit (ReLU)).

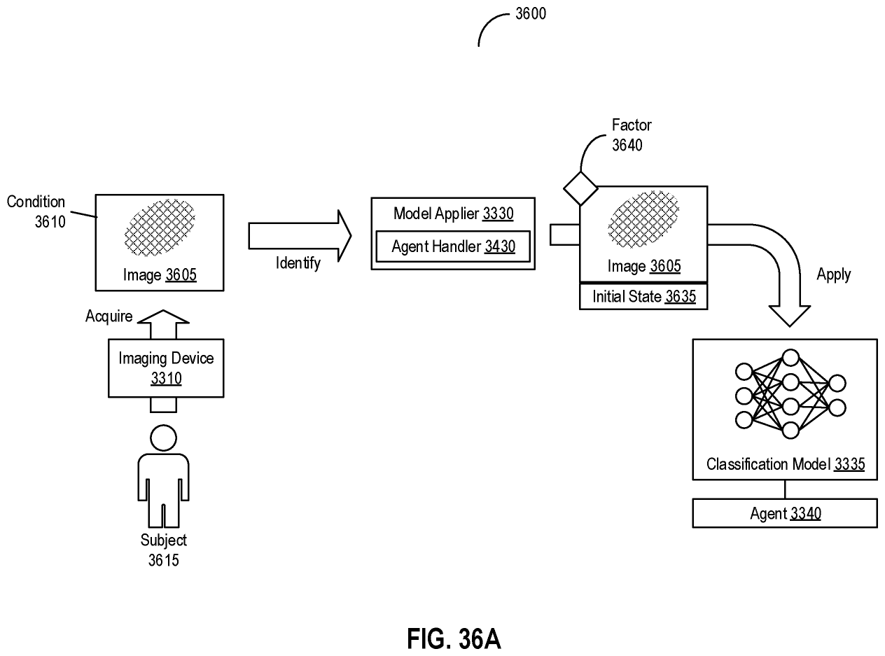

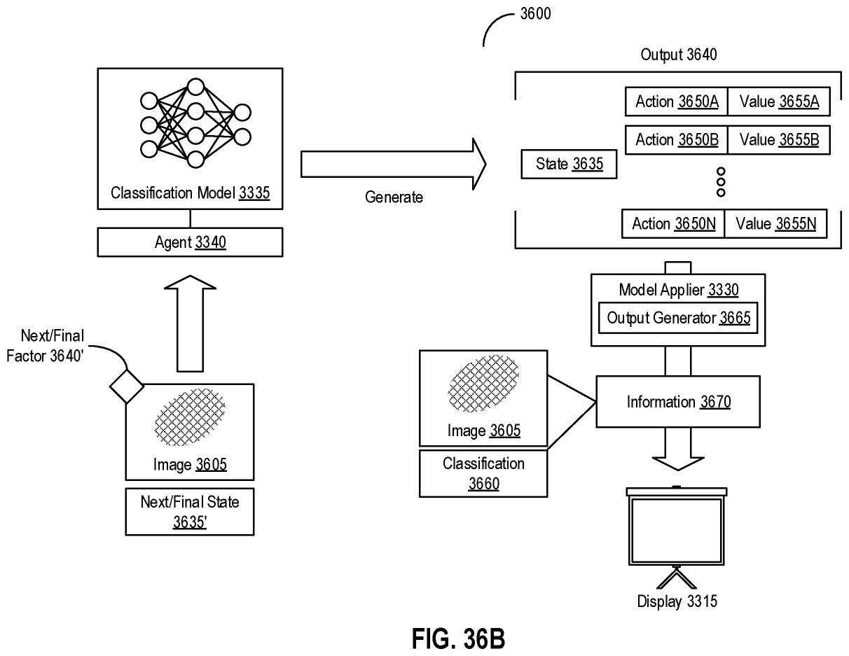

Referring now to FIGS. 36A and 36B, depicted are block diagrams of a process 3600 for using the classification model 3335 in the system 3300 for classifying images. The process 3600 may include operations performed by the image processing system 3305 under the runtime or evaluation mode. The operations of process 3600 may include at least some of the operations in process 3400 to train the classification model 3335. Starting with FIG. 36A, imaging device 3310 may produce, output, or otherwise generate at least one image 3605. The image 3605 may be similar to the image 3405 as discussed above, but may be acquired during the runtime mode. The image 3605 may have at least one condition 3610 corresponding to a feature in the sample from which the image 3605 is acquired. The condition 3610 may correspond to at least one structure of interest (SOI). The SOI may correspond to an area, section, or part of the image 3605 that corresponds to feature in the sample (or object) from which the image 3605 is acquired. For example, the image 3605 may depict a lesion in a magnetic resonance imaging (MM) scan of a brain of a human subject. The condition in this example may correspond to whether the brain has the tumor or does not have any tumor.

The image 3605 may be derived or acquired from at least one subject 3615. The subject 3615 may include any object used to derive the image 3605. For example, the subject 3615 may include a human, an animal, a plant, or a cellular organism, among others. The image 3605 may be acquired, derived, or otherwise be of a sample (or object). The image 3605 may be a two-dimensional section of the sample or a three-dimensional volume of the sample. For example, the image 3605 may include a set of two-dimensional cross-sections (e.g., a front, a sagittal, a transverse, or an oblique plane) acquired from the three-dimensional volume. The image 3605 may be defined in terms of pixels, in two-dimensions or three-dimensions. In some embodiments, the image 3605 may be part of a video acquired of the sample over time. For example, the image 3605 may correspond to a single frame of the video acquired of the sample over time at a frame rate.

In generating the image 3605, the imaging device 3310 may acquire the image 3605 from at least one subject 3615 in accordance with any number of imaging modalities or techniques. For example, the imaging device 3310 may use a tomographic imaging technique, such as magnetic resonance imaging (MM), nuclear magnetic resonance (NMR) imaging, X-ray, computed tomography (CT), ultrasound imaging, positron emission tomography (PET) imaging, and photoacoustic spectroscopy, among others. The image 3605 generated by the imaging device 3310 may be a tomogram, such as an MRI image, a NMR image, CT image, ultrasound image, X-ray image, or PET image, among others. Upon acquisition and generation, the imaging device 3310 may send, transmit, or otherwise provide the image 3605 to the imaging processing system 3305. While discussed primarily in terms of tomograms and tomographs, the imaging device 3310 may support other imaging modalities besides the ones listed above, such as optical photography or microscopy, among others.

The model applier 3330 may receive, retrieve, or otherwise identify the image 3605. In some embodiments, the model applier 3330 may identify the image 3605 of the subject 3615 acquired via the imaging device 3310. Upon identification, the model applier 3330 may invoke or use the agent handler 3430 to set or assign an initial state 3635 for the agent 3340 of the classification model 3335. The initial state 3635 may identify or indicate a classification of the image 3405 as having the presence or absence of the condition 3610. In some embodiments, the agent handler 3430 may use the presence or the absence of each condition 3610 as an action space for the agent 3340. In some embodiments, the agent handler 3430 may select, determine, or identify the classification as one of presence or the absence of the condition 3610 as the initial state 3635 for the agent 3340. The initial state 3635 may correspond to the initial prediction for the classification of the image 3605 as having or lacking the condition 3610. The identification of the classification of the condition 3610 may be set at random or a set value (e.g., presence of the condition 3610). With the identification, the agent handler 3430 may assign the initial state 3635 to the agent 3340.

Based on the state 3635, the agent handler 3430 may determine, assign, or otherwise set at least one factor 3640 for the agent 3340. The state 3635 may be associated with the factor 3640 to indicate the classification of the image 3605 as having the presence or absence of the condition 3410. The factor 3640 in turn may indicate or identify the state 3635 of the agent 3340 and by extension the classification determined by the agent 3340 for the image 3605. The factor 3640 itself may be an indicator to be input into the classification model 3335 along with the image 3605. The value of the indicator for the factor 3640 may indicate the state 3635 of the agent 3340. In some embodiments, the agent handler 3430 may generate the factor 3640 as an indicator (e.g., a Binary value) separate from the image 3605. In some embodiments, the agent handler 3430 may generate the factor 3640 as a graphical indicator to add or insert in the image 3605. In some embodiments, the agent handler 3430 may omit the generation and insertion of the factor 3640.

With the assignment, the model applier 3330 may apply the image 3605 to the classification model 3335. The factor 3640 may be added onto the image 3605 using the graphical indicator or separately from the image 3605 as a separate value during the application to the classification model 3335. In some embodiments, the model applier 3330 may apply the image 3605 without the addition of the factor 3640. In applying, the model applier 3330 may input or feed the image 3605 along with the assigned state 3635 to the classification model 3335. In feeding, the model applier 3330 may process the input image 3605 along with the factor 3640 using the kernel parameters of the set of transform layers in the classification model 3335.

Moving onto FIG. 36B, from processing through the classification model 3335, the model applier 3330 may produce or generate at least one output 3640. The output 3640 may be used to determine the classification of the image 3605 as having the presence or the absence of the condition 3610. The output 3640 may include or identify the state 3635 of the agent 3340 corresponding to the classification of the image 3605 as having or lacking the condition 3610. The state 3635 in the output 3640 may correspond to the state 3635 assigned by the agent handler 3430, prior to the application to the classification model 3335 or the current state of the agent 3340. For example, the state 3635 of the output 3640 may identify the initial classification by the agent 3340 for the image 3605 as having or lacking the condition 3610.

In addition, the output 3640 produced by the classification model 3335 may include or identify a set of actions 3650A-N (hereinafter generally referred to as actions 3650) to be performed by the agent 3340 with respect to the classification of the image 3605. The set of actions 3650 may be within the definition of the action space, such as the absence or the presence of the condition 3610 in the image 3605. Each action 3650 may correspond to, define, or identify the next state 3635′ to which to transition the agent 3340. The action 3650 may be to maintain the classification determined by the agent 3340 in regard to the condition 3610. For example, the previous classification may have been the absence of the condition 3610, and the action 3650 of the output 3640 may specify the maintenance of the classification as the absence of the condition 3610. The action 3650 may be to change the classification determined by the agent 3340 in regard to the condition 3610. For instance, the previous classification may have been the presence of the condition 3610 in the image 3605, and the action 3650 may indicate changing the classification to the absence of the condition 3610.

For each action 3650, the output 3640 generated by the classification model 3335 may include or identify at least one value 3655A-N (hereinafter generally referred to value 3655). Each value 3655 may correspond to or identify a degree to which the associated action 3650 conforms to or deviates from the optimal transition for the agent 3340 from the state 3635 to determine the classification of the image 3605 as the presence or the absence of the condition 3610. For example, the value 3655 may correspond to a Q value determined from the Q function approximated by the set of transform layers in the classification model 3335. In general, the value 3655 may be positive, if the associated action 3650 is to transition the agent 3340 into or toward the correct classification. Conversely, the value 3655 may be negative, if the associated action 3650 is to maintain the state 3635 of the agent 3340 in the incorrect classification or transition the agent 3340 away from the correct classification.

With the generation of the output 3640, the model applier 3330 may determine whether to perform another iteration of the application of the image 3605 to the classification model 3335. In some embodiments, the mode applier 3330 may maintain a counter to keep track of a number of iterations. Upon production of the output 3640, the model applier 3330 may compare the number of iterations to a maximum number of iterations. The maximum number of iterations may be a fixed number (e.g., 100 epochs). If the number of iterations performed is less than the maximum number, the model applier 3330 may perform another iteration of the application of the image 3605 to the classification model 3335.

For the next iteration, the agent handler 3430 of the model applier 3330 may identify or select the next state 3635′ to which to transition the agent 3340 based on the set of actions 3650 and the set of values 3655. In some embodiments, the agent handler 3430 may select the state 3635′ for the agent 3340 corresponding to the action 3650 with the maximum value 3655. The next state 3635′ may identify or indicate the subsequent determination for the classification of the image 3605 as having the presence or the absence of the condition 3610. The subsequent determination may correspond to the next prediction by the agent 3340 as to the proper classification for the image 3605.

Upon identification of the next state 3635′, the model applier 3330 may repeat many of the functionalities described above in processing the image 3605. For example, the model applier 3330 may generate the next factor 3640′ based on the next state 3635′ and apply the image 3605. In feeding, the model applier 3330 may feed the image 3605 along with the factor 3640′ associated with the state 3635′ to the classification model 3335. The model applier 3330 may process the image 3605 with the next state 3635′ in accordance with the kernel parameters of the set of transform layers in the classification model 3335. Again, from processing the image 3605, the model applier 3330 may produce or generate another output 3640. The output 3640 may identify the state 3635′ of the agent 3340, a set of actions 3650 to be performed by the agent 3340, and a set of corresponding values 3655. The model applier 3330 may determine whether to perform another iteration again.

Conversely, if the number of iterations performed is greater than or equal to the maximum number, the model applier 3330 may cease the application of the image 3605 to the classification model 3335. In addition, the model applier 3330 may identify or determine a classification 3660 for the image 3605 as having one of the presence or the absence of the condition 3610 based on the output 3640. To identify, the model applier 3330 may identify or select a final state 3635′ to which to transition the agent 3340 based on the set of actions 3650 and the set of values 3655 of the output 3640. In some embodiments, the agent handler 3430 may select the final state 3635′ for the agent 3340 corresponding to the action 3650 with the maximum value 3655. By the time that the model applier 3330 terminates iterations, the agent 3340 of the classification model 3335 may have been continuously maintaining the state 3635 identifying the presence or the absence of the condition 3610 in the image 3605. As such, the final state 3635′ of the agent 3340 may identify the classification 3660 associated with the condition 3610. From the final state 3635′, the model applier 3330 may determine or identify the classification 3660 for the image 3605 as having or lacking the condition 3610.

Using the identified classification 3660, the model applier 3330 may invoke or use at least one output generator 3665 to generate information 3670. The information 3670 may identify or include the classification 3660 for the image 3605 as one of the presence or the absence of the condition 3610. In some embodiments, the information 3670 may include the image 3605 along the classification 3660. In some embodiments, the information 3670 may include the factor 3640′ (or another indicator) associated with the final state 3635′ of the agent 3340. The indicator may be, for example, text indicating the condition 3610 as “present” or “absent” in the image 3605 at a defined location therein (e.g., generally top-left). In some embodiments, the output generator 3665 may use a template to generate the information 3670 for output. For example, the template may be a radiology report with empty fields, and the output generator 3665 may populate the empty fields with the determined classification 3660 for the information 3670 to be outputted.

Upon generation, the output generator 3665 of the model applier 3330 may provide the information 3670. In some embodiments, the model applier 3330 may send, transmit, or otherwise provide the information 3670 for presentation via the display 3315. The display 3315 may render, display, or present the information 3670, such as the image 3605 and the classification 3660 as the presence or absence of the condition 3610 in the image 3605. For instance, the output generator 3665 may provide the information 3670 to present via a graphical user interface on the display 3315 to display the image 3605 and the classification 3660. In some embodiments, the model applier 3330 may store and maintain the information 3670 on a database accessible from the image processing system 3305.

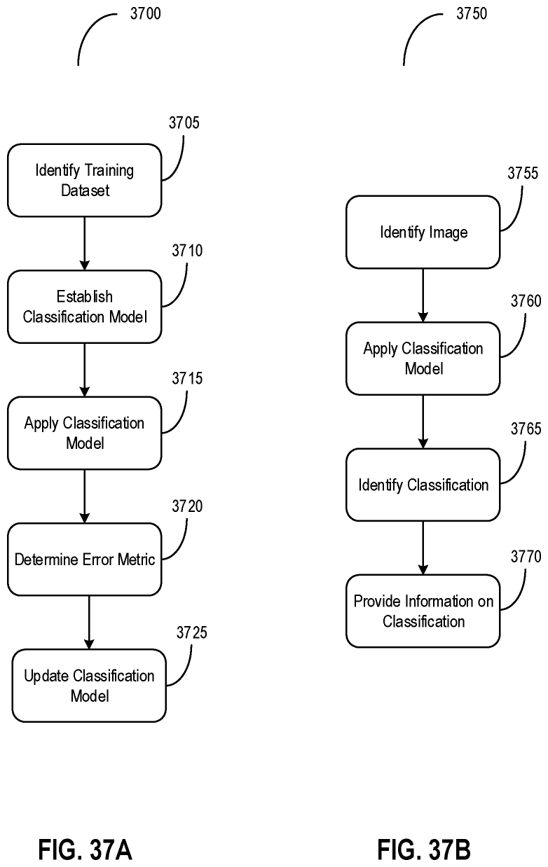

Referring now to FIG. 37A, depicted is a flow diagram of a method 3700 of training models to classifying images. The method 3700 may be performed by or implementing using the system 3300 described herein in conjunction with FIGS. 33-36B or the system 3800 as described herein in conjunction with Section H. Under method 3700, a computing system may identify a training dataset including an image (3705). The computing system may establish a classification model (3710). The computing system may apply the classification model to the image (3715). The computing system may determine an error metric from an output of the classification model (3720). The computing system may update the classification model using the error metric (3725).

Referring now to FIG. 37B, depicted is a flow diagram of a method 3750 of classifying images. The method 3750 may be performed by or implementing using the system 3300 described herein in conjunction with FIGS. 33-36B or the system 3800 as described herein in conjunction with Section H. Under method 3750, a computing system may identify an image (3755). The computing system may apply a classification model to the image (3760). The computing system may identify a classification for the image (3765). The computing system may provide information on the classification (3770).

### H. Computing and Network Environment

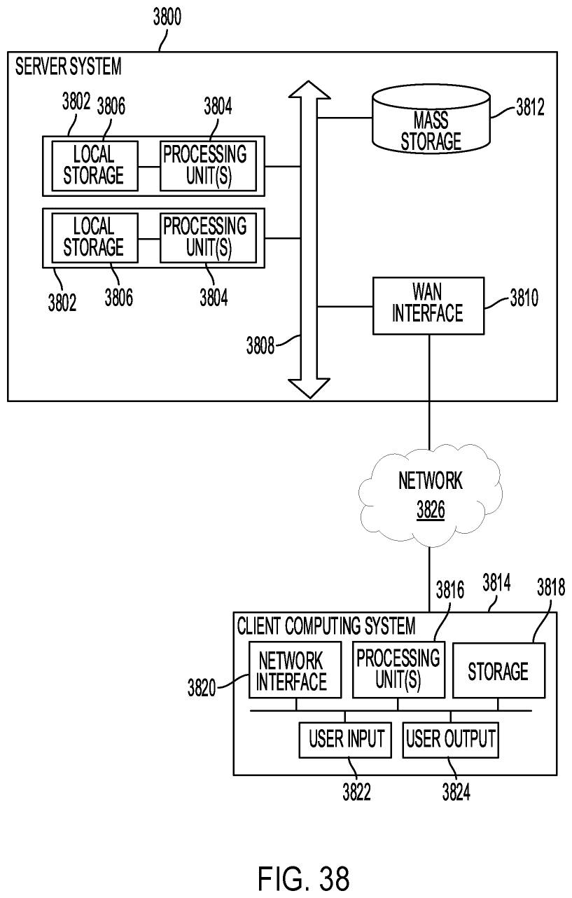

Various operations described herein can be implemented on computer systems. FIG. 38 shows a simplified block diagram of a representative server system 3800, client computer system 3814, and network 3826 usable to implement certain embodiments of the present disclosure. In various embodiments, server system 3800 or similar systems can implement services or servers described herein or portions thereof. Client computer system 3814 or similar systems can implement clients described herein. The system 2300, 2800, and 3300 described herein can be similar to the server system 3800. Server system 3800 can have a modular design that incorporates a number of modules 3802 (e.g., blades in a blade server embodiment); while two modules 3802 are shown, any number can be provided. Each module 3802 can include processing unit(s) 3804 and local storage 3806.

Processing unit(s) 3804 can include a single processor, which can have one or more cores, or multiple processors. In some embodiments, processing unit(s) 3804 can include a general-purpose primary processor as well as one or more special-purpose co-processors such as graphics processors, digital signal processors, or the like. In some embodiments, some or all processing units 3804 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 3804 can execute instructions stored in local storage 3806. Any type of processors in any combination can be included in processing unit(s) 3804.

Local storage 3806 can include volatile storage media (e.g., DRAM, SRAM, SDRAM, or the like) and/or non-volatile storage media (e.g., magnetic or optical disk, flash memory, or the like). Storage media incorporated in local storage 3806 can be fixed, removable, or upgradeable as desired. Local storage 3806 can be physically or logically divided into various subunits such as a system memory, a read-only memory (ROM), and a permanent storage device. The system memory can be a read-and-write memory device or a volatile read-and-write memory, such as dynamic random-access memory. The system memory can store some or all of the instructions and data that processing unit(s) 3804 need at runtime. The ROM can store static data and instructions that are needed by processing unit(s) 3804. The permanent storage device can be a non-volatile read-and-write memory device that can store instructions and data even when module 3802 is powered down. The term “storage medium” as used herein includes any medium in which data can be stored indefinitely (subject to overwriting, electrical disturbance, power loss, or the like) and does not include carrier waves and transitory electronic signals propagating wirelessly or over wired connections.

In some embodiments, local storage 3806 can store one or more software programs to be executed by processing unit(s) 3804, such as an operating system and/or programs implementing various server functions such as functions of the system 2300, 2800, and 3300 or any other system described herein, or any other server(s) associated with system 2300, 2800, and 3300 or any other system described herein.

“Software” refers generally to sequences of instructions that, when executed by processing unit(s) 3804, cause server system 3800 (or portions thereof) to perform various operations, thus defining one or more specific machine embodiments that execute and perform the operations of the software programs. The instructions can be stored as firmware residing in read-only memory and/or program code stored in non-volatile storage media that can be read into volatile working memory for execution by processing unit(s) 3804. Software can be implemented as a single program or a collection of separate programs or program modules that interact as desired. From local storage 3806 (or non-local storage described below), processing unit(s) 3804 can retrieve program instructions to execute and data to process in order to execute various operations described above.

In some server systems 3800, multiple modules 3802 can be interconnected via a bus or other interconnect 3808, forming a local area network that supports communication between modules 3802 and other components of server system 3800. Interconnect 3808 can be implemented using various technologies including server racks, hubs, routers, etc.

A wide area network (WAN) interface 3810 can provide data communication capability between the local area network (interconnect 3808) and the network 3826, such as the Internet. Technologies can be used, including wired (e.g., Ethernet, IEEE 802.3 standards) and/or wireless technologies (e.g., Wi-Fi, IEEE 802.11 standards).

In some embodiments, local storage 3806 is intended to provide working memory for processing unit(s) 3804, providing fast access to programs and/or data to be processed while reducing traffic on interconnect 3808. Storage for larger quantities of data can be provided on the local area network by one or more mass storage subsystems 3812 that can be connected to interconnect 3808. Mass storage subsystem 3812 can be based on magnetic, optical, semiconductor, or other data storage media. Direct attached storage, storage area networks, network-attached storage, and the like can be used. Any data stores or other collections of data described herein as being produced, consumed, or maintained by a service or server can be stored in mass storage subsystem 3812. In some embodiments, additional data storage resources may be accessible via WAN interface 3810 (potentially with increased latency).

Server system 3800 can operate in response to requests received via WAN interface 3810. For example, one of modules 3802 can implement a supervisory function and assign discrete tasks to other modules 3802 in response to received requests. Work allocation techniques can be used. As requests are processed, results can be returned to the requester via WAN interface 3810. Such operation can generally be automated. Further, in some embodiments, WAN interface 3810 can connect multiple server systems 3800 to each other, providing scalable systems capable of managing high volumes of activity. Other techniques for managing server systems and server farms (collections of server systems that cooperate) can be used, including dynamic resource allocation and reallocation.

Server system 3800 can interact with various user-owned or user-operated devices via a wide-area network such as the Internet. An example of a user-operated device is shown in FIG. 38 as client computing system 3814. Client computing system 3814 can be implemented, for example, as a consumer device such as a smartphone, other mobile phone, tablet computer, wearable computing device (e.g., smart watch, eyeglasses), desktop computer, laptop computer, and so on.

For example, client computing system 3814 can communicate via WAN interface 3810. Client computing system 3814 can include computer components such as processing unit(s) 3816, storage device 3818, network interface 3820, user input device 3822, and user output device 3824. Client computing system 3814 can be a computing device implemented in a variety of form factors, such as a desktop computer, laptop computer, tablet computer, smartphone, other mobile computing device, wearable computing device, or the like.

Processor 3816 and storage device 3818 can be similar to processing unit(s) 3804 and local storage 3806 described above. Suitable devices can be selected based on the demands to be placed on client computing system 3814; for example, client computing system 3814 can be implemented as a “thin” client with limited processing capability or as a high-powered computing device. Client computing system 3814 can be provisioned with program code executable by processing unit(s) 3816 to enable various interactions with server system 3800.

Network interface 3820 can provide a connection to the network 3826, such as a wide area network (e.g., the Internet) to which WAN interface 3810 of server system 3800 is also connected. In various embodiments, network interface 3820 can include a wired interface (e.g., Ethernet) and/or a wireless interface implementing various RF data communication standards such as Wi-Fi, Bluetooth, or cellular data network standards (e.g., 3G, 4G, LTE, etc.).

User input device 3822 can include any device (or devices) via which a user can provide signals to client computing system 3814; client computing system 3814 can interpret the signals as indicative of particular user requests or information. In various embodiments, user input device 3822 can include any or all of a keyboard, touch pad, touch screen, mouse or other pointing device, scroll wheel, click wheel, dial, button, switch, keypad, microphone, and so on.

User output device 3824 can include any device via which client computing system 3814 can provide information to a user. For example, user output device 3824 can include display-to-display images generated by or delivered to client computing system 3814. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some embodiments can include a device such as a touchscreen that function as both input and output device. In some embodiments, other user output devices 3824 can be provided in addition to or instead of a display. Examples include indicator lights, speakers, tactile “display” devices, printers, and so on.

Some embodiments include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operations indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 3804 and 3816 can provide various functionality for server system 3800 and client computing system 3814, including any of the functionality described herein as being performed by a server or client, or other functionality.

It will be appreciated that server system 3800 and client computing system 3814 are illustrative and that variations and modifications are possible. Computer systems used in connection with embodiments of the present disclosure can have other capabilities not specifically described here. Further, while server system 3800 and client computing system 3814 are described with reference to particular blocks, it is to be understood that these blocks are defined for convenience of description and are not intended to imply a particular physical arrangement of component parts. For instance, different blocks can be but need not be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present disclosure can be realized in a variety of apparatus including electronic devices implemented using any combination of circuitry and software.

While the disclosure has been described with respect to specific embodiments, one skilled in the art will recognize that numerous modifications are possible. Embodiments of the disclosure can be realized using a variety of computer systems and communication technologies including but not limited to specific examples described herein. Embodiments of the present disclosure can be realized using any combination of dedicated components and/or programmable processors and/or other programmable devices. The various processes described herein can be implemented on the same processor or different processors in any combination. Where components are described as being configured to perform certain operations, such configuration can be accomplished; e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present disclosure may be encoded and stored on various computer readable storage media; suitable media include magnetic disk or tape, optical storage media such as compact disk (CD) or digital versatile disk (DVD), flash memory, and other non-transitory media. Computer readable media encoded with the program code may be packaged with a compatible electronic device, or the program code may be provided separately from electronic devices (e.g., via Internet download or as a separately packaged computer-readable storage medium).

Thus, although the disclosure has been described with respect to specific embodiments, it will be appreciated that the disclosure is intended to cover all modifications and equivalents within the scope of the following claims.

1. A method of localizing on biomedical images, comprising:
identifying, by a computing system, a biomedical image having at least one structure of interest (SOI);
applying, by the computing system, the biomedical image to a localization model for handling an agent, the localization model comprising a set of transform layers to generate an output identifying (i) a state indicating a position of the agent within the biomedical image; and (ii) an action to be performed by the agent with respect to the position;
determining, by the computing system, at least one location in the biomedical image corresponding to the at least one SOI based on the state and the action performed by the agent in accordance with the output; and
providing, by the computing system, information based on the at least one location in the biomedical image corresponding to the at least one SOI.

2. The method of claim 1, further comprising generating, by the computing system, a plurality of tiles from the biomedical image to define an action space for the position of the agent, at least one tile of the plurality of tiles having the at least one SOI, and
wherein the output generated by the localization model identifies (i) the state indicating the position corresponding to a first tile of the plurality of tiles; and (ii) the action to maintain the position of the agent or move the agent from the first tile to a second tile of the plurality of tiles.

3. The method of claim 1, wherein identifying the biomedical image further comprises receiving, from a tomograph, a tomogram of at least one of a two-dimensional section of a subject or a three-dimensional volume of the subject.

4. The method of claim 1, wherein applying the biomedical image further comprises applying the biomedical image to the localization model for a number of iterations, the number of iterations identified based on a set number of tiles in a plurality of tiles defining an action space for the position of the agent.

5. The method of claim 1, wherein the localization model further comprises the set of transform layers arranged across a plurality of convolutional neural networks (CNNs) and a plurality of fully-connected layers (FLCs) connected in series.

6. The method of claim 1, wherein determining the at least one location further comprises determining the at least one location corresponding to at least one tile of a plurality of tiles defining an action space for the position of the agent on the biomedical image, based on the state and the action performed by the agent in accordance with the output.

7. The method of claim 1, wherein providing the information further comprises presenting, on an interface, the information based on the at least one location corresponding to the at least one SOI in the biomedical image.

8. A method of training models to localize biomedical images, comprising:
identifying, by a computing system, a biomedical image having at least one structure of interest (SOI) and an annotation identifying at least one location of the at least one SOI in the biomedical image;
applying, by the computing system, the biomedical image to a localization model, the localization model comprising a set of transform layers to generate an output identifying (i) a state indicating a position of the agent within the biomedical image; and (ii) a plurality of actions to be performed by the agent with respect to the position, the state and the plurality of actions to be used to determine the at least one location corresponding to the at least one SOI in the biomedical image;
determining, by the computing system, a loss metric based on the state and the plurality of actions identified in the output in accordance with a value function, the value function defining (i) a first value for when the position of the agent corresponds to the at least one location identified in the at least one SOI; and (ii) a second value for when the position of the agent does not correspond to the at least one location; and
updating, by the computing system, at least one of the set of transform layers of the localization model using the loss metric.

9. The method of claim 8, further comprising generating, by the computing system, a plurality of tiles from the biomedical image to define an action space for the position of the agent, at least one tile of the plurality of tiles having the at least one SOI.

10. The method of claim 9, wherein the output generated by the localization model identifies (i) the state indicating the position corresponding to a first tile of the plurality of tiles;
and (ii) the plurality of actions to maintain the position of the agent or the move the agent from the first tile to a second tile of the plurality of tiles.

11. The method of claim 8, wherein applying the biomedical image further comprises assigning an initial state for the agent indicating an initial position corresponding to one of a plurality of tiles defining an action space for the position of the agent.

12. The method of claim 8, wherein applying the biomedical image further comprises selecting, from the plurality of actions, an action for the agent to perform with respect to the position based on a value associated with the action.

13. The method of claim 8, wherein applying the biomedical image further comprises applying the biomedical image to the localization model for a number of iterations, the number of iterations identified based on a set number of tiles in a plurality of tiles defining an action space for the position of the agent.

14. The method of claim 8, further comprising storing, by the computing system, on a buffer, an entry identifying the state of the agent, an action of the plurality of actions performed by the agent, and a value determined based on the value function, the entry to be used in at least one subsequent iteration of application of the biomedical image.

15. The method of claim 8, further comprising adding, by the computing system, random noise to the biomedical image, prior to at least one iteration of applying the biomedical image to the segmentation model.

16. A system for localizing on biomedical images, comprising:
a computing system having one or more processors coupled with memory, configured to:
identify a biomedical image having at least one structure of interest (SOI);
apply the biomedical image to a localization model for handling an agent, the localization model comprising a set of transform layers to generate an output identifying (i) a state indicating a position of the agent within the biomedical image; and (ii) an action to be performed by the agent with respect to the position;
determine at least one location in the biomedical image corresponding to the at least one SOI based on the state and the action performed by the agent in accordance with the output; and
provide information based on the at least one location in the biomedical image corresponding to the at least one SOI.

17. The system of claim 16, wherein the computing system is further configured to generate a plurality of tiles from the biomedical image to define an action space for the position of the agent, at least one tile of the plurality of tiles having the at least one SOI, and
wherein the output generated by the localization model identifies (i) the state indicating the position corresponding to a first tile of the plurality of tiles; and (ii) the action to maintain the position of the agent or the move the agent from the first tile to a second tile of the plurality of tiles.

18. The system of claim 16, wherein the computing system is further configured to receive, from a tomograph, a tomogram of at least one of a two-dimensional section of a subject or a three-dimensional volume of the subject.

19. The system of claim 16, wherein the computing system is further configured to determine the at least one location corresponding to at least one tile of a plurality of tiles defining an action space for the position of the agent on the biomedical image, based on the state and the action performed by the agent in accordance with the output.

20. The system of claim 16, wherein the computing system is further configured to present, on an interface, the information based on the at least one location corresponding to the at least one SOI in the biomedical image.

21.-60. (canceled)
